(19) United States
(12) Patent Application Publication
(10) Pub. No.: US 2026/0241459 A1
(43) Pub. Date: Aug. 20, 2026

(54) OPTICAL SYSTEM ADJUSTMENT

(71) Applicant: Velo3D, Inc., Fremont, CA (US)

(72) Inventors: Christopher William Barton, Milpitas, CA (US); Sergey Borisovich Korepanov, Los Altos, CA (US); Joseph Andrew Tralongo, El Cajon, CA (US); Benyamin Buller, Cupertino, CA (US)

(73) Assignee: Velo3D, Inc., Fremont, CA (US)

(21) Appl. No.: 18/871,113

(22) PCT Filed: Jun. 1, 2023
(86) PCT No.: PCT/US2023/024161

§ 371 Date: Dec. 2, 2024

Related U.S. Application Data
(60) Provisional application No. 63/348,901, filed on Jun. 3, 2022.

(51) Int. Cl. B22F 12/49; B22F 10/28; B22F 10/73; B22F 10/85; B22F 12/44; B33Y 30/00; B33Y 40/00; B33Y 50/02; G02B 7/182

(52) U.S. Cl. CPC B22F 12/49; B22F 10/28; B22F 10/73; B22F 10/85; B22F 12/44; B33Y 30/00; B33Y 40/00; B33Y 50/02; G02B 7/182

(57) ABSTRACT

The present disclosure provides various methods of adjusting optical systems subject to temperature variations, and related apparatuses, software, systems, and devices. The optical system can be utilized in a three-dimensional printing system for printing one or more three-dimensional objects.

### PRIORITY APPLICATIONS

This Patent application claims priority from U.S. Provisional Patent Application Ser. No. 63/348,901 filed on Jun. 3, 2022, which is entirely incorporated herein by reference.

### BACKGROUND

Three-dimensional (3D) printing (e.g., additive manufacturing) is a process for making a three-dimensional object of any shape from a design (e.g., 3D model). The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layerwise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based at least in part on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together. The energy beam may be projected on a material bed to transform at least a portion of the starting material (also referred to herein as “pre-transformed material” or “source material”) to print the 3D object.

In some instances, an optical assembly is utilized to guide an energy beam used for printing 3D object(s). The optical assembly may comprise a scanner. The optical assembly may comprise optical element(s). The optical element(s) may be exposed to (I) radiation comprising radiation guided by the optical element(s) (e.g., radiation of the energy beam) and/or (II) radiation reflected onto the optical element(s). The radiation may generate thermal heating of the optical element(s). At times, such heating may result in a degraded performance of the optical assembly. The degraded performance may compromise performance of the energy beam used at least in part for printing the 3D object(s), e.g., resulting in compromised 3D object(s). the compromised 3D object(s) may include a structural discrepancy, and/or a material property discrepancy. The structural discrepancy may include internal and/or external structural discrepancies. The material property discrepancy may comprise a material defect, e.g., dislocation, crack, and/or porosity. These problems are exacerbated, e.g., when the optical path from the scanner to the material bed is large-magnifying the optical error when the energy beam impinges on the exposed surface of the material bed. For example, when laser beam maneuvers occur at a small timescale and require high spatial precision over a lengthy optical path.

### SUMMARY

In some aspects, the present disclosure alleviates the aforementioned hardships. Integrated measures can be implemented to reduce thermal effects in the optical assembly and/or enclosure thereof. The multiple integrated measures can include (1) reducing stray-radiation incident on various optical element(s) of the optical assembly and/or (2) reducing the effects of thermal heating on the various optical element(s). The integrated measure(s) can comprise (a) adding guard(s) arranged with respect to the optical element(s) to guard (e.g., shield or block) the optical elements from stray-radiation, (b) selecting materials for the optical element(s) that alter their optical properties, (c) selecting mounting hardware for mounting the various optical element(s), (e) temperature conditioning the optical element(s) and/or their enclosure atmosphere, (f) software re-alignment of the energy beam emerging out of the optical assembly such as including feedback and feedforward control schemes, (g) using feedback and feedforward control schemes that are robust to changes in mechanical properties of the optical assembly, or (h) any combination thereof.

In another aspect, a device for energy beam translation, the device comprises: an actuator; a mirror operatively coupled with (e.g., to) the actuator configured to move the mirror about an axis, the mirror being configured to deflect the energy beam impinging on the mirror; and a housing configured to (a) accommodate the mirror, (b) facilitate (e.g., allow) transmission of the energy beam propagating along an optical path disposed in the housing, and (c) operatively couple with (e.g., to) an optical window configured to facilitate (e.g., allow) the energy beam to propagate therethrough and out of the housing, wherein: (A) during operation, the device is configured to bring about translation of (e.g., translate) the energy beam along a target surface with a positional error at the target surface, the positional error being of a value of at most about 0.01 percent or a lower percentage, the value of the positional error being relative to a portion of the path from the axis of the mirror to the target surface; (B) the device comprises a guard configured to shield the mirror from at least a portion of stray radiation in the housing; (C) the mirror being (is) coupled with (e.g., to) the actuator with an adhesive having a liquidous phase transition at a temperature of at least about 120 degrees Celsius (° C.) or at a higher temperature; (D) the device is configured to maintain its standard operation at a temperature of at least about 80° C. or at a higher temperature, the standard operation being at an ambient temperature (external to the device); (E) the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror; (F) a fastener of the actuator has a torque value of at least about 1.5 Newton*meters (Nm) or a higher torque value; (G) during operation, the mirror is configured to have a frequency response drift during use, the frequency response drift having a value of at most about two hertz per degree Celsius or a lower value; (H) during operation, the mirror is configured to have a total drift tolerance (frequency) having a value of at most about 100 Hertz or a lower total drift tolerance value; (I) the device comprises an optical element having a reflectivity value of at least about 90 percent or higher, the optical element comprises the mirror, a mount of the mirror, the actuator, or the guard (e.g., the reflectivity being of the energy beam); or (J) any combination of (A) to (I) (i.e., (A), (B), (C), (D), (E), (F), (G), (H), and/or (I)). The symbol “*” represents the mathematical operation “times.” In some embodiments, during operation, the device is configured to bring about translation of (e.g., translate) the energy beam along a target surface with a positional error at the target surface, the positional error being of a value of at most about 0.01 percent or a lower percentage, the value of the positional error being relative to a portion of the path from the axis of the mirror to the target surface. In some embodiments, the device comprises a guard configured to shield the mirror from at least a portion of stray radiation in the housing. In some embodiments, the mirror being (is) coupled with (e.g., to) the actuator with an adhesive having a liquidous phase transition at a temperature of at least about 120° C. or at a higher temperature. In some embodiments, the device is configured to maintain its standard operation at a temperature of at least about 80° C. or at a higher temperature, the standard operation being at an ambient temperature (external to the device). In some embodiments, the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror. In some embodiments, a fastener of the actuator has a torque value of at least about 1.5 Newton*meters (Nm) or a higher torque value. In some embodiments, during operation, the mirror is configured to have a frequency response drift during use, the frequency response drift having a value of at most about two hertz per degree Celsius or a lower value. In some embodiments, during operation, the mirror is configured to have a total drift tolerance (frequency) having a value of at most about 100 Hertz or a lower total drift tolerance value. In some embodiments, the device comprises an optical element having a reflectivity value of at least about 90 percent or higher, the optical element comprises the mirror, a mount of the mirror, the actuator, or the guard (e.g., the reflectivity being of the energy beam). In some embodiments, the fastener of the actuator is configured to fasten the actuator directly or indirectly to the housing. In some embodiments, the standard operation being at an ambient temperature of an atmosphere of the housing, and/or of at least one optical element of the housing; wherein the at least one optical element comprises the mirror and the actuator. In some embodiments, the guard is configured to guard the mirror from stray radiation incoming into the housing through the optical window. In some embodiments, the positional error at the target surface is of at most about 300 micrometers, 150 micrometers, 100 micrometers, 75 micrometers, 50 micrometers, or 25 micrometers. In some embodiments, the positional error is of at most about 0.01 percent (%), 0.007%, 0.005%, or 0.003% or lower percentage, the value of the positional error being relative to the portion of the path from the axis of the mirror to the target surface. In some embodiments, the device further comprises one or more other optical elements other than the mirror and the actuator. In some embodiments, the guard is configured to shield the mirror from stray radiation reflected from the one or more other optical element. In some embodiments, the one or more other optical elements are configured to alter a beam profile of the energy beam from a first beam profile to a second beam profile. In some embodiments, the one or more other optical elements are configured to alter a beam profile to the second beam profile that comprises a ring profile (e.g., doughnut, or corona profile). In some embodiments, the one or more other optical elements are configured to alter a beam profile in real time during the printing. In some embodiments, the one or more other optical elements are configured to alter a beam profile in real time operation of the energy beam. In some embodiments, the one or more other optical elements are configured to alter a beam profile in real time during an operation of the three-dimensional printing other than impinging the energy beam at the target surface. In some embodiments, the one or more other optical elements are configured to alter a beam profile in real time during operation of a layer dispensing mechanism of the three-dimensional printer. In some embodiments, the device comprises an axicon or an optical wedge. In some embodiments, the axicon is configured to alter the energy beam from the first profile to the second profile. In some embodiments, the axicon is reversibly translatable. In some embodiments, translatable is in real time during the printing. In some embodiments, the optical wedge is configured to direct a reflected beam from the target surface to be detected by a detector. In some embodiments, the detector comprises a single pixel detector. In some embodiments, the detector comprises an optical fiber. In some embodiments, the detector is configured to measure the temperature at the target surface (e.g., in real time during the printing). In some embodiments, measurements of the detector affects the printing. In some embodiments, the detector comprises an optical detector. In some embodiments, the optical detector is configured to detect electromagnetic radiation comprising infrared radiation. In some embodiments, the housing is configured for reversibly installed and uninstalled without substantial (e.g., measurable) alteration to the beam path of the energy beam at the target surface, e.g., affecting the three-dimensional object per requested tolerances. In some embodiments, the housing is configured to be reversibly installed and uninstalled for the purpose comprising maintenance, upgrade, or replacement. In some embodiments, the device further comprises one or more other optical elements other than the mirror and the actuator, and wherein the guard is configured to shield the mirror from stray radiation reflected from the one or more other optical elements. In some embodiments, the one or more other optical elements are configured to alter a beam profile of the energy beam from a first beam profile to a second beam profile. In some embodiments, the second beam profile is a ring beam profile. In some embodiments, the one or more other optical elements are configured to alter the beam profile during printing of a three-dimensional object as the energy beam impinges on the target surface. In some embodiments, the target surface comprises an exposed surface of a material bed. In some embodiments, the material bed is a powder bed. In some embodiments, the material bed comprises elemental metal, metal alloy, an allotrope of elemental carbon, or a ceramic. In some embodiments, the energy beam is a laser beam. In some embodiments, the energy beam is configured to irradiate the target surface to transform a starting material into a transformed material to print a three-dimensional object. In some embodiments, transformation of the starting material comprises melting or sintering. In some embodiments, for maintaining the standard operation, the device comprises (i) the guard, (ii) the reflectivity of the optical element, (iii) the torque of the actuator, and/or (iv) the adhesive. In some embodiments, for the mirror to have the frequency response drift during use, the device comprises (i) the guard, (ii) the reflectivity of the optical element, (iii) the torque of the actuator, and/or (iv) the adhesive. In some embodiments, for the mirror to have a total drift tolerance having the value, the device comprises (i) the guard, (ii) the reflectivity of the optical element, (iii) the torque of the actuator, and/or (iv) the adhesive. In some embodiments, the ambient temperature is about 20° C. or 25° C. In some embodiments, the mirror is coupled with (e.g., to) the actuator with an adhesive having a liquidous phase transition at a temperature of at least about 120° C., 130° C., or 140° C., or at a higher temperature. In some embodiments, the device is configured to maintain the standard operation while being subject to stray radiation that increases the temperature by a temperature increase value of from about zero ° C. to at least about 25° C., 30° C., 40° C., 50° C., or to a higher temperature increase value. In some embodiments, the fastener of the actuator has a torque value of at least about 1.5 Newtown meters (Nm), 2 Nm, 2.5 Nm, or a higher torque value. In some embodiments, the device comprises an optical element having a reflectivity value of at least about 90 percent (%), 95%, 97%, 99% or higher percent value. In some embodiments, the device comprises an optical element having a material comprising an elemental metal or metal alloy. In some embodiments, the device comprises an optical element comprising a material having specular surface reflectivity. In some embodiments, the device comprises an optical element comprising metal, chrome, or platinum. In some embodiments, the device comprises an optical element comprising the mirror, the mount, the guard, the actuator, a prism, or a lens. In some embodiments, the lens is configured to focus the energy beam, and wherein the lens is disposed before or after the mirror along the path of the energy beam with respect to the optical window. In some embodiments, the housing includes one or more sensors sensing an attribute comprising a temperature, humidity, optical density, or gas borne debris. In some embodiments, the mirror is configured to have a frequency response drift. In some embodiments, during operation, the frequency response drift has a value of at most about 2.0 Hertz per degree Celsius (Hz/° C.), 1.9 Hz/° C., 1.7 Hz/° C., 1.5 Hz/° C., or a lower value. In some embodiments, during operation, the mirror is configured to have a total drift tolerance having a value of at most about 100 Hertz (Hz), 90 Hz, 85 Hz, 80 Hz, 75 Hz, 70 Hz, 60 Hz, or 50 Hz or a lower total drift tolerance value. In some embodiments, the actuator is disposed in the housing. In some embodiments, the actuator is automatically controlled by one or more controllers. In some embodiments, the one or more controllers are part of a control system, e.g., of a manufacturing system such as a three-dimensional printer. In some embodiments, the control system comprises three or more hierarchical control levels. In some embodiments, the control system is of a three-dimensional printing system configured to print one or more three-dimensional objects in a printing cycle, and wherein the energy beam is utilized at least in part to print the one or more three-dimensional objects. In some embodiments, the target surface is an exposed surface of a material bed in which the one or more three-dimensional objects are being printed. In some embodiments, the material bed comprises powder material. In some embodiments, the material bed comprises elemental metal, metal alloy, an allotrope of elemental carbon, or a ceramic. In some embodiments, the one or more three-dimensional objects are being printed in a processing chamber operatively coupled with (e.g., to) the housing, the processing chamber being configured to operate at an internal atmosphere different from an ambient atmosphere outside of the processing chamber. In some embodiments, the internal atmosphere of the processing chamber (i) has a gas content less reactive with a starting material of the three-dimensional printing as compared to reactivity of the gas content of the ambient atmosphere, and/or (ii) has a gas pressure different than the gas pressure of the ambient atmosphere. In some embodiments, the gas pressure of the internal atmosphere of the processing chamber is higher than the gas pressure of the ambient atmosphere. In some embodiments, the internal atmosphere of the processing chamber is a first internal atmosphere, and wherein the housing has a second internal atmosphere. In some embodiments, the first atmosphere comprises argon or nitrogen. In some embodiments, the second atmosphere comprises air. In some embodiments, the first atmosphere comprises a reactive agent at a lower concentration relative to its concentration in the ambient atmosphere. In some embodiments, the reactive agent comprises water or oxygen. In some embodiments, the second atmosphere is different from the first atmosphere different by at least one characteristic. In some embodiments, the second atmosphere is similar to the first atmosphere by at least one characteristic. In some embodiments, the at least one characteristic comprises a gas content, a velocity, a flow path, or a pressure. In some embodiments, the actuator is configured to operatively couple with (e.g., to) one or more controllers. In some embodiments, the one or more controllers are part of a control system. In some embodiments, the control system is configured to control a three-dimensional printing system. In some embodiments, the control system comprises feedforward and feedback control schemes. In some embodiments, the feedback control scheme is based at least in part on positional feedback of the actuator. In some embodiments, the feedforward control scheme is based at least in part on (i) positional feedback of the actuator and/or (ii) a thermal reaction of a position of the actuator. In some embodiments, the thermal reaction of the position of the actuator is based at least in part on (I) historical measurements, (II) empirical measurements, (III) lookup table, (IV) simulation, and/or (V) artificial intelligence learning scheme. In some embodiments, the housing comprises a galvanometer scanner that comprises the mirror. In some embodiments, the device comprises a heat sink operatively coupled with the actuator and/or with the mirror. In some embodiments, the heat sink comprises a heat conducting solid. In some embodiments, the housing is configured to facilitate flow of at least one coolant type therethrough, the at least one coolant type configured to cool the mirror and/or the actuator during operation of the device to translate the energy beam. In some embodiments, the at least one coolant type comprises a gas, a liquid, or a semisolid. In some embodiments, the at least one coolant type comprises air, nitrogen, argon, or water. In some embodiments, the air comprises clean dry air. In some embodiments, the coolant is configured to flow at a rate such that the energy beam (e.g., substantially) retains its stability while propagating along the target surface. In some embodiments, retaining the stability of the energy beam comprises having a positional error at the target surface of at most about 300 micrometers, 150 micrometers, 100 micrometers, 75 micrometers, 50 micrometers, or 25 micrometers. In some embodiments, retaining the stability of the energy beam having a positional error the positional error being of a value of at most about 0.01 percent (%), 0.007%, 0.005%, or 0.003% or lower percentage, the value of the positional error being relative to the portion of the path from the axis of the mirror to the target surface. In some embodiments, the mirror is configured to (e.g., substantially) retain its stability in response to the coolant flowing in the housing to contribute at least in part in retaining the stability of the energy beam. In some embodiments, the coolant is configured to flow at a rate such that the mirror (e.g., substantially) retains its stability in response to the coolant flowing upon the mirror and/or flowing upon the actuator, to contribute at least in part in retaining the stability of the energy beam. In some embodiments, the device is configured to retain the stability of the energy beam at least in part by minimizing disturbance of one or more optical elements of the device comprising the mirror or the actuator. In some embodiments, the disturbance comprises vibration, movement, or a positional shift. In some embodiments, the coolant is temperature conditioned prior to entering the housing, upon entering the housing, or after entering the housing and before exiting the housing. In some embodiments, the device is configured such that during flow, the coolant contacts (i) the housing and/or (ii) one or more components in the housing, during its temperature conditioned in the housing. In some embodiments, the device is configured to facilitate cooling of one or more optical elements of the device at least in part by directing the coolant via one or more channels to the one or more optical elements, the one or more optical elements comprising the mirror, the actuator, a lens, or a collimator. In some embodiments, the device is configured to include one or more apertures configured to direct flow of the coolant to one or more optical elements of the device comprising (I) the mirror, (II) the actuator, (III) the guard, or (IV) the mount. In some embodiments, the one or more apertures directing flow of the coolant to an optical element of the one or more optical elements, are arranged in a single file. In some embodiments, a group of the one or more apertures is configured to direct the coolant towards an optical element. In some embodiments, a group of the one or more apertures is configured to direct the coolant towards different optical elements. In some embodiments, the housing is configured to operatively coupled with (e.g., to) a filter configured to filter a gas flowing into the housing during operation of the device. In some embodiments, the filter is configured to filter particles having a fundamental length scale of at least about 0.1 micrometer or larger. In some embodiments, the filter comprises a High-Efficiency Particulate Air (HEPA) filter. In some embodiments, the mirror includes a curved edge and/or a straight edge. In some embodiments, the guard is configured to (I) allow minimal obstruction to the energy beam impinging on the mirror at a requested location, and (II) maximally guard of the mirror from the stray radiation. In some embodiments, the guard is configured to shield of the mirror from the stray radiation at least in part by (a) being configured to absorb at least a portion of the stray radiation, (b) being configured to reflect at least a portion of the stray radiation, or (c) otherwise being configured to hinder the stray radiation from reaching the mirror. In some embodiments, the guard has a shape having a two-dimensional cross section (abbreviated herein as a “2D shape”) that (a) is configured to absorb at least a portion of the stray radiation, (b) is configured to reflect at least a portion of the stray radiation, or (c) is otherwise configured to hinder the stray radiation from reaching the mirror. In some embodiments, the 2D shape comprises a superposition of basic two-dimensional (2D) geometric shapes. In some embodiments, the basic 2D shape includes an elliptical shape and/or a polygonal shape. In some embodiments, the basic 2D shape includes a circle, an oval, a triangle, a rectangle, a parallelogram, a rhombus, a kite, a trapezoid, a pentagon, a hexagon, a heptagon, an octagon, a nonagon, or a decagon. In some embodiments, the oval comprises an ellipse. In some embodiments, a circumference of the 2D shape comprises a curvature and a straight line. In some embodiments, a circumference of the 2D shape includes a curved corner and/or a sharp corner. In some embodiments, the 2D has an asymmetrical shape. In some embodiments, the stray radiation comprises (i) radiation entering the housing through the optical window and/or (ii) reflected from one or more optical elements disposed in the housing. In some embodiments, the one or more optical elements differ from (I) the mirror, (II) the actuator, (III) the guard, or (IV) the mount. In some embodiments, the one or more optical elements comprise (I) the mirror, (II) the actuator, (III) the guard, or (IV) the mount. In some embodiments, the guard, housing, and/or mount includes a material comprising a ceramic, an elemental metal, a metal alloy, an allotrope of elemental carbon, a polymer, or a resin. In some embodiments, the mirror is part of a galvanometer scanner. In some embodiments, the device further comprises at least one other (i) at least one other mirror, or (ii) at least one other actuator. In some embodiments, the optical path is disposed in one or more channels within the housing. In some embodiments, a channel of the one or more channels comprises perforations configured to facilitate egress of gas from an interior of the channel. In some embodiments, the mount is configured as a symmetric skeleton supporting the mirror. In some embodiments, the mount has a central portion from which supporting beams extend to different edges of the mirror. In some embodiments, the mirror comprise edges, and the edges are (e.g., substantially) evenly spaced from each other. In some embodiments, the supporting beams being (are) configured to (A) support (e.g., substantially) similar weight and/or (B) withstand a similar force as compared to each other. In some embodiments, the energy beam is part of an energy beam set, wherein the optical window is part of an optical window set, and wherein the optical window set has the same number of optical windows as a number of energy beams in the energy beam set, and wherein each optical window of the optical window set is configured to respectfully facilitate transmission of each of the energy beams of the energy beam set. In some embodiments, the housing is configured to engage with an energy source configured to generate the energy beam. In some embodiments, the energy source comprises a laser source, and wherein the energy beam comprises a laser beam. In some embodiments, the laser source comprises a fiber laser. In some embodiments, the fiber laser comprises a laser diode pumped fiber laser. In some embodiments, the energy beam is of at least about 150 Watts (W), 200 W, 250 W, 500 W, 750 W, or 1000 W. In some embodiments, the housing is included in a plurality of housings. In some embodiments, the plurality of housing is encased in a casing. In some embodiments, the casing is configured to engage with (i) an energy source for the energy beam, (ii) a coolant source, and/or (iii) a gas source. In some embodiments, two housings of the plurality of housings merge into a single housing having a separating interior wall that separates each of the two housings. In some embodiments, the plurality of housings comprises at least 2, 4, 6, 8, 10, 12, 16, 24, 32, or 64 housings. In some embodiments, the plurality of housings includes an even number of housings. In some embodiments, two housings of at least one pair of housings of the plurality of housings are symmetrically arranged with respect to each other. In some embodiments, symmetrically arranged with respect to each other comprises a rotational symmetry axis, or a mirror symmetry plane, wherein the rotational symmetry axis is disposed between the two housings of the pair of housings, and wherein the mirror symmetry plane is disposed between the two housings of the pair of housings. In some embodiments, (A) the rotational symmetry axis and/or (B) the mirror symmetry plane, is perpendicular to (i) a plane in which the optical window is disposed and/or (ii) a floor of the housing relative to a gravitational center. In some embodiments, the symmetry of the rotational symmetry axis comprises a C2 (180 degrees), C3 (120 degrees), or C4 (90 degrees) symmetry axis. In some embodiments, at least two housings of the plurality of housings are asymmetrically arranged with respect to each other. In some embodiments, at least two housings of the plurality of housings are (e.g., substantially) identical to each other. In some embodiments, at least two housings of the plurality of housings are (e.g., substantially) different from each other. In some embodiments, being different from each other includes a difference in (i) a difference in a shape of the housing, (ii) a difference in a configuration of optical elements and/or (iii) a difference in a content of the optical elements, wherein the optical elements comprise the mirror, the actuator, the optical window, the guard, or the mount of the mirror. In some embodiments, the plurality of housings is configured to operatively couple with (e.g., to) a plurality of optical windows disposed adjacent to each other such that each housing of the plurality of housings is engaged with each optical window of the plurality of optical windows; and wherein each housing of the plurality of housings is configured to extend away from the optical window. In some embodiments, at least one pair of housings of the plurality of housings is disposed such that housings of the at least one pair of housings are disposed at opposing sides of a processing chamber ceiling, the processing chamber including the optical window at its ceiling. In some embodiments, each housing of the plurality of housings is configured to extend away from the optical window to engage with (i) an energy source for the energy beam, (ii) a coolant source, and/or (iii) a gas source. In some embodiments, optical windows of the plurality of optical windows are symmetrically arranged with respect to each other. In some embodiments, housings of the plurality of housings are symmetrically arranged with respect to each other in the symmetry of the optical windows of the plurality of optical windows. In some embodiments, the symmetry comprises (i) a mirror symmetry plane or (ii) a rotational symmetry axis, the mirror symmetry plane being perpendicular to the plane in which the optical windows are disposed, and wherein the rotational symmetry axis being perpendicular to the plane in which the optical windows are disposed. In some embodiments, the rotational symmetry axis comprises a C2 (180 degrees), C3 (120 degrees), or C4 (90 degrees) symmetry axis. In some embodiments, the rotational symmetry axis and/or the mirror symmetry plane are also of the housings. In some embodiments, the housing comprises an opaque or a transparent material, wherein transparent is to an average person. In some embodiments, the housing comprises at least one viewing window. In some embodiments, the at least one viewing window comprises a material protecting a viewer from the energy beam. In some embodiments, the material comprises a layer of material. In some embodiments, the material comprises an absorptive or a reflective material. In some embodiments, the material comprises a polymer or a resin. In some embodiments, the material comprises an elemental metal or a metal alloy. In some embodiments, the housing is configured to engage with (i) an energy source for the energy beam, (ii) a coolant source, and/or (iii) a gas source. In some embodiments, the device is operatively coupled with, or is part of, a three-dimensional printing system. In some embodiments, the target surface is an exposed surface of a material bed in which the one or more three-dimensional objects are being printed. In some embodiments, the material bed comprises powder material. In some embodiments, the material bed comprises elemental metal, metal alloy, an allotrope of elemental carbon, or a ceramic. In some embodiments, the one or more three-dimensional objects are being printed in a processing chamber operatively coupled to the housing, the processing chamber being configured to operate at an internal atmosphere different from an ambient atmosphere outside of the processing chamber. In some embodiments, the internal atmosphere of the processing chamber (i) has a gas content less reactive with a starting material of the three-dimensional printing as compared to reactivity of the gas content of the ambient atmosphere, and/or (ii) has a gas pressure different than the gas pressure of the ambient atmosphere. In some embodiments, the gas pressure of the internal atmosphere of the processing chamber is higher than the gas pressure of the ambient atmosphere. In some embodiments, the internal atmosphere of the processing chamber is a first internal atmosphere, and where the housing has a second internal atmosphere. In some embodiments, the first atmosphere comprises argon or nitrogen. In some embodiments, the second atmosphere comprises air. In some embodiments, the first atmosphere comprises a reactive agent at a lower concentration relative to its concentration in the ambient atmosphere. In some embodiments, the reactive agent comprises water or oxygen. In some embodiments, the second atmosphere is different from the first atmosphere different by at least one characteristic. In some embodiments, the second atmosphere is similar to the first atmosphere by at least one characteristic. In some embodiments, the at least one characteristic comprises a gas content, a velocity, a flow path, or a pressure. In some embodiments, the housing is a field replaceable unit. In some embodiments, the housing can be maneuvered without (e.g., substantially) measurably altering the beam path in the housing. In some embodiments, the housing comprises a prism. In some embodiments, the mirror is substituted by at least one prism.

In another aspect, an apparatus for energy beam translation, the apparatus comprises at least one controller configured to (a) operatively coupled with (e.g., to) any of the above devices, and (b) execute, or direct execution of, one or more operations associated in any of the above devices, the one or more operations comprises translation of the energy beam along the target surface. For example, in another aspect disclosed herein is an apparatus for energy beam translation, the apparatus comprises at least one controller configured to operatively couple with (e.g., to) a device; and direct the device to translate the energy beam along a target surface, the device comprises (I) an actuator (II) a mirror operatively coupled with (e.g., to) the actuator configured to move (e.g., rotate) the mirror about an axis, the mirror being configured to deflect the energy beam impinging on the mirror, and (III) a housing configured to (a) accommodate the mirror, (b) facilitate transmission of the energy beam propagating along an optical path disposed in the housing, and (c) operatively couple with (e.g., to) an optical window configured to facilitate (e.g., allow) the energy beam to propagate therethrough and out of the housing (e.g., and to the target surface); wherein: (A) during operation, the device is configured to bring about translation of (e.g., translate) the energy beam along the target surface with a positional error at the target surface, the positional error being of a value of at most about 0.01 percent or a lower percentage, the value of the positional error being relative to a portion of the optical path from the axis of the mirror to the target surface; (B) the device comprises a guard configured to shield the mirror from at least a portion of stray radiation in the housing; (C) the mirror being (is) coupled with (e.g., to) the actuator with an adhesive having a liquidous phase transition at a temperature of at least about 120° C. or at a higher temperature; (D) the device is configured to maintain its standard operation at a temperature of at least about 80° C. or at a higher temperature, the standard operation being at an ambient temperature (external to the device); (E) the device is configured to maintain the standard operation while being subject to stray radiation that increases the temperature (of the standard operation) by a temperature increase value of from about zero ° C. to at least about 25° C. or by a higher temperature increase value, the temperature increase being (i) of the actuator and/or (ii) of the mirror; (F) a fastener of the actuator has a torque value of at least about 1.5 Newton*meters (Nm) or a higher torque value; (G) during operation, the mirror is configured to have a frequency response drift during use, the frequency response drift having a value of at most about two hertz per degree Celsius or a lower value; (H) during operation, the mirror is configured to have a total drift tolerance (frequency) having a value of at most about 100 Hertz or a lower total drift tolerance value; (I) the device comprises an optical element having a reflectivity value of at least about 90 percent or higher, the optical element comprises the mirror, a mount of the mirror, the actuator, or the guard, e.g., the reflectivity being of the energy beam; or (J) any combination of (A) to (I). In some embodiments, during operation, the device is configured to bring about translation of (e.g., translate) the energy beam along a target surface with a positional error at the target surface, the positional error being of a value of at most about 0.01 percent or a lower percentage, the value of the positional error being relative to a portion of the path from the axis of the mirror to the target surface. In some embodiments, the device comprises a guard configured to shield the mirror from at least a portion of stray radiation in the housing. In some embodiments, the mirror being (is) coupled with (e.g., to) the actuator with an adhesive having a liquidous phase transition at a temperature of at least about 120° C. or at a higher temperature. In some embodiments, the device is configured to maintain its standard operation at a temperature of at least about 80° C. or at a higher temperature, the standard operation being at an ambient temperature (external to the device). In some embodiments, the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror. In some embodiments, a fastener of the actuator has a torque value of at least about 1.5 Newton*meters (Nm) or a higher torque value. In some embodiments, during operation, the mirror is configured to have a frequency response drift during use, the frequency response drift having a value of at most about two hertz per degree Celsius or a lower value. In some embodiments, during operation, the mirror is configured to have a total drift tolerance (frequency) having a value of at most about 100 Hertz or a lower total drift tolerance value. In some embodiments, the device comprises an optical element having a reflectivity value of at least about 90 percent or higher, the optical element comprises the mirror, a mount of the mirror, the actuator, or the guard (e.g., the reflectivity being of the energy beam). In some embodiments, the at least one controller is included in the one or more controllers. In some embodiments, the at least one controller utilizes a feed forward control scheme and/or a feedback control scheme. In some embodiments, the at least one controller is configured to (a) operatively couple with (e.g., to) the actuator; and (b) direct the actuator to operate to translate the mirror about the axis. In some embodiments, the at least one controller is configured to direct the actuator at least in part by diminishing temperature effects on the actuator and/or on the mirror, the temperature effects occurring during operation of the device. In some embodiments, the at least one controller is configured to diminish the temperature effects at least in part by utilizing a relationship, a table, a simulation, and/or historical data. In some embodiments, the relationship and/or table utilizes empirical temperature measurements. In some embodiments, the simulation comprises a physics simulation and/or an artificial intelligence learning scheme. In some embodiments, the at least one controller is configured to diminish the temperature effects at least in part by utilizing a positional drift at a temperature, the positional drift being of the mirror and/or of the actuator. In some embodiments, the at least one controller is configured to operatively couple with (e.g., to) one or mor sensors comprising a temperature sensor, a humidity sensor, a positional sensor, a debris sensor, or an optical density sensor. In some embodiments, the actuator comprises a motor, and wherein the positional sensor comprises an encoder of the motor. In some embodiments, the at least one controller is configured to (a) operatively couple with (e.g., to) a gas flow system, and (b) direct the gas flow system to flow the gas in the housing. In some embodiments, the at least one controller is configured to (a) operatively couple with (e.g., to) a temperature conditioning system, and (b) direct the temperature conditioning system to condition the temperature in the housing. In some embodiments, the at least one controller is configured to (a) operatively couple with (e.g., to) an energy source, and (b) direct the energy source to generate the energy beam. In some embodiments, the at least one controller is configured to direct the energy beam to print one or more three-dimensional objects in a printing cycle. In some embodiments, the at least one controller is configured to (a) operatively couple with (e.g., to) a gas conveyance system, and (b) direct the gas conveyance system to flow gas into a processing chamber in which one or more three-dimensional objects are being printed by utilizing radiation or another energy beam. In some embodiments, the at least one controller is configured to control an atmosphere in the processing chamber to be above ambient pressure external to the processing chamber. In some embodiments, the at least one controller is configured to (a) operatively couple with (e.g., to) a gas filtration system, and (b) direct the gas filtration system to filter the gas before entering the housing. In some embodiments, the gas filtration system is configured to filter gas utilized during three-dimensional printing in a processing chamber in which one or more three-dimensional objects have been printed. In some embodiments, the gas filtration system is configured to filter gas not utilized in a processing chamber in which one or more three-dimensional objects have been printed.

In another aspect, Non-transitory computer readable program instructions for energy beam translation, the program instructions, when read by one or more processors operatively coupled with (e.g., to) the device in any of the above devices, cause the one or more processors to execute, or direct execution of, one or more operations associated in any of the above devices, the one or more operations comprises translating the energy beam along the target surface. For example, in another aspect disclosed herein are non-transitory computer readable program instructions for energy beam translation, the program instructions, when read by one or more processors operatively coupled with (e.g., to) a device; cause the one or more processors to execute, or direct execution, of one or more operations associated the device, the one or more operations comprises translating the energy beam along a target surface, the device comprises (I) an actuator (II) a mirror operatively coupled with (e.g., to) the actuator configured to move the mirror about an axis, the mirror being configured to deflect the energy beam impinging on the mirror, and (III) a housing configured to (a) accommodate the mirror, (b) facilitate translation of the energy beam propagating along an optical path disposed in the housing (e.g., the translation being with respect to a target surface), and (c) operatively couple with (e.g., to) an optical window configured to allow the energy beam to propagate therethrough and out of the housing (e.g., and along the target surface); wherein: (A) during operation, the device is configured to bring about translation of (e.g., translate) the energy beam along the target surface with a positional error at the target surface, the positional error being of a value of at most about 0.01 percent or a lower percentage, the value of the positional error being relative to a portion of the optical path from the axis of the mirror to the target surface; (B) the device comprises a guard configured to shield the mirror from at least a portion of stray radiation in the housing; (C) the mirror being (is) coupled with (e.g., to) the actuator with an adhesive having a liquidous phase transition at a temperature of at least about 120° C. or at a higher temperature; (D) the device is configured to maintain its standard operation at a temperature of at least about 80° C. or at a higher temperature, the standard operation being at an ambient temperature (external to the device); (E) the device is configured to maintain the standard operation while being subject to stray radiation that increases the temperature (of the standard operation) by a temperature increase value of from about zero ° C. to at least about 25° C. or by a higher temperature increase value, the temperature increase being (i) of the actuator and/or (ii) of the mirror; (F) a fastener of the actuator has a torque value of at least about 1.5 Newton*meters (Nm) or a higher torque value; (G) during operation, the mirror is configured to have a frequency response drift (during use), the frequency response drift having a value of at most about two hertz per degree Celsius or a lower value; (H) during operation, the mirror is configured to have a total drift tolerance (frequency) having a value of at most about 100 Hertz or a lower total drift tolerance value; (I) the device comprises an optical element having a reflectivity value of at least about 90 percent or higher, the optical element comprises the mirror, a mount of the mirror, the actuator, or the guard (e.g., the reflectivity being of the energy beam); or (J) any combination of (A) to (I). In some embodiments, during operation, the device is configured to bring about translation of (e.g., translate) the energy beam along a target surface with a positional error at the target surface, the positional error being of a value of at most about 0.01 percent or a lower percentage, the value of the positional error being relative to a portion of the path from the axis of the mirror to the target surface. In some embodiments, the device comprises a guard configured to shield the mirror from at least a portion of stray radiation in the housing. In some embodiments, the mirror being (is) coupled with (e.g., to) the actuator with an adhesive having a liquidous phase transition at a temperature of at least about 120° C. or at a higher temperature. In some embodiments, the device is configured to maintain its standard operation at a temperature of at least about 80° C. or at a higher temperature, the standard operation being at an ambient temperature (external to the device). In some embodiments, the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror. In some embodiments, a fastener of the actuator has a torque value of at least about 1.5 Newton*meters (Nm) or a higher torque value. In some embodiments, during operation, the mirror is configured to have a frequency response drift during use, the frequency response drift having a value of at most about two hertz per degree Celsius or a lower value. In some embodiments, during operation, the mirror is configured to have a total drift tolerance (frequency) having a value of at most about 100 Hertz or a lower total drift tolerance value. In some embodiments, the device comprises an optical element having a reflectivity value of at least about 90 percent or higher, the optical element comprises the mirror, a mount of the mirror, the actuator, or the guard (e.g., the reflectivity being of the energy beam). In some embodiments, program instructions comprise a feed forward control scheme and/or a feedback control scheme. In some embodiments, the one or more processors are operatively coupled with (e.g., to) the actuator; and wherein the operations comprise directing the actuator to operate to translate the mirror about the axis. In some embodiments, the operations comprise directing the actuator at least in part by diminishing temperature effects on the actuator and/or on the mirror, the temperature effects occurring during operation of the device. In some embodiments, the operations comprise diminishing, or directing diminishing of, the temperature effects at least in part by utilizing a relationship, a table, a simulation, and/or historical data. In some embodiments, the relationship and/or table utilizes empirical temperature measurements. In some embodiments, the simulation comprises a physics simulation and/or an artificial intelligence learning scheme. In some embodiments, the operations comprise diminishing, or directing diminishing of, the temperature effects at least in part by utilizing a positional drift at a temperature, the positional drift being of the mirror and/or of the actuator. In some embodiments, the one or more processors are operatively coupled with (e.g., to) one or more sensors comprising a temperature sensor, a humidity sensor, a positional sensor, a debris sensor, or an optical density sensor. In some embodiments, the actuator comprises a motor, and wherein the positional sensor comprises an encoder of the motor. In some embodiments, the one or more processors are operatively coupled with (e.g., to) a gas flow system, and wherein the operations comprise directing the gas flow system to flow the gas in the housing. In some embodiments, the gas flow system is configured to flow condensed dry air. In some embodiments, the gas flow system is configured to flow gas having a reactive agent in a concentration similar to that in the ambient atmosphere external to the housing. In some embodiments, the reactive agent comprises oxygen. In some embodiments, the reactive agent is reactive with a starting material of a three-dimensional process for which the energy beam is utilized. In some embodiments, the one or more processors is operatively coupled with (e.g., to) a temperature conditioning system, and wherein the operations comprising directing the temperature conditioning system to condition the temperature in the housing. In some embodiments, the at least one processors are operatively coupled with (e.g., to) an energy source, and wherein the operations comprising directing the energy source to generate the energy beam. In some embodiments, the operations comprise directing the energy beam to print one or more three-dimensional objects in a printing cycle. In some embodiments, the one or more processors are operatively coupled with (e.g., to) a gas conveyance system, and wherein the operations comprise directing the gas conveyance system to flow gas into a processing chamber in which one or more three-dimensional objects are being printed by utilizing radiation other energy beam. In some embodiments, the gas conveyance system is configured to flow gas having a reactive agent in a concentration different from that in the ambient atmosphere external to a processing chamber; wherein the reactive agent is reactive with a starting material of a three-dimensional process for which the energy beam is utilized. In some embodiments, the reactive agent comprises oxygen or humidity. In some embodiments, the operations comprise controlling, or directing control of, an atmosphere in the processing chamber to be above ambient pressure external to the processing chamber. In some embodiments, the at least one controller is configured to (a) operatively couple with (e.g., to) a gas filtration system, and (b) direct the gas filtration system to filter the gas before entering into the housing. In some embodiments, the gas filtration system is configured to filter gas utilized during three-dimensional printing in a processing chamber in which one or more three-dimensional objects have been printed. In some embodiments, the gas filtration system is configured to filter gas not utilized in a processing chamber in which one or more three-dimensional objects have been printed.

In another aspect, a method for energy beam translation, the method comprises: (a) providing the device in any of the above devices; and (b) executing, or directing execution of, one or more operations associated in any of the above devices, the one or more operations comprises translating the energy beam along the target surface. For example, in another aspect disclosed herein is a method for energy beam translation, the method comprises: providing a device; and performing, or directing performance of, one or more operations associated with the device, the one or more operations comprise translating the energy beam along a target surface, the device comprises (I) an actuator (II) a mirror operatively coupled with (e.g., to) the actuator configured to move (e.g., rotate) the mirror about an axis, the mirror being configured to deflect the energy beam impinging on the mirror, and (III) a housing configured to (a) accommodate the mirror, (b) facilitate transmission of the energy beam propagating along an optical path disposed in the housing, and (c) operatively couple with (e.g., to) an optical window configured to allow the energy beam to propagate therethrough and out of the housing (e.g., and towards the target surface); wherein: (A) during operation, the device is configured to bring about translation of (e.g., translate) the energy beam along the target surface with a positional error at the target surface, the positional error being of a value of at most about 0.01 percent or a lower percentage, the value of the positional error being relative to a portion of the optical path from the axis of the mirror to the target surface; (B) the device comprises a guard configured to shield the mirror from at least a portion of stray radiation in the housing; (C) the mirror being (is) coupled with (e.g., to) the actuator with an adhesive having a liquidous phase transition at a temperature of at least about 120° C. or at a higher temperature; (D) the device is configured to maintain its standard operation at a temperature of at least about 80° C. or at a higher temperature, the standard operation being at an ambient temperature (external to the device); (E) the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror; (F) a fastener of the actuator has a torque value of at least about 1.5 Newton*meters (Nm) or a higher torque value; (G) during operation, the mirror is configured to have a frequency response drift (during use), the frequency response drift having a value of at most about two hertz per degree Celsius or a lower value; (H) during operation, the mirror is configured to have a total drift tolerance (frequency) having a value of at most about 100 Hertz or a lower total drift tolerance value; (I) the device comprises an optical element having a reflectivity value of at least about 90 percent or higher, the optical element comprises the mirror, a mount of the mirror, the actuator, or the guard (e.g., the reflectivity being of the energy beam); or (J) any combination of (A) to (I). In some embodiments, during operation, the device is configured to bring about translation of (e.g., translate) the energy beam along a target surface with a positional error at the target surface, the positional error being of a value of at most about 0.01 percent or a lower percentage, the value of the positional error being relative to a portion of the path from the axis of the mirror to the target surface. In some embodiments, the device comprises a guard configured to shield the mirror from at least a portion of stray radiation in the housing. In some embodiments, the mirror being (is) coupled with (e.g., to) the actuator with an adhesive having a liquidous phase transition at a temperature of at least about 120° C. or at a higher temperature. In some embodiments, the device is configured to maintain its standard operation at a temperature of at least about 80° C. or at a higher temperature, the standard operation being at an ambient temperature (external to the device). In some embodiments, the device is configured to maintain the standard operation while being subject to stray radiation that increases the temperature (e.g., of the standard operation) by a temperature increase value of from about zero ° C. to at least about 25° C. or by a higher temperature increase value, the temperature increase being (i) of the actuator and/or (ii) of the mirror. In some embodiments, a fastener of the actuator has a torque value of at least about 1.5 Newton*meters (Nm) or a higher torque value. In some embodiments, during operation, the mirror is configured to have a frequency response drift during use, the frequency response drift having a value of at most about two hertz per degree Celsius or a lower value. In some embodiments, during operation, the mirror is configured to have a total drift tolerance (frequency) having a value of at most about 100 Hertz or a lower total drift tolerance value. In some embodiments, the device comprises an optical element having a reflectivity value of at least about 90 percent or higher, the optical element comprises the mirror, a mount of the mirror, the actuator, or the guard (e.g., the reflectivity being of the energy beam). In some embodiments, utilizing a feed forward control scheme and/or a feedback control scheme to control movement of the mirror. In some embodiments, translating the mirror about the axis at least in part by using the actuator. In some embodiments, diminishing temperature effects on the actuator and/or on the mirror, the temperature effects occurring during operation of the device. In some embodiments, diminishing the temperature effects at least in part by utilizing a relationship, a table, a simulation, and/or historical data. In some embodiments, the relationship and/or table utilizes empirical temperature measurements. In some embodiments, the simulation comprises a physics simulation and/or an artificial intelligence learning scheme. In some embodiments, diminishing, or directing diminishing of, the temperature effects is accomplished at least in part by utilizing a positional drift at a temperature, the positional drift being of the mirror and/or of the actuator. In some embodiments, the method further comprises using one or more sensors comprising a temperature sensor, a humidity sensor, a positional sensor, a debris sensor, or an optical density sensor. In some embodiments, the actuator comprises a motor, and wherein the positional sensor comprises an encoder of the motor. In some embodiments, the method further comprises using a gas flow system to flow gas in the housing. In some embodiments, the gas flow system is configured to flow condensed dry air. In some embodiments, the gas flow system is configured to flow gas having a reactive agent in a concentration similar to that in the ambient atmosphere external to the housing. In some embodiments, the reactive agent comprises oxygen. In some embodiments, the reactive agent is reactive with a starting material of a three-dimensional process for which the energy beam is utilized. In some embodiments, the method further comprises using a temperature conditioning system to condition the temperature in the housing. In some embodiments, the method further comprises using an energy source to generate the energy beam. In some embodiments, the method further comprises directing the energy beam to print one or more three-dimensional objects in a printing cycle. In some embodiments, the method uses a gas conveyance system to flow gas into a processing chamber in which one or more three-dimensional objects are being printed by utilizing radiation other energy beam. In some embodiments, the gas conveyance system is configured to flow gas having a reactive agent in a concentration different from that in the ambient atmosphere external to a processing chamber; wherein the reactive agent is reactive with a starting material of a three-dimensional process for which the energy beam is utilized. In some embodiments, the reactive agent comprises oxygen or humidity. In some embodiments, the method further comprises controlling an atmosphere in the processing chamber to be above ambient pressure external to the processing chamber. In some embodiments, the method further comprises using a gas filtration system to filter the gas before entering into the housing. In some embodiments, the method of the gas further comprises filtration system is configured to filter gas utilized during three-dimensional printing in a processing chamber in which one or more three-dimensional objects have been printed. In some embodiments, the gas filtration system is configured to filter gas not utilized in a processing chamber in which one or more three-dimensional objects have been printed.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of operations (e.g., instructions) of the apparatus are directed by different controllers.

In some embodiments, at least two of operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple with (e.g., to) the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple with (e.g., to) a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple with (e.g., to) another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple with (e.g., to) the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively couped to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure or a portion thereof (e.g., optical housing). In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple with (e.g., to) at least one controller configured to (i) operatively couple with (e.g., to) the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.,” “FIGs.,” “Fig.,” and “Figs.” herein), of which:

FIG. 1 schematically illustrates a side view of a three-dimensional (3D) printer and its components;

FIG. 2 schematically illustrates a 3D printing system and a user;

FIG. 3 schematically illustrates a side view of a 3D printer and its components;

FIG. 4 shows a schematic side view of a 3D printing system and its components;

FIG. 5 schematically illustrates various components of a 3D printing system and portions thereof;

FIG. 6 schematically illustrates various components of a 3D printing system and portions thereof;

FIG. 7 schematically illustrates various components of a 3D printing system and portions thereof;

FIG. 8 schematically illustrates a side view of components in a 3D printer;

FIG. 9 schematically illustrates a side view of a 3D printer and its components;

FIG. 10 schematically illustrates components of an optical system;

FIG. 11 schematically illustrates an example of systematic variation within a 3D printer;

FIG. 12 schematically illustrates a view of a 3D printer and its components;

FIG. 13 schematically illustrates various 3D printer components;

FIG. 14 schematically illustrates various 3D printer components;

FIG. 15 schematically illustrates various 3D printer components;

FIG. 16 schematically illustrates a side view of a 3D printer and its components;

FIG. 17 schematically illustrates perspective views of components of a 3D printer;

FIG. 18 schematically illustrates a perspective view of a processing chamber with manifolds, and a perspective view of manifolds;

FIG. 19 schematically illustrates various components relating to an optical system;

FIG. 20 schematically illustrates various components relating to an optical system;

FIG. 21 schematically illustrates various components relating to an optical system;

FIG. 22 schematically illustrates various components relating to an optical system;

FIG. 23 schematically illustrates various components relating to an optical system;

FIG. 24 schematically illustrates various components relating to an optical system;

FIG. 25 schematically illustrates a path;

FIG. 26 schematically illustrates various paths;

FIG. 27 schematically illustrates a computer control system that is programmed or otherwise configured to facilitate the formation of one or more 3D objects;

FIG. 28 is a flow diagram of an example process of a 3D system;

FIG. 29 depicts a block diagram of an example control scheme;

FIG. 30 depicts a block diagram of an example control scheme;

FIG. 31 depicts a block diagram of a control scheme;

FIG. 32 depicts example Bode plots for a plant;

FIG. 33 depicts example oscillatory response plot of a plant;

FIG. 34 depicts example Bode plots for a plant;

FIG. 35 depicts example oscillatory response plot of a plant;

FIG. 36 depicts example Bode plots for a plant;

FIG. 37 depicts a block diagram of a control scheme;

FIG. 38 schematically illustrates various 3D printer components;

FIG. 39 schematically illustrates various components of an optical system; and

FIG. 40 schematically illustrates various optical components.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) can be referred herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by at least one material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed at least in part by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may be in the form of a powder, wires, sheets, or droplets. The pre-transformed material may be pulverous. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In some embodiments, the deposited pre-transformed material within the enclosure is a liquid material, semi-solid material (e.g., gel), or a solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the afore-mentioned electrical conductivity values (e.g., from about 1*10⁵ S/m to about 1*10⁸ S/m). The thermal conductivity, electrical resistivity, electrical conductivity, and/or density can be measured at ambient temperature (e.g., at R.T., or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the afore-mentioned values (e.g., from about 1×10⁻⁵ Ω*m to about 1×10^{-8 0}*m). The high thermal conductivity may be at least about 10 Watts per meter times Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the afore-mentioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

In some embodiments, the elemental metal is an alkali metal, an alkaline earth metal, a transition metal, a rare-earth element metal, a precious metal, or another metal. The elemental metal may comprise Titanium, Copper, Platinum, Gold, or Silver.

In some embodiments, the metal alloy comprises iron-based alloy, nickel based alloy, cobalt based alloy, chrome based alloy, cobalt chrome based alloy, titanium based alloy, magnesium based alloy, or copper based alloy. The alloy may comprise an oxidation or corrosion resistant alloy. The alloy may comprise a super alloy (e.g., Inconel). The alloy may comprise an alloy used for aerospace applications, automotive application, surgical application, or implant applications. The metal may include a metal used for aerospace applications, automotive application, surgical application, or implant applications.

In some embodiments, the metal alloys are Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers and associated methods, software, systems, devices, and apparatuses, can be found in International Patent Application Serial Nos. PCT/US17/60035 filed Nov. 3, 2017, and PCT/US22/16550 filed Feb. 26, 2022, each of which is entirely incorporated herein by reference.

In some embodiments, the elemental carbon comprises graphite, Graphene, diamond, amorphous carbon, carbon fiber, carbon nanotube, or fullerene.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs. The central tendency may comprise mean, median, or mode. The mean may comprise a geometric mean.

In some embodiments, the powder comprises a particle mixture, which particle comprises a shape. The powder can be composed of a homogenously shaped particle mixture such that all of the particles have substantially the same shape and FLS magnitude within at most about 1%, 5%, 8%, 10%, 15%, 20%, 25%, 30%, 35%, or 40% distribution of FLS.

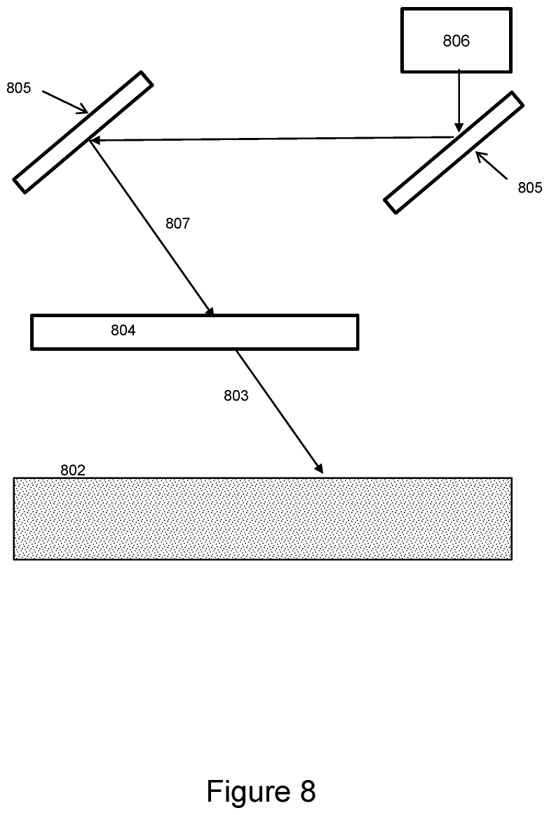

In an aspect provided herein is a system for generating a 3D object comprising: an enclosure for accommodating at least one layer of pre-transformed material (e.g., powder); an energy (e.g., energy beam) capable of transforming the pre-transformed material to form a transformed material; and a controller that directs the energy to impinge on the exposed surface of the layer of pre-transformed material and translate along a path (e.g., as described herein). The transformed material may be capable of hardening to form at least a portion of a 3D object. The system may comprise an energy source generating the energy beam, an optical system (e.g., FIG. 8), a control system, a layer dispensing mechanism such as a recoater, gas source(s), pump(s), nozzle(s), valve(s), sensor(s), display(s), chamber(s), processor(s) comprising or software (e.g., comprising computational scheme(s) such as algorithm(s)) inscribed on a computer readable media/medium. The control system may be configured to control temperature, pressure, gas flow, optics, actuator(s), energy source(s), energy beam(s), and/or atmosphere(s). The chamber may comprise a platform including a base and a substrate. The base may be referred to herein as the “build plate” or “building platform.” The substrate may comprise an elevator piston. The system for generating at least one 3D object (e.g., in a printing cycle) and its components may be any 3D printing system. Examples of materials, 3D printers and associated methods, software, systems, devices, and apparatuses, can be found in PCT/US17/60035 and PCT/US22/16550, each of which is entirely incorporated herein by reference.

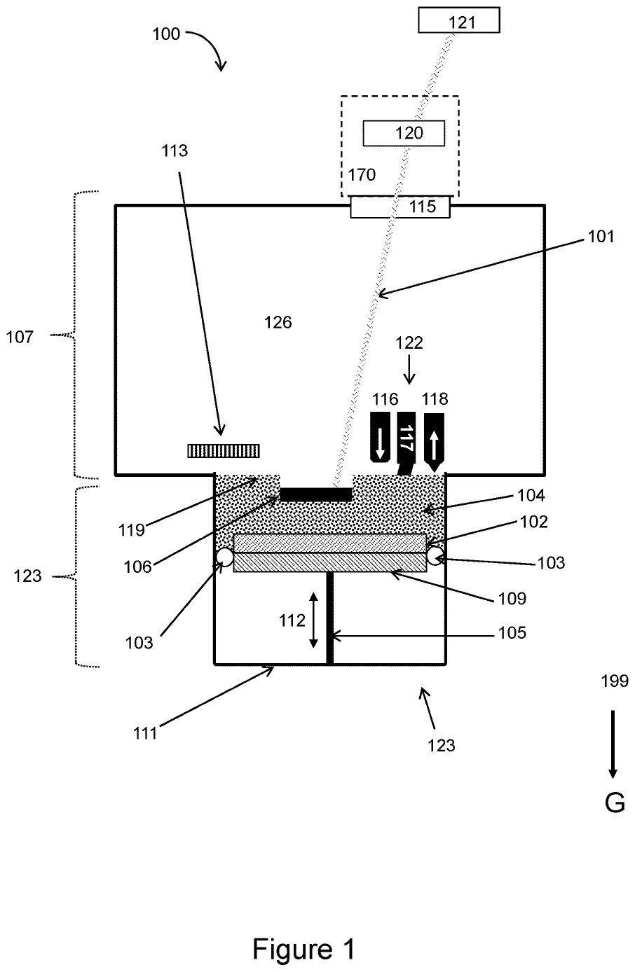

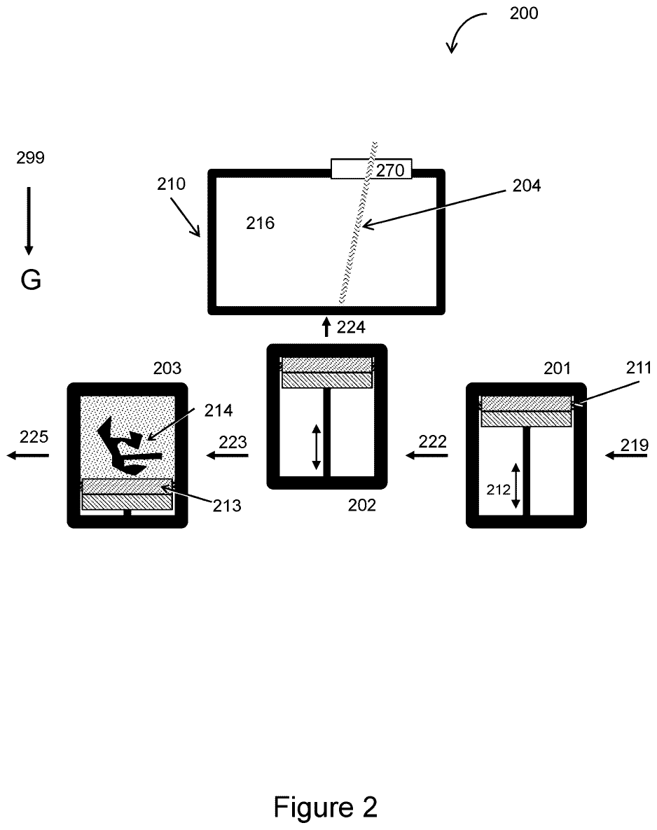

In some embodiments, the 3D printing system comprises a chamber (e.g., FIG. 1, chamber 107 having interior space 126, or FIG. 2, chamber 216). The chamber may be referred herein as the “processing chamber.” The processing chamber may facilitate ingress of an energy beam (e.g., FIG. 1, energy beam 101; FIG. 2, energy beam 204). The energy beam may be directed towards an exposed surface of a material bed (e.g., FIG. 1, 119). The 3D printing system may comprise one or more modules (e.g., FIG. 1, module 123, or FIG. 2, modules 201, 202, and 203). The one or more modules may be referred herein as the “build modules.” At times, at least one build module (e.g., FIG. 1, build module 123) may be situated in the enclosure comprising the processing chamber (e.g., FIG. 1, 116). At times, at least one build module may engage with the processing chamber (e.g., FIG. 1). At times, at least one build module may not engage with the processing chamber (e.g., FIG. 2). At times, a plurality of build modules (e.g., FIG. 2, build modules 201, 202, and 203) may be situated in an enclosure (e.g., FIG. 2, enclosure 200) comprising the processing chamber (e.g., FIG. 2, processing chamber 210). In the examples shown in FIGS. 1 and 2, vectors 199 and 299 points towards a gravitational center. The build module may be configured to reversibly engage and disengage with (e.g., couple with (e.g., to) and decouple from) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent. The FLS (e.g., width, depth, and/or height) of the processing chamber and/or the build plate can be at least about 50 millimeters (mm), 60 mm, 70 mm, 80 mm, 90 mm, 100 mm, 200 mm, 250 mm, 280 mm, 320 mm, 400 mm, 450 mm, 500 mm, 800 mm, 900 mm, 1 meter (m), 2 m, or 5 m. The FLS of the processing chamber and/or the build plate can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber and/or the build plate can be between any of the afore-mentioned values (e.g., 50 mm to about 5 m, from about 250 mm to about 500 mm, or from about 500 mm to about 5 m).

FIG. 1 shows an example of a 3D printing system 100 having a processing chamber 107 coupled with (e.g., to) a build module 123. The build module comprises an elevator having shaft 105 that vertically translate a substrate (e.g., piston) 109 along arrow 112. The base (e.g., build platform) 102 is disposed on substrate (e.g., piston) 109. Material bed 104 is disposed above base 102 (e.g., also referred herein as “building platform”, or “build plate”). Energy source (e.g., laser source) 121 generates energy beam 101 that traverses through an optical system 120 disposed in optical enclosure 170, and through an optical window 115 into processing chamber 107 enclosing interior space 126 that can include an atmosphere. The floor of optical enclosure 170 contacts the top of optical window 115. The processing chamber comprises a layer dispensing mechanism 122 that includes a dispenser 116, a leveler 117, and a remover 118. Processing chamber 107 includes an optional temperature adjustment device 113 (e.g., cooling plate). Seal 103 encircles the substrate and/or base, e.g., to deter (e.g., prevent) migration of material of the material bed from reaching the elevator mechanism (e.g., shaft 105). Energy beam 101 impinges upon an exposed surface 119 of material bed 104, to form at least a portion of a 3D object 106.

In some examples, at least one build module translates relative to the processing chamber. The translation may be parallel or substantially parallel to the bottom surface of the build chamber. In some embodiments, the 3D printing system comprises a plurality of build modules. The 3D printing system may comprise at least 1, 2, 3, 4, 5, 6, 7, 8, 9, or 10 build modules. FIG. 2 shows an example of three build modules (e.g., build modules 201, 202, and 203) and one processing chamber 210. Examples of 3D printers and their components such as enclosures, build modules, unpacking stations, processing chambers and their components, associated methods, software, systems, devices, and apparatuses, can be found in International Patent Application Serial Nos. PCT/US17/60035, PCT/US22/16550, and PCT/US17/39422 filed on Jun. 27, 2017, each of which is entirely incorporated herein by reference.

FIG. 2 shows an example of a 3D printing system 200 having processing chamber 210 enclosing space 216 that can include an atmosphere. Energy beam 204 traverses into space 216 of processing chamber 210. FIG. 2 shows examples of three build modules 201, 202, and 203. Build module 201 includes an elevator that can vertically travel along direction 212, causing vertical translation of the build plate 211. Build module 201 is translated to a position depicted as build module 202. Build module 202 assumes a position at which it is about to engage 224 with processing chamber 210. Build module 203 includes a material bed in which a 3D object 214 is disposed. The build plate 213 of build module 203 is at a lower position as compared to build plate 211 of build module 201, which lower position accommodates the material bed and 3D object 214. The build modules 201-203 may travel in a general direction of arrows 221, 222, 223, 224, and 225 (e.g., directed by controller(s) and/or actuators) towards engagement with the processing chamber before printing (e.g., 221, 222, and 224), or away from the processing chamber after printing 223 and 225.

In some examples, at least one build module engages with the processing chamber to expand the interior volume of the processing chamber (e.g., into the volume of the engaged build module). During at least a portion of the 3D printing process, the atmospheres of the chamber and enclosure may merge. At times, during at least a portion of the 3D printing process, the atmospheres of the chamber and enclosure may remain separate (e.g., one atmosphere above seal 103 and another atmosphere below seal 103, wherein above and below are with respect to gravitational vector 199). The seal may or may not be gas tight. The seal may or may not facilitate atmospheric equilibration. During at least a portion of the 3D printing process, the atmospheres of the build module and processing chamber may be separate. The build module may be mobile or stationary. The build module may comprise an elevator. The elevator may be connected to a platform. The elevator may be reversibly connected to at least a portion of the platform. The elevator may be irreversibly connected to the substrate (e.g., the piston). The build plate and/or substrate may be separated from one or more walls (e.g., side walls) of the build module by a seal (e.g., FIG. 1, 103). The seal may be permeable to at least one gas, and impermeable to the pre-transformed (e.g., and to the transformed) material. The seal may not allow a solid material (e.g., a pre-transformed material and/or a transformed material) to pass through.

In some embodiments, the pre-transformed material (e.g., starting material for the 3D printing) is deposited in an enclosure. FIG. 1 shows an example of a build module container 123 (also referred to herein as a build module). The build module container can contain the pre-transformed material (e.g., without spillage; such as in a material bed FIG. 1, material bed 104). Material may be placed in or inserted to the container. The material may be deposited in, pushed to, sucked into, or lifted to a container. The material may be layered (e.g., spread) in the enclosure such as by using a layer dispensing mechanism 122. The build module container may be configured to enclosure a substrate (e.g., FIG. 1, 109 such as an elevator piston). The substrate may be situated adjacent to the bottom of the build module container (e.g., FIG. 1, 111). Bottom may be relative to the gravitational field along gravitational vector 199 pointing towards gravitational center G, or relative to the position of the footprint of the energy beam (e.g., FIG. 1, energy beam 101) on the layer of pre-transformed material as part of a material bed such as 104. The footprint of the energy beam may follow a Gaussian bell shape. In some embodiments, the footprint of the energy beam does not follow a Gaussian bell shape. The build module container may comprise a platform comprising a base (e.g., FIG. 1, build plate 102). The platform may comprise a substrate or a base. The base may reside adjacent to the substrate. For example, the base may (e.g., reversibly) connect to the substrate. The pre-transformed material may be layer wise deposited adjacent to a side of the build module container (e.g., above and/or on the bottom of the build module container). The pre-transformed material may be layered adjacent to the substrate and/or adjacent to the base. Adjacent to may be above. Adjacent to may be directly above, or directly on. The substrate may have one or more seals that enclose the material in a selected area within the build module container (e.g., FIG. 1, seals 103). The one or more seals may be flexible or non-flexible. The one or more seals may comprise a polymer or a resin. The build module container may comprise the base. The base may be situated within the build module container. The build module container may comprise the platform, which may be situated within the build module container. The enclosure, processing chamber, and/or building module container may comprise (I) a window (e.g., an optical window and/or a viewing window) or (II) an optical system (e.g., FIG. 1, 120). An example of an optical window can be seen in FIG. 1, optical window 115. The optical window may allow the energy beam to pass through without (e.g., substantial) energetic loss. During the 3D printing, a ventilator and/or gas flow may prevent spatter from accumulating on the surface optical window that is disposed within the enclosure (e.g., within the processing chamber). A portion of the enclosure that is occupied by the energy beam (e.g., during the 3D printing) can define a processing cone. During the 3D printing may comprise during the entire 3D printing. The processing cone can be the enclosure space that is occupied by a non-reflected energy beam during the (e.g., entire) 3D printing. The processing cone can be the enclosure space that is occupied by an energy beam that is directed towards the material bed during the (e.g., entire) 3D printing. During the 3D printing may comprise during printing of a layer of hardened material.

In some embodiments, the 3D printer comprises a gas flow mechanism. The gas flow mechanism may be in fluidic contact with one or more enclosures of the 3D printer. For example, the gas flow mechanism may be in fluidic contact with (i) a processing chamber, (ii) a build module, (iii) an optical enclosure, or (iv) any combination thereof. The gas flow mechanism may be in fluidic contact with a processing chamber and/or a build module. The gas flow mechanism may be in fluid communication with the optical enclosure. At times, a gas flow assembly may be in fluid communication with the optical enclosure. The gas flow assembly may be configured to flow gas. The gas flow assembly may be separate from the gas flow mechanism. For example, the gas flow mechanism and the gas flow assembly may be isolated (e.g., fluidically separate) from each other.

In some embodiments, the 3D printer comprises a material dispensing mechanism. The pre-transformed material may be deposited in the enclosure by a material dispensing mechanism (also referred to herein as a layer dispenser, layer forming apparatus, or layer forming device) (e.g., FIG. 1, material dispensing mechanism 122). In some embodiments, the material dispensing mechanism includes one or more material dispensers (also referred to herein as “dispensers”) (e.g., FIG. 1, material dispenser 116), one or more leveling mechanisms (also referred to herein as “levelers”) (e.g., FIG. 1, leveler 117), and/or one or more powder removal mechanisms (also referred to herein as material “removers”) (e.g., FIG. 1, removers 118) to form a layer of pre-transformed material within the enclosure. The deposited material may be leveled by a leveling operation. The leveling operation may comprise using a powder removal mechanism that does not contact the exposed surface of the material bed (e.g., FIG. 1, removers 118). The leveling operation may comprise using a leveling mechanism that contacts the exposed surface of the material bed (e.g., FIG. 1, leveler 117). The material (e.g., powder) dispensing mechanism may comprise one or more dispensers (e.g., FIG. 1, material dispenser 116). The material dispensing system may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). Examples of materials, 3D printers and associated methods, software, systems, apparatuses and devices such as a layer dispensing mechanism and/or a material (e.g., powder) dispenser can be found in PCT/US17/60035, PCT/US22/16550, and PCT/US17/39422, each of which is entirely incorporated herein by reference.

In some embodiments, the 3D object(s) are printed from a material bed. The FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, the FLS of the material bed is in the direction of the gas flow. The layer dispensing mechanism may include components comprising a material dispensing mechanism, material leveling mechanism, material removal mechanism, or any combination or permutation thereof.

In some embodiments, the layer dispensing mechanism may reside within an ancillary chamber. Examples of 3D printers and their components (e.g., ancillary chamber), associated methods, software, apparatuses, systems, and devices, may be any ancillary chamber such as, for example, the one described in International Patent Application serial number PCT/US17/57340, filed Oct. 19, 2017, which is entirely incorporated herein by reference in its entirety. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing).

In some embodiments, the 3D printer comprises a base. The base (also herein, “printing platform” or “building platform”) may be disposed in the enclosure (e.g., in the build module and/or processing chamber). A platform may comprise the base. The platform may be configured to support a material bed. The platform may be configured to support one or more layers of pre-transformed material (e.g., as part of the material bed). The platform may be configured to support at least a portion of the 3D object (e.g., during forming of the 3D object). The platform may comprise a substrate or a base. The substrate and/or the base may be removable or non-removable (e.g., from the 3D printing system and/or relative to each other). The platform (e.g., substrate and/or base) may be fastened to the build module container (e.g., build module) and/or to each other. The platform (or any of its components) may be transportable. The transportation of the platform may be controlled and/or regulated by at least one controller (e.g., by a control system). The platform may be transportable horizontally, vertically, or at an angle (e.g., planar or compound).

In some embodiments, the platform is transferable (e.g., translatable). The platform may be vertically translatable, for example using an actuator. The actuator may cause a vertical translation (e.g., and elevator). An actuator causing a vertical translation (e.g., an elevation mechanism) is shown as an example in FIG. 1, elevation mechanism 105. The up and down arrow next to the elevation mechanism 105 signifies a possible direction of movement of the elevation mechanism, or a possible direction of movement effectuated by the elevation mechanism.

In some examples, auxiliary support(s) adhere to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. In any of the methods described herein, the printed 3D object may be supported only by the pre-transformed material within the material bed (e.g., powder bed, FIG. 1, material bed 104). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material (e.g., as disclosed herein). The platform may comprise glass, stone, zeolite, or a polymeric material. The polymeric material may include a hydrocarbon or fluorocarbon. The platform (e.g., base) may include Teflon. The platform may include compartments for printing small objects. Small may be relative to the size of the enclosure. The compartments may form a smaller compartment within the enclosure, which may accommodate a layer of pre-transformed material.

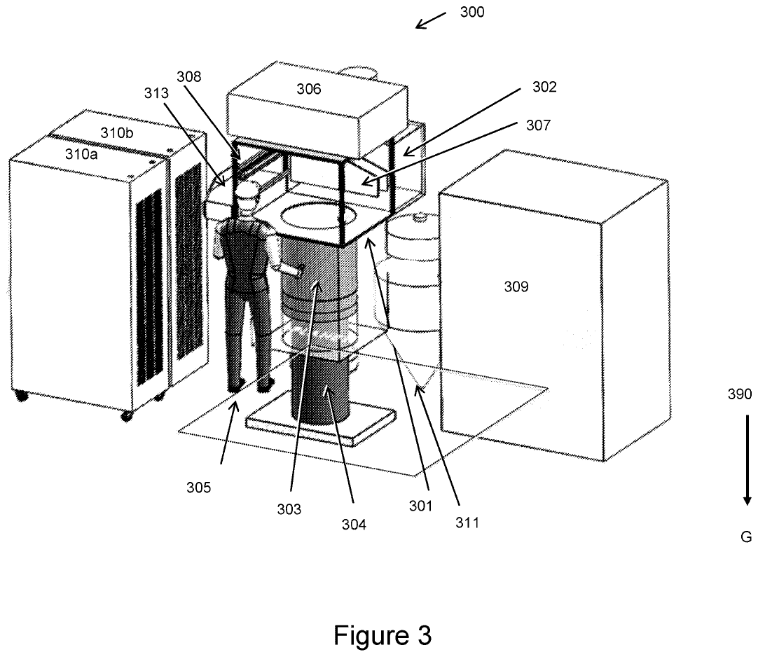

FIG. 3 shows an example of a 3D printing system 300 disposed in relation of gravitational vector 390 directed towards gravitational center G. The 3D printing system comprises processing chamber 301 coupled with (e.g., to) an ancillary chamber (e.g., garage) 302 configured to accommodate a layer dispensing mechanism (e.g., recoater), e.g., in its resting (e.g., idle) position. The processing chamber is coupled with (e.g., to) a build module 303 that extends 304 under a plane (e.g., floor) at which user 305 stands on (e.g., can extend under-grounds). The processing chamber may comprise a door (not shown) facing user 305. 3D printing system 300 comprises enclosure 306 that can comprise an energy beam alignment system (e.g., an optical system) and/or an energy beam directing system (e.g., scanner)—not shown. A layer dispensing mechanism (not shown) may be coupled with (e.g., to) a framing 307 as part of a movement system that facilitate movement of the layer dispensing mechanism along the material bed and garage (e.g., in a reversible back-and-forth movement). The movement system comprises a translation inducer system (e.g., comprising a belt or a chain 308). 3D printing system 300 comprises a filter unit 309, heat exchangers 310a and 310b, pre-transformed material reservoir 311, and gas flow mechanism (e.g., comprising gas inlets and gas inlet portions) disposed in enclosure 313. The filtering system may filter gas and/or pre-transformed (e.g., powder) material. The filtering system may be configured to filter debris (e.g., comprising byproduct(s) of the 3D printing).

In some examples, the 3D printing system requires operation of maximum a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some examples, the 3D printing system requires operation of maximum a single standard work week shift. The 3D printing system may require operation by a human operator working at most of about 50 h, 40 h, 30 h, 20 h, 10h, 5h, or 1 h a week. The 3D printing system may require operation by a human operator working between any of the afore-mentioned time frames (e.g., from about 40 h to about 1 h, from about 40 h to about 20 h, from about 30 h to about 10 h, from about 20 h to about 1 h, or from about 10 h to about 1 h a week). A single operator may support during his daily and/or weekly shift at least 1, 2, 3, 4, 5, 6, 7, 8, 9, or 10 3D printers (i.e., 3D printing systems).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise two, three, four, five, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source (e.g., FIG. 1, 121) may be a laser source. The laser may comprise a fiber laser, a solid-state laser or a diode laser (e.g., diode pumped fiber laser).

In some embodiments, the energy source is a laser source. The laser source may comprise a Nd:YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of materials, 3D printers and associated methods, software, systems, apparatuses and devices such as an energy source generating an energy beam (and the energy beam) can be found in PCT/US17/60035 and PCT/US22/16550, each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

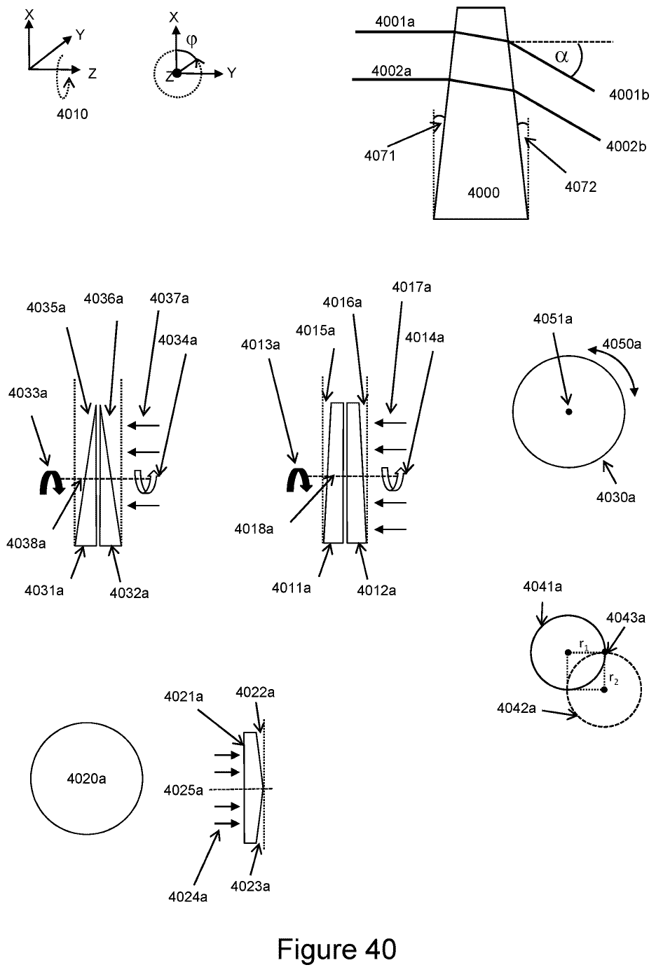

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile. The ring (e.g., doughnut or corona) shaped energy beam can be generated using a physical optical component such as a lens, e.g., a doughnut converter lens. FIG. 40 shows an example of lens 4021a as a vertical cross section, or side view. The scanner may be any scanner disclosed herein, e.g., a galvanometer scanner. The irradiating energy may be directed to one or more scanners. The scanner may direct the irradiating energy on to a position at the target surface. The energy beam may travel through one or more filters, apertures, or optical windows on its way to the target surface (e.g., as depicted in the exposed surface of FIG. 1, 119).

The energy beam has an energy profile. The energy profile of the energy beam may represent the spatial intensity profile of the energy beam at a particular plane transverse to the beam propagation path. FIG. 8 shows examples of energy beam profiles, e.g., energy as a function of distance from the center of the energy beam. The energy beam profile may be represented as the power or energy of the energy beam plotted as a function of a distance within its cross section, e.g., that is perpendicular to its propagation path. The energy beam profile may be substantially uniform, e.g., homogenous. At times, the energy beam profile is not uniform such as intentionally and/or controllably non-uniform. At least one characteristic of the beam profile of the energy may be altered, e.g., before, after, or during the printing such as in real time. The at least one characteristic of the beam profile may comprise its shape, uniformity, amplitude, or at least one of its FLS, e.g., width. The beam profile may be measured perpendicular to the direction of beam propagation. The beam profile may be measured at the target surface. The at least one characteristic of the energy beam may be controllably altered. Controllably altered may comprise manual or automatic control. The automatic control may comprise using at least one controller such as the one disclosed herein. For example, the control system of the 3D printer. The manual control may comprise inserting an optical component to the beam path of the energy beam prior to its impinging on the target surface. The manual control may comprise altering a position of the optical component. The optical component may comprise a converter lens, e.g., FIG. 40, 4021a. The energy beam profile may be substantially uniform. The energy beam profile may comprise a substantially uniform section. The energy beam profile may deviate from uniformity. The energy beam profile may be (e.g., controllably) non-uniform. The energy beam profile may have a shape that facilitates substantially uniform heating of the are at the target surface that is enclosed by the impinging energy beam, e.g., a tile. The energy beam profile may have a shape that facilitates substantially uniform temperature variation of the tile, e.g., including a rim of the tile. The energy beam profile may have a shape that facilitates substantially uniform phase transfer of the material within the tile. For example, the material phase transfer can be solid to liquid. Substantially uniform may be substantially similar, even, homogenous, invariable, consistent, and/or equal. FIG. 40 shows an example of an optical components having a side vertical cross section 4021a. The energy beam enters the optical component 4021 (e.g., converter lens) in direction 4024a with one type of beam profile (e.g., gaussian beam), and exits the optical component with another type of beam profile (e.g., doughnut or corona beam profile). The vertical cross section 4021a of the optical component is symmetrical and a flat side a convex side, with the maximal extending portion (e.g., maximal width of the optical component) disposed symmetrically at the center of the optical component (e.g., converter lens). The width of the optical component may be reduced gradually and symmetrically up to its edge in a manner similar to an isosceles triangle. The optical component has a vertical cross section of an irregular pentagon having right angled sides. The pentagonal cross section is symmetric with respect to its center using a mirror symmetry plane along broken line 4025a, or a C2 rotational symmetry axis along broken line 4025a. The pentagon is devoid of C5 rotational axis. The pentagonal cross section is non-equilateral. The angles 4022a and 4023a are the same or substantially the same, e.g., the angles may be shallow angles. The shallow angles may be at most about 10 degrees (°), 8°, 5°, 3°, 1°, 0.5°, or 0.25°. The angle may be at most about 0.05 milliradians (mrad), 0.1 mrad, 0.2 mrad, 0.3 mrad, 0.5 mrad, 1 mrad, 5 mrad, 10 mrad, or 15 mrad. The inner radius of the doughnut beam profile may follow the formula r=(n−1)*α*f with “r” being the radius, alpha “α” being the angle, “f” being the (e.g., effective) focal length, “n” being the refractive index, and “*” designating the mathematical operation of “times” or “multiplied by.” For example, when the radius is 0.2 mm, the focal length is 1000 mm, and a refractive index of two (n=2); alpha would be about 0.2 milliradians. At times, the optical setup includes a telescopic lens setup comprising a concave lens followed by a convex lens, the telescopic lens setup having an effective focal length. The outer radius of the doughnut beam may correspond to the original spot size of the beam before its conversion by the optical component, e.g., by the converter lens. For example, when the original beam profile of the beam incoming to the optical component (e.g., the converter lens) is a gaussian beam, then the outer radius of the doughnut beam outgoing from the optical component corresponds to the width of the gaussian beam.

In some embodiments, the energy beam (e.g., laser) has a power of at least about 150 Watt (W), 200 W, 250 W, 300 W, 350 W, 400 W, 500 W, 750 W, 800 W, 900 W, 1000 W, 1500 W, 2000 W, 3000 W, or 4000 W. The energy source may have a power between any of the afore-mentioned energy beam power values (e.g., from about from about 150 W to about 1000 W, or from about 1000 W to about 4000 W). The energy beam may derive from an electron gun.

In some embodiments, an energy beam is utilized for the 3D printing. The methods, apparatuses and/or systems disclosed herein may comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

In some embodiments, the energy source(s) projects energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some embodiments, a scanning speed of an energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the scanning energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the scanning energy beam may be any value between the aforementioned values (e.g., from about 50 mm/sec to about 50000 mm/sec, from about 50 mm/sec to about 3000 mm/sec, or from about 2000 mm/sec to about 50000 mm/sec). The scanning energy beam may be continuous or non-continuous (e.g., pulsing).

In some embodiments, a positioning accuracy of the optical assembly comprising a scanner is performed. A calibration may include a comparison of a commanded (e.g., instructed) energy beam position (e.g., at the target surface) compared with an actual (e.g., measured) energy beam position at the target surface. A variation of the measured energy beam position from the commanded energy beam position (e.g., at the target surface) may be termed a “distortion.” A calibrated energy beam position (e.g., at a target surface) may include a measured position that may be at most about 350 microns (μm), 250 μm, 150 μm, 100 μm, 50 μm, 40 μm, 30 μm, 20 μm, 10 μm, 5 μm, or 2 μm from a commanded position of the energy beam. The measured position of the energy beam may be at least about 2 μm, 5 μm, 10 μm, 20 μm, 30 μm, 40 μm, 50 μm, 150 μm, 250 μm or 350 μm from a commanded position of the energy beam. The measured position may be any value between the aforementioned values (e.g., from about 2 μm to about 350 μm, from about 150 μm to about 350 μm, or from about 2 μm to about 150 μm). A calibrated energy beam position may include a measured angular position of a guidance system element (e.g., a mirror). The positioning accuracy of the optical assembly may be a positional accuracy of an optical element, e.g., a mirror of a scanner. The measured angular position may deviate from a requested angular position by (e.g., comprise an error of) at most about 40 micro-radians (μRads), 30 μRads, 20 μRads, 15 μRads, or 10 μRads from a commanded angular position of the optical element. A deviation of the measured angular position from a requested angular position may be any value between the afore-mentioned values (e.g., from about 10 μRads to about 50 μRads, from about 30 μRads to about 50 μRads, or from about 10 μRads to about 30 μRads). These angular position accuracies may correspond to position accuracies at the target surface (e.g., an X-Y position accuracy at a build plane) from about 2 μm to about 350 μm, from about 150 μm to about 350 μm, or from about 2 μm to about 150 μm.

In some embodiments, the energy beam(s), energy source(s), and/or the platform of the energy beam array is moved. The energy beam(s), energy source(s), and/or the platform of the energy beam(s) can be moved via an optical system comprising a galvanometer scanner (e.g., moving the energy beam(s)), a polygon, a mechanical stage (e.g., X-Y stage), a piezoelectric device, gimble, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

In some embodiments, the energy beam (e.g., laser beam) is impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printer comprises at least one controller, e.g., as part of a control system (such as any control system disclosed herein). The controller(s) may control one or more characteristics of the energy beam (e.g., variable characteristics). The control of the energy beam may allow a lower degree of material evaporation during the 3D printing process that would have otherwise transpire. The material evaporation may form debris (e.g., gas borne debris).

In some cases, the 3D printing system can comprise two, three, four, five, eight, ten, sixteen, eighteen, twenty, or more energy sources that each generates an energy beam (e.g., laser beam). An energy source can be a source configured to deliver energy to an area (e.g., a confined area). An energy source can deliver energy to the confined area through radiative heat transfer.

In some embodiments, the energy source supplies any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

In some embodiments, the energy beam is moveable with respect to a material bed and/or 3D printing system. The energy beam can be moveable such that it can translate relative to the material bed. The energy beam can be moved by an optical system (e.g., comprising a scanner). The movement of the energy beam can comprise utilization of a scanner. In some embodiments, the energy source is stationary.

In some embodiments, the formation of the 3D object includes transforming (e.g., fusing, binding and/or connecting) the pre-transformed material (e.g., 3D printing starting material such as a powder material) using an energy beam. The energy beam may be projected on to the starting material (e.g., disposed in the material bed), thus causing the pre-transformed material to transform (e.g., fuse). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the transforming energy is provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited pre-transformed material (e.g., in the material bed). The warming energy may be able to raise the temperature of the deposited pre-transformed material. The energy beam may comprise energy provided at a (e.g., substantially) constant or varied energy beam characteristics. The energy beam may comprise energy provided at (e.g., substantially) constant or varied energy beam characteristics, depending on the position of the generated hardened material within the 3D object. The varied energy beam characteristics may comprise energy flux, rate, intensity, wavelength, amplitude, power, cross-section, or time exerted for the energy process (e.g., transforming or heating). The energy beam footprint may be the average (or mean) FLS of the footprint of the energy beam on the exposed surface of the material bed. The FLS may be a diameter, a spherical equivalent diameter, a length, a height, a width, or diameter of a bounding circle. The FLS may be the larger of a length, a height, and a width of a 3D form.

In some embodiments, the term “auxiliary support,” as used herein, generally refers to at least one feature that is a part of a printed 3D object, but not part of the desired, intended, designed, ordered, and/or final 3D object. Auxiliary support may provide structural support during and/or after the formation of the 3D object. The auxiliary support may be anchored to the enclosure. For example, an auxiliary support may be anchored to the platform (e.g., building platform such as a build plate), to the side walls of the material bed, to a wall of the enclosure, to an object (e.g., stationary or semi-stationary) within the enclosure, or any combination thereof. The auxiliary support may be the platform (e.g., the base, or the substrate) or the bottom of the enclosure. The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object(s) can be printed without auxiliary support in a material bed in which it/they are formed. In some examples, low hanging overhanging feature an/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees (°), 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. The generated 3D object may be suspended in the layer of pre-transformed material (e.g., powder material). The pre-transformed material can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the platform. The auxiliary support may be suspended in the material bed and not touch (e.g., contact) the platform. The auxiliary support may be anchored to the platform.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The average temperature of the material bed can be below a melting point of the material constituting the material bed. The average temperature of the material bed can be above an ambient temperature external to the enclosure in which the material bed is disposed. The average temperature of the material bed (e.g., pre-transformed material therein) may refer to the average temperature during the 3D printing. The pre-transformed material can be the material within the material bed that has not been transformed and generated at least a portion of the 3D object (e.g., the remainder). The temperature of the material bed can be conditioned (e.g., heated or cooled) before, during, or after forming (e.g., printing) the 3D object (e.g., hardened material). Bulk heaters can heat and/or cool the material bed. The bulk temperature conditioners can be situated adjacent to (e.g., above, below, or to the side of) the material bed, or within a material dispensing system. For example, the material can be heated using radiators (e.g., quartz radiators, or infrared emitters). The material bed temperature can be controller (e.g., substantially maintained) at a predetermined value. The temperature of the material bed can be monitored. The material temperature can be controlled manually and/or by a control system (e.g., such as any control system disclosed herein).

In some embodiments, the 3D printing system comprises one or more sensors. The 3D printing system includes at least one container. In some embodiments, the container comprises one or more sensors (alternatively referred to herein as one or more sensors). The container described herein may comprise at least one sensor. The container may comprise the build module container, the filtering container, the processing chamber, or the enclosure. The sensor may be connected and/or controlled by the control system (e.g., computer control system, or controller(s)). The control system may be able to receive signals from the at least one sensor. The control system may act upon at least one signal received from the at least one sensor. The control may rely on feedback and/or feed forward control scheme that has been pre-programmed. The feedback and/or feed forward mechanisms may rely on input from at least one sensor that is connected to the controller(s).

In some embodiments, the 3D printing system comprises one or more sensors. The one or more sensors can include a pressure sensor, a temperature sensor, a gas flow sensor, or an optical density sensor. The pressure sensor may measure the pressure of the chamber (e.g., pressure of the chamber atmosphere). The pressure sensor can be coupled with (e.g., to) the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The optical sensor may comprise a camera (e.g., IR camera, or CCD camera (e.g., single line CCD camera)). or CCD camera (e.g., single line CCD camera). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure can be monitored by at least one weight sensor in or adjacent to the material. For example, a weight sensor can be situated at the bottom of the enclosure. The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise a button load cell. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 1, 119 shows an example of an upper surface of the material bed 104.

In some embodiments, the 3D printer comprises one or more valves. The methods, systems and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves. The valve may or may not comprise a sensor sensing the open/shut position of the valve. The valve may be a component of a gas flow mechanism, e.g., operable to control a flow of gas of the gas flow mechanism. A valve may be a component of gas flow assembly, e.g., operable to control a flow of gas of the gas flow assembly.

In some embodiments, the 3D printer comprises one or more actuators such as motors. The motor may be controlled by the controller(s) (e.g., by the control system) and/or manually. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The motor may alter (e.g., a position of) a scanner, e.g., a galvanometric scanner.

In some embodiments, the 3D printer comprises one or more nozzles. The systems and/or the apparatus described herein may comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises a communication technology. The systems, apparatuses, and/or parts thereof may comprise Bluetooth technology. systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of materials, 3D printers and associated methods, software, systems, device and apparatus such as the controller (e.g., a controller used in 3D printing) can be found in in International Patent Application Serial No. PCT/US17/18191, filed Feb. 16, 2017, which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more energy sources, optical systems, gas flow system, material flow systems, energy (e.g., energy beams) and/or with any other component of the 3D printing system. At least two of the energy sources may be of the same type or of different types. For example, at least two of the energy sources can be both fiber lasers. For example, the control system may be in communication with the first energy source and/or with the second energy source. The control system may regulate the one or more energy beams. The control system may regulate the energy supplied by the one or more energy sources. For example, the control system may regulate the energy supplied by a first energy beam and by a second energy beam, to the pre-transformed material within the material bed. The control system may regulate the position of the one or more energy beams. For example, the control system may regulate the position of the first energy beam and/or the position of the second energy beam.

In some embodiments, a plurality of energy beams is used to transform the pre-transformed material to print one or more 3D objects. At least a portion of the energy beams may be staggered, e.g., in a direction. The direction of may be along the direction of the gas flow, or at an angle relative to the direction of flow. The angle may be perpendicular, or an angle different than perpendicular. The plurality of energy beam may comprise at least 2, 3, 4, 5, 6, 7, 8, 9, 10, 12, 16, 24, or 32 energy beams. The plurality of energy beams may form an array. At least two energy beams of the plurality of energy beams may be controlled independently of each other. At least two energy beams of the plurality of energy beams may be controlled in concert. At least two energy beams of the plurality of energy beams may translate independently of each other. At least two energy beams of the plurality of energy beams may translate in concert. At least two energy beams of the plurality of energy beams may be controlled by the same controller. At least two energy beams of the plurality of energy beams may be controlled by different controllers.

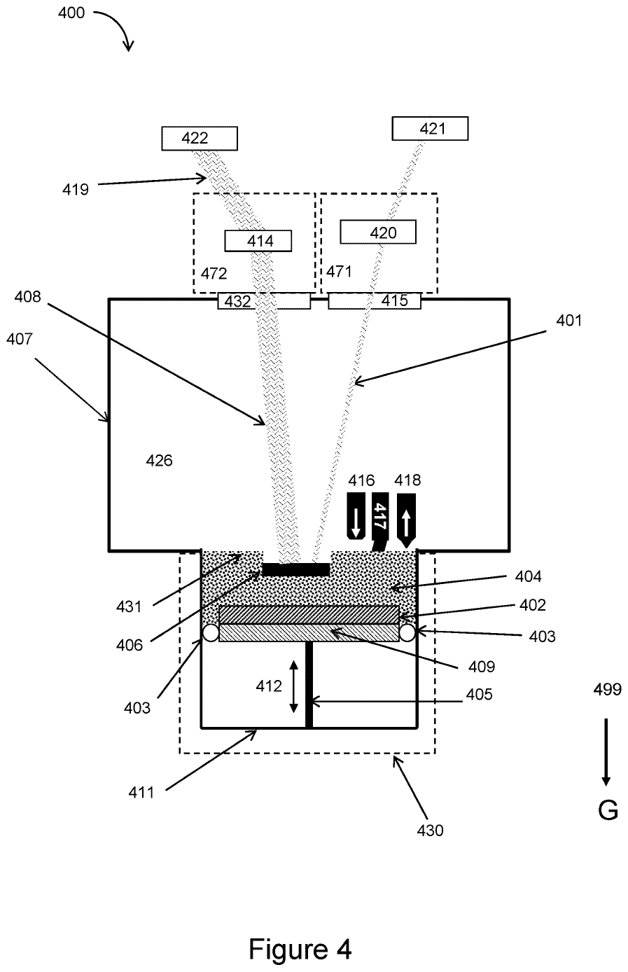

FIG. 4 shows an example of a 3D printing system 400 and apparatuses, a first energy source 422 that emits a first energy beam 419 providing an energy flux. In the example of FIG. 4 the energy beam 419 travels through an optical system 414 (e.g., comprising an aperture, lens, mirror, or deflector) and an optical window 432, to emerge as energy beam 408 that impinges upon a target surface 431. Optical system 420 is disposed in optical enclosure 471 contacting optical window 415, and optical system 414 is disposed in optical enclosure 472 contacting optical window 432. In other embodiments, optical enclosure 471 and optical enclosure 472 merge to form one optical enclosure contacting both windows 414 and 432. The target surface may be a portion of a hardened material (e.g., 406) that was formed by transforming at least a portion of a target surface (e.g., 431) of the material bed 404. In the example of FIG. 4 a second energy 401 is generated by a second energy source 421. The generated energy beam 401 travels through an optical mechanism 420 and an optical window 415. In other embodiments, the first energy beam and the second energy beam may travel through the same optical window and/or through the same optical system. At times, the first energy beam and the second energy beam may travel each (a) through its respective optical system and (b) through its respective optical window. FIG. 4 shows the material bed 404 disposed on base (e.g., building platform) 402 supported by substrate (e.g., piston) 409 coupled with shaft 405 that can translate vertically along double arrow 412. Seal 403 (e.g., O-ring) encircles piston 403, e.g., to reduce a chance of entry of the material from material bed 402 to the elevator mechanism (e.g., shaft 405). The material bed, building platform, piston, seal, and shaft are disposed in build module 430 that is coupled to processing chamber 407 having interior space 426. FIG. 4 is shown with respect to gravitational vector 499 pointing towards the gravitational center of the ambient environment.

In some embodiments, the build module and the processing chamber are reversibly configured to separate from each other and integrate with each other. Each of the build module and processing chamber may comprise separate atmospheres, e.g., before and/or after the printing. The separate build module and processing chamber may (e.g., controllably) merge, couple, or integrate. For example, the atmospheres of the build module and processing chamber may merge. In the example of FIG. 4, the 3D printing system comprises a processing chamber which comprises the energy beam and the target surface (e.g., comprising the atmosphere in the interior volume of the processing chamber, e.g., 426). For example, the processing chamber may comprise a first energy beam (e.g., FIG. 4, 401) and/or a second energy beam (e.g., FIG. 4, 408). The enclosure may comprise one or more build modules (e.g., enclosed in the dashed area 430). At times, at least one build module may be situated in the enclosure comprising the processing chamber. At times, at least one build module may engage with the processing chamber (e.g., FIG. 4) (e.g., 407). At times, a plurality of build modules may be coupled with (e.g., to) the enclosure. The build module may reversibly engage with (e.g., couple to) the processing chamber. The engagement of the build module may be before or after the 3D printing. The engagement of the build module with the processing chamber may be controlled (e.g., by a controller, such as for example by a microcontroller). Examples of materials, 3D printers and associated methods, software, systems, device and apparatuses such as a controller found in PCT/US17/18191; US Patent Application Ser. No. U.S. Ser. No. 15/435,065, filed on February 46; and in European Patent Application Serial No. EP17156707, filed on Feb. 47, 2017; each of which is incorporated herein by reference in its entirety. The controller may direct the engagement and/or dis-engagement of the build module. The control may be automatic and/or manual. The engagement of the build module with the processing chamber may be reversible. In some embodiments, the engagement of the build module with the processing chamber may be non-reversible (e.g., stable).

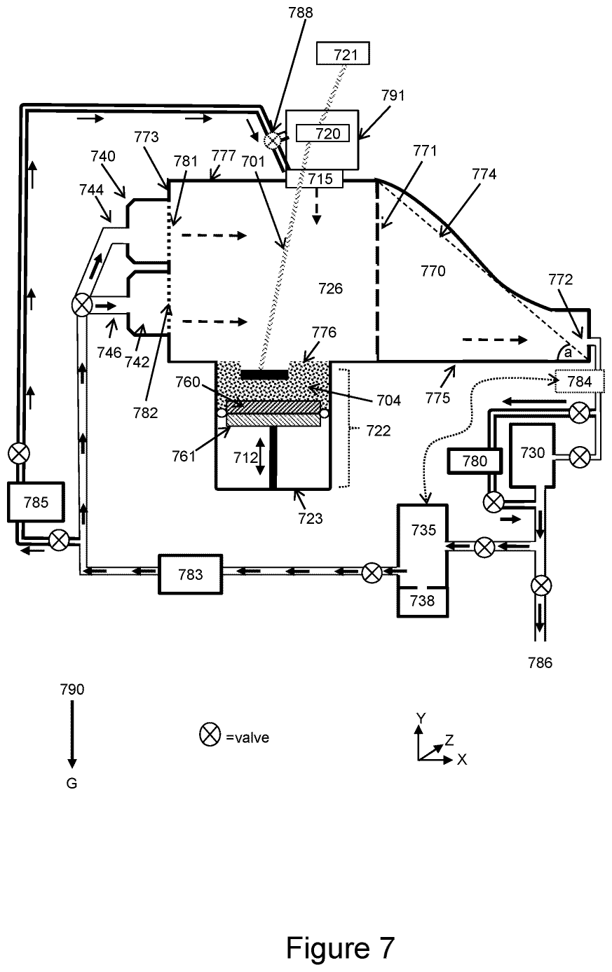

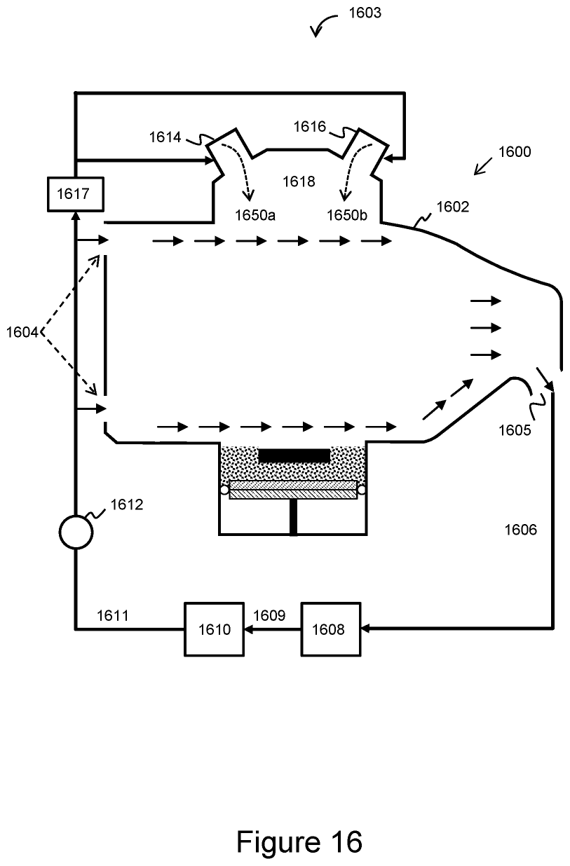

In some embodiments, a gas flow mechanism comprises structures that at least partially dictate the flowing of gas across an (e.g., entire) enclosure and/or a portion of an enclosure. The gas flow mechanism can be used to at least partially control a characteristic of gas flow adjacent to (e.g., over) the target surface, the platform, and/or a mechanical component, e.g., an optical component such as a lens. Target surface may refer to a surface that is a radiation target for the energy beam. The gas flow mechanism can include a gas inlet portion that at least partially controls the flow of gas entering the enclosure and/or directed towards the component. The gas flow mechanism can include a gas outlet portion that at least partially controls the flow of gas exiting the enclosure. The gas flow mechanism can be used to at least partially control a characteristic of gas flow adjacent to or within a recessed portion of the enclosure (e.g., to purge the recessed portion). The gas flow mechanism can include the gas inlet portion, the gas outlet portion, features for purging a recessed portion of the enclosure, or any suitable combination thereof. The recessed portion may be at the ceiling of the enclosure. The recessed portion (e.g., FIG. 16, 1618) may be disposed at a wall of the enclosure opposing to the target surface. The gas may comprise an inert gas (e.g., nitrogen and/or argon). The gas may flow in bulk. The gas may flow in one or more streams. The gas may comprise a non-reacting (e.g., inert) gas. The gas may comprise a reactive agent depleted gas, e.g., a water depleted gas and/or an oxygen depleted gas. The flow of the gas may comprise flowing across at least a portion of the height (e.g., Y axis. See FIG. 7) of the enclosure. For example, the flow of the gas may comprise flowing across the entire height of the enclosure. The flow of the gas may comprise flowing across at least a portion of the depth (e.g., Z axis. See FIG. 7) of the enclosure. For example, the flow of the gas may comprise flowing across the entire depth of the enclosure. The flow of the gas may comprise flowing across at least a portion of the width (e.g., X axis. See FIG. 7) of the enclosure (e.g., also referred herein as the length of the enclosure). For example, the flow of the gas may comprise flowing across the entire width of the enclosure. The flow of gas may comprise flowing onto an internal surface of the optical window (e.g., facing the exposed surface of the material bed). The area adjacent to the optical window may comprise one or more slots (e.g., a slot per optical window, or a single slot for all optical windows, or dispersed multiple slots across one or more optical windows), one or more channels, or a combination thereof. The flow of gas may comprise flowing through the one or more slots, channels, or a combination thereof, on to the internal surface of the optical window. The slot and/or channel may facilitate directing the flow of gas onto the internal surface of the optical window. For example, the gas flow may be optionally evacuated from an area adjacent (e.g., directly adjacent) to the one or more optical windows. The flow of gas may be (e.g., substantially) lateral. The flow of gas may be (e.g., substantially) horizontal. The gas may flow along, away and/or towards the one or more optical windows. The gas may flow in a plurality of gas streams. The gas streams may be spread across at least a portion of the (e.g., entire) height and/or depth of the enclosure. The gas streams may be evenly spread. The gas streams may not be evenly spread (e.g., across at least a portion of the enclosure height and/or depth). The gas streams may flow across at least a portion of the enclosure height and/or depth Across the enclosure, the gas streams may flow in the same direction. The same direction may comprise from the gas-inlet to the gas-outlet. The same direction may comprise from one edge of the enclosure to the opposite end). The same direction may comprise from the gas-inlet to the gas-outlet. The gas flow may flow laterally across at least a portion of the (e.g., height and/or depth of the) enclosure. The gas flow may flow laminarly across at least a portion of the (e.g., height and/or depth of the) enclosure. The at least a portion of the enclosure may comprise the processing cone. In one embodiment, the gas streams may not flow in the same direction. In one embodiment, one or more gas streams may flow in the same direction and one or more gas streams may flow in the opposite direction. The gas flow (e.g., in the at least one stream) may comprise a laminar flow. The gas flow may comprise flow in a constant velocity during at least a portion of the 3D printing. For example, the gas flow may comprise flow in a constant velocity during the operation of the energy beam (e.g., during the transformation of at least a portion of the material bed). Laminar flow may comprise fluid flow (e.g., gas flow) in (e.g., substantially) parallel layers. The gas flow may comprise flow in a varied velocity during at least a portion of the 3D printing. For example, the gas flow may comprise flow in a varied velocity during the operation of the energy beam (e.g., during the transformation of at least a portion of the material bed). The gas streams may comprise a turbulent flow.

In some embodiments, a layer dispensing mechanism is reversibly parked in an isolatable ancillary chamber when it does not perform a layer dispensing operation. The energy beam may be projected on (e.g., impinge on) the material bed when the layer dispensing mechanism resides within the ancillary chamber (e.g., isolated from the processing chamber), and the gas flow may continue during operation of energy beam (e.g., lasing). The gas stream(s) may be altered (e.g., reduced, or cease to flow) when the layer dispensing mechanism performs an operation of dispensing of a layer of material (e.g., and exits the ancillary chamber). The gas stream(s) may continue to flow when the layer dispensing mechanism performs an operation of dispensing of a layer of material.

In some embodiments, a 3D printing system comprises a processing chamber, build module, gas flow system, recycling system (e.g., for gas and/or pre-transformed material), optical system, layer dispensing mechanism, garage, control system, and/or structural supports. In some embodiments, an enclosure comprises a processing chamber. The processing chamber may be in fluidic contact with a gas flow mechanism. The gas flow mechanism can comprise structures that at least partially dictate the flowing of gas across (e.g., through, within, or the like) the (e.g., entire) processing chamber and/or a portion of the processing chamber.

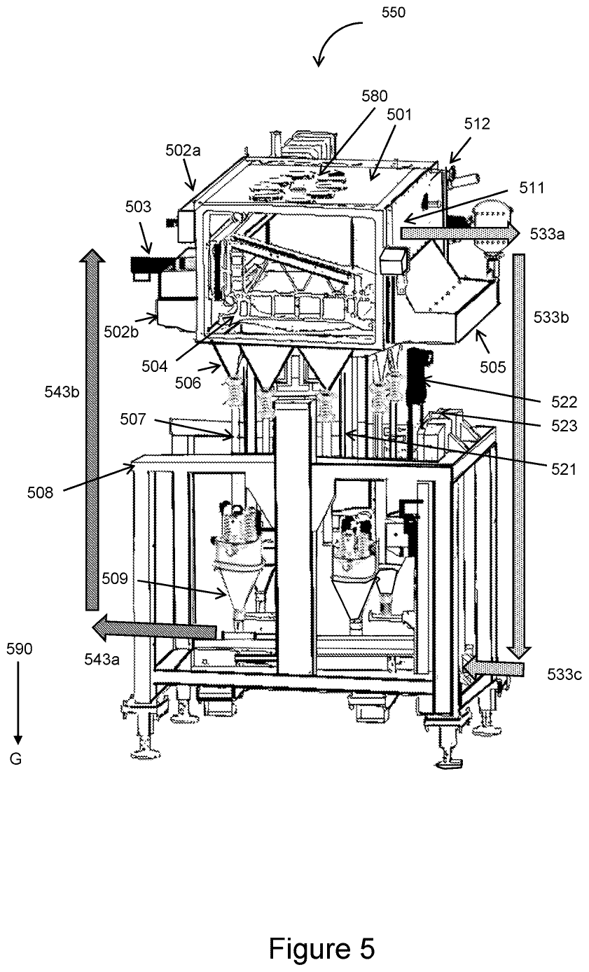

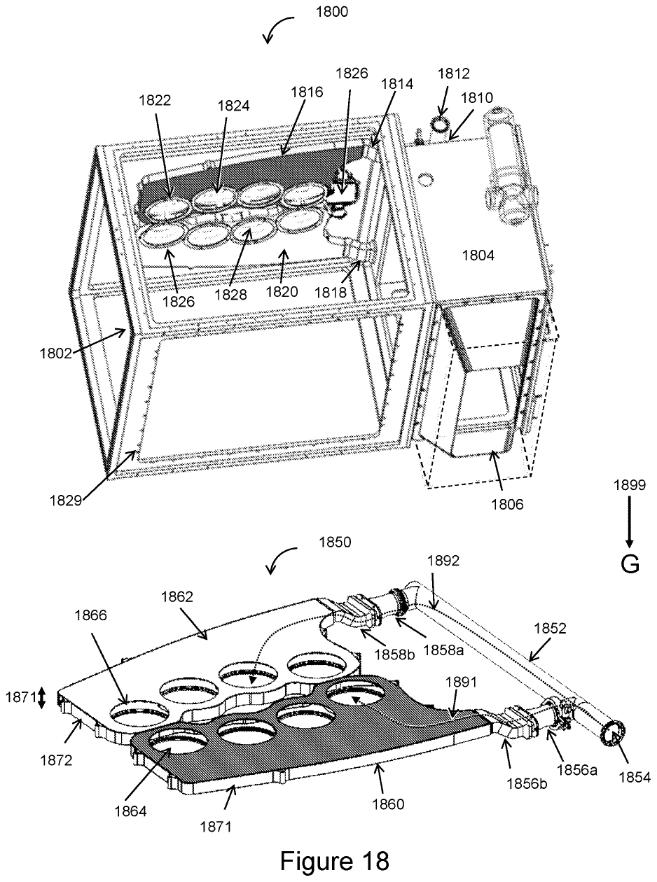

FIG. 5 shows a perspective view example of a portion of a 3D printing system including a processing chamber having a ceiling 501 in which optical windows 580 are disposed to each facilitate penetration of an energy beam into the processing chamber interior space, side wall 511 having a gas exit port (e.g., gas outlet port) covering 505 coupled thereto. A similar arrangement of optical windows 580 is shown in FIG. 18. The processing chamber has two gas entrance port coverings 502a and 502b coupled with (e.g., to) an opposing wall to side wall 511. The opposing wall is coupled with (e.g., to) an actuator 503 configured to facilitate translation of a layer dispensing mechanism (e.g., recoater) mounted on a framing 504 above a base disposed adjacent to a floor of the processing chamber, which framing is configured to facilitate (e.g., enable) reversible translation of the layer dispensing mechanism (back and forth) in the processing chamber along railings. The processing chamber floor has slots through which remainder material can flow downwards towards gravitational center G along gravitational vector 590. The slots are coupled with (e.g., to) funnels such as 506 that are connected by channels (e.g., pipes) such as 507 to material reservoir such as 509 (e.g., to facilitate unpacking of a remainder of a material bed after printing). The processing chamber is coupled with (e.g., to) a build module 521 that comprises a substrate to which the base is attached, which substrate is configured to vertically translate with the aid of actuator 522 coupled with (e.g., to) an elevator motion stage (e.g., supporting plate) 523 via a bent arm. The elevator motion stage and coupled components are supported by framing 508 that is missing a beam that is removed in FIG. 5 (e.g., the beam can be removed for installation and/or maintenance). Atmosphere (e.g., content, temperature, and/or pressure) may be equilibrated between the material reservoirs and the processing chamber via schematic channel (e.g., pipe) portions 533a-c. Remainder material in the material reservoirs may be conveyed via schematic channels (e.g., pipes) 543a-b to a material recycling system, e.g., for future use in printing. The components of the 3D printing system are disposed relative to gravitational vector 590 pointing to gravitational center G.

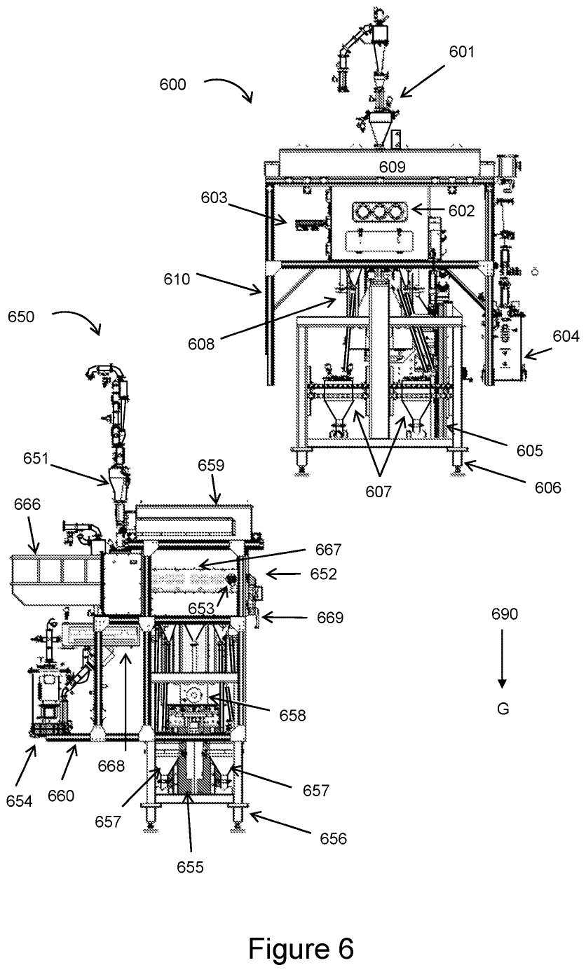

FIG. 6 shows in example 600 a front side example of a portion of a 3D printing system comprising a material reservoir 601 configured to feed pre-transformed material to a layer dispensing mechanism, an enclosure 609 configured to enclosure, e.g., scanner(s) and/or director(s) (e.g., optical system) of at least one energy beam (e.g., laser beam) configured to transform the pre-transformed material into a transformed material to print one or more 3D object in a printing cycle. Example 600 of FIG. 6 shows a build module 602 having a door with three circular windows. The windows may be any window disclosed herein. The window may be a single or a double pane window. The window may be an insulated glass unit (IGU), the window may be configured to withstand positive pressure within the processing chamber, e.g., during printing. The positive pressure is above ambient pressure external to the build module, e.g., the ambient pressure may be about one atmosphere. Example 600 show a material reservoir 604 configured to accumulate recycled remainder starting material (e.g., pre-transformed material) from the layer dispensing process to form a material bed and/or a remainder of the material bed that did not form one or more 3D objects during a printing cycle, post 605 as part of an elevator mechanism of build module 608; two material reservoirs 607 for accumulating a remainder of the material bed that did not form the 3D object, and actuator 603 configured to translate the layer dispensing mechanism to dispense a layer of pre-transformed material as part of a material bed. Supports 606 are planarly stationed in a first horizontal plane, which supports 606 and associated framing support one section of the 3D printing system portion 600, and framing 610 is disposed on a second horizontal plane higher than the first horizontal plane. FIG. 6 shows in 650 an example side view example of a portion of the 3D printing system shown in example 600, which side view comprises a material reservoir 651 configured to feed pre-transformed material to a layer dispensing mechanism, an enclosure 659 enclosing, e.g., scanners and/or directors (e.g., optical system) of at least one energy beam (e.g., laser beam) configured to transform the pre-transformed material into a transformed material to print one or more 3D object in a printing cycle. Example 650 of FIG. 6 shows an example of a build module 652 having a door comprising handle 669 (as part of a handle assembly). Example 600 show a material reservoir 654 configured to accumulate recycled remainder from the layer dispensing process to form a material bed and/or a remainder of the material bed that did not form one or more 3D objects during a printing cycle, a portion of the material conveyance system 668 configured to convey the material to reservoir 654. The material conveyed to reservoir 654 may be separated (e.g., sieved) before reaching reservoir 654. The example shown in 650 shows post 655 as part of an elevator mechanism of build module 658; two material reservoirs 657 for accumulating a remainder of the material bed that did not form the 3D object, and actuator 653 configured to translate the layer dispensing mechanism to dispense a layer of pre-transformed material as part of a material bed, e.g., along railing 667 in processing chamber and into garage 666 in a reversible (e.g., back and forth) movement. Supports 656 are planarly stationed in a first horizontal plane, which supports 606 and associated framing support one section of the 3D printing system portion 650, and framing 660 is disposed on a second horizontal plane higher than the first horizontal plane. In the example shown in FIG. 6, the 3D printing system components may be aligned with respect to gravitational vector 690 pointing towards gravitational center G.

In some embodiments, material utilized in the 3D printing undergoes passivation, e.g., using a passivation system. A passivation system may comprise (A) an in-situ passivation system (e.g., to passivate filtered debris and/or any other gas borne material before their disposal), (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, the gas in the gas conveyance system and/or enclosure comprises a robust gas. The robust gas may comprise an inert gas enriched with reactive agent(s). At least one reactive agent in the robust gas may be in a concentration below that present in the ambient atmosphere external to the gas conveyance system and/or enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or pre-transformed material, e.g., during and/or after the printing. In some embodiments, humidity levels and/or oxygen levels in at least a portion of the enclosure (e.g., processing chamber, ancillary chamber, and/or build module) can be regulated such that an oxygenation and/or humidification of powder in the powder conveyance system is controlled. Oxygenation and/or humidification levels of recycled pre-transformed material (e.g., recycled powder material) can be about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). The gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to about −10° C. or from about −30° C. to about −20° C. A dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. A dew point of an internal atmosphere of the enclosure can be any value within or including the afore-mentioned values. Examples of gas conveyance system and components (including control components), in-situ passivation systems, controlled oxidation methods and systems, 3D printing systems, control systems, software, and related processes, can be found in PCT/US17/60035 and PCT/US21/35350, each of which is incorporated herein by reference in its entirety.

In some embodiments, the gas flow mechanism comprises an inlet portion (e.g., FIG. 7, 740, 742), which can also be referred to as an inlet portion, gas inlet portion, gas inlet port, gas inlet portion, or other suitable term. The inlet portion may be connected to a side wall of the enclosure (e.g., FIG. 7, 773). The inlet portion may comprise one or more inlets. The side wall may be an internal side wall. The side wall may be a divider forming a processing chamber side wall. The inlet portion may include one or more openings to facilitate gas flow into the enclosure (e.g., into the inlet portion). In some embodiments, the inlet portion may be separated from the processing chamber by an internal inlet (e.g., separation) wall. In some embodiments, the inlet portion is separated from the processing chamber by a filter. The filter may be one of the filters disclosed herein. In some embodiments, the outlet portion may be separated from the processing chamber by an internal outlet (e.g., separation) wall. The internal outlet wall and/or internal inlet wall may comprise an opening. The term “opening” may refer to the internal inlet wall opening, internal outlet wall opening, inlet opening, and/or outlet opening.

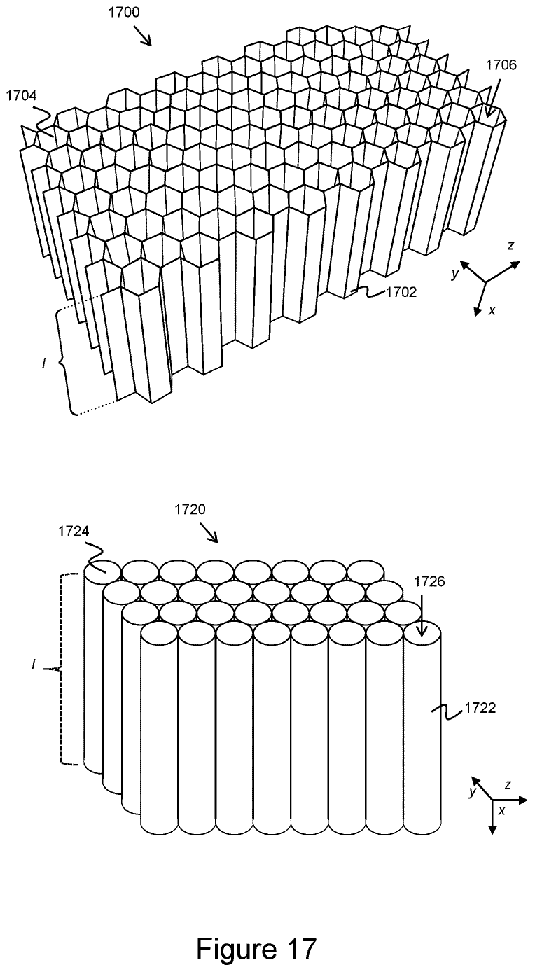

FIG. 7 shows an example of a 3D printing system having an energy beam source 721 generating an energy beam 701 that traverses an optical system 720 (e.g., comprising a scanner) that translates the energy beam along a path, which energy beam travels through an optical window 715 into processing chamber enclosing space 726 having an atmosphere. The optical system is disposed in optical enclosure 791. In some embodiments, the 3D printer comprises more than one: (i) optical window, (ii) energy source, and/or, (iii) optical system (e.g., scanner). Energy beam 701 impinges upon an exposed surface 776 of material bed 704 to generate at least a portion of a 3D object. Material bed 704 is disposed above a base (e.g., build plate or build platform) 760 disposed above a substrate (e.g., piston) 761 that can traverse vertically 712, e.g., using an elevator mechanism. Material bed 704 is disposed in a build module 722 having floor 723, enclosing at least a portion of the elevator mechanism, e.g., the elevator shaft. The processing chamber comprises gas inlets 744 and 746 and gas outlet 772. Gas inlet 744 diverts (e.g., and expands) into gas inlet portion 740. Gas inlet 746 is diverted (e.g., and expands) into gas inlet portion 742. The processing chamber has an outlet portion 770 coupled with (e.g., to) outlet port 772, which outlet portion tapers towards the outlet port in tapering angle 774 alpha (x). While FIG. 7 shows a non-linear tapering, other embodiments can have a linear tapering (e.g., along angle 774). The outlet portion 770 may or may not include optional perforated outlet screen 771. Any of the inlet portions may or may not comprise a perforated inlet screen, e.g., such as in FIG. 17. Optional perforated inlet screens are depicted (i) in 781 coupled with (e.g., to) gas inlet portion 740, and (ii) in and 782 coupled with (e.g., to) gas inlet portion 742. The processing chamber is connected to pump 730 and to filtering mechanism 735 having a distal (e.g., residual) container 738 into which gas borne debris can be collected. In some embodiments, the filtering mechanism 735 (e.g., with its distal container) can be disposed in optional alternate location 784. The gas conveyance system comprises an enriching system 780. The enriching system may enrich the gas (e.g., gas mixture) flowing in the gas conveyance system by one or more reactive agents (e.g., water and/or oxygen). In some embodiments, the enriching system is configured to enrich the gas with humidity, e.g., controlled level of humidity. The gas flowing in the gas conveyance system may be a robust gas, e.g., that is more interest that the gas in the ambient atmosphere external to the 3D printer. The robust gas can comprise an inert gas (e.g., Argon) at levels above those present in the ambient environment. The gas conveyance system can convey gas (e.g., over-pressured gas above a threshold and above ambient pressure) to an exhaust location 786, e.g., that can comprise the ambient environment. The gas conveyance system comprises temperature conditioning system 783, e.g., a cooler. The gas conveyance system depicted in FIG. 7 comprises a gas line to the optical window 715 and/or optical system 720, the gas line comprising filter 785, e.g., comprising a filter configured to facilitate streaming gas with a higher degree of purity, such as a HEPA filter. In some embodiments, the optical window is part of the optical system. In some embodiments, the optical system and the optical window are disposed in an optical enclosure, e.g., the optical window is disposed at a floor of the optical enclosure. In the example shown in FIG. 7, the optical window and the optical system receive gas streams from different lines split at junction 788. Junction 788 may comprise an optional valve. In FIG. 7, the processing chamber and the build module are depicted with respect to gravitational vector 790 pointing towards the gravitational center of the ambient environment external to the 3D printer. The gas conveyance system portion extending externally to the processing chamber from outlet 772 to optional perforated screens 781 and 782 and to junction 788, is not entirely depicted with relation vector 790, and is rather depicted schematically.

In some embodiments, the processing chamber (e.g., FIG. 7, enclosing space 726) comprises one or more side walls (e.g., 773), a floor (e.g., 775), and a ceiling (e.g., 777). The processing chamber may comprise at least one gas conveying inlet (e.g., FIG. 7, 744, 746) coupled with (e.g., to) a first of the processing chamber side walls. The processing chamber may comprise at least one gas conveying outlet (e.g., FIG. 7, 772) coupled with (e.g., to) a side wall of the chamber. The side wall that is connected to the inlet may not be connected to the outlet. The side wall connected to the inlet may be different from the side wall connected to the outlet. For example, the inlet may be coupled with (e.g., to) the first of the processing chamber side walls, and the outlet may be coupled with (e.g., to) the second of the processing chamber side walls. The first side wall may be different from the second side wall. For example, the first side wall may oppose the second side wall. The outlet opening may be (e.g., fluidly) connected to a gas recycling system. In some embodiments, the outlet opening (or a supplemental outlet opening) may be adjacent to an optical window. The outlet opening may be (e.g., fluidly) connected to a pump. Fluid connection may allow a gas to flow through. The gas may flow through the opening due to a pressure difference between the two ends of the outlet opening. The gas may be sucked through the outlet opening. The gas may be pressurized through the outlet opening. The pressure at the end of the opening away from the processing pressure may be lower than the pressure at the side of the outlet opening closer to the processing chamber.

% %

FIG. 7 shows an example of a 3D printing system having an energy beam source 721 generating an energy beam 701 that is traverses an optical system 720 (e.g., comprising a scanner) that translates the energy beam along a path, which energy beam travels through an optical window 715 into processing chamber enclosing space 726 having an atmosphere. Energy beam 701 impinges upon an exposed surface 776 of material bed 704 to generate at least a portion of a 3D object. Material bed 704 is disposed above a base (build plate) 760 disposed above a substrate (e.g., piston) 761 that can traverse horizontally 712 using an elevator mechanism. The processing chamber comprises gas conveying inlets 744 and 746 and gas conveying outlet 772. The gas conveying inlet 744 expands into gas inlet portion 740. The gas conveying inlet 746 expands into gas inlet portion 742. The processing chamber has an outlet portion 770 coupled with (e.g., to) gas conveying outlet 772, which outlet portion tapers towards the outlet portion in tapering angle 774 alpha. While FIG. 7 shows a non-linear tapering, other embodiments can have a linear tapering (e.g., along angle 774). The outlet portion 770 may or may not include a perforated outlet screen 771. The inlet portion may or may not comprise a perforated inlet screen. The processing chamber is connected to pump 730 and to filtering mechanism 735 having a residual container 738 into which gas borne debris can be collected.

In some embodiments, the processing chamber (e.g., FIG. 7, enclosing space 726) comprises one or more side walls (e.g., side walls 773). The processing chamber may comprise at least one gas conveying inlet (e.g., FIG. 7, gas conveying inlets 744, 746) coupled with (e.g., to) a first of the processing chamber side walls. The processing chamber may comprise at least one gas conveying outlet (e.g., FIG. 7, gas conveying outlet 772) coupled with (e.g., to) a side wall of the chamber. The side wall that is connected to the inlet may not be connected to the outlet. The side wall connected to the inlet may be different from the side wall connected to the outlet. For example, the inlet may be coupled with (e.g., to) the first of the processing chamber side walls, and the outlet may be coupled with (e.g., to) the second of the processing chamber side walls. The first side wall may be different from the second side wall. For example, the first side wall may oppose the second side wall. The outlet opening may be (e.g., fluidly) connected to a gas recycling system. In some embodiments, the outlet opening (or a supplemental outlet opening) may be adjacent to an optical window. The outlet opening may be (e.g., fluidly) connected to a pump. Fluid connection may allow a gas to flow through. The gas may flow through the opening due to a pressure difference between the two ends of the outlet opening. The gas may be sucked through the outlet opening. The gas may be pressurized through the outlet opening. The pressure at the end of the opening away from the processing pressure may be lower than the pressure at the side of the outlet opening closer to the processing chamber.

In some embodiments, the temperature of the gas that flows to the enclosure (e.g., processing chamber and/or optical chamber) may be temperature controlled. The optical system may be housed and/or enclosed in the optical chamber. For example, the gas may be heated and/or cooled before, or during the time it flows into the processing chamber and/or optical chamber. For example, the gas may flow through a heat conditioner such as a heat exchanger and/or heat sink. The gas may be temperature controlled outside and/or inside the enclosure. The gas may be temperature controlled at least one inlet to the enclosure. In some embodiments, the temperature of the atmosphere in the enclosure may be kept (e.g., substantially) constant. Substantially constant temperature may allow for a temperature fluctuation (e.g., error delta) of at most about 15° C., 12° C., 10° C., 5° C., 4° C., 3° C., 2° C., 1° C., or 0.5° C. In some instances, the gas flow mechanism is coupled with (e.g., to) a recycling mechanism. The recycling system may be configured to recycle the gas flowing into the processing chamber, e.g., before, during and/or after printing. The recycling mechanism may comprise a closed loop system (e.g., having one or more vents). The recycling mechanism may collect the gas from the outlet portion (e.g., 670) and/or from the outlet opening (e.g., 672). The recycling mechanism may filter the gas from debris. The debris may comprise a byproduct of the 3D printing (e.g., soot, splatter, and/or spatter). The debris may comprise gas-borne starting material of the 3D printing. The recycling mechanism may inject the recycled (e.g., cleaned) gas into the enclosure. For example, the recycling mechanism may inject the gas into the inlet opening, and/or the inlet portion. The injection may be direct or indirect. At least a portion of the recycling may be performed before, after, and/or during the 3D printing. At least a portion of the recycling may be continuous (e.g., during at least a portion of the 3D printing). The recycling mechanism may comprise a filtering mechanism. The recycling mechanism may comprise a gas classification system. Examples of gas classification system, gas flow mechanism, 3D printing system and their related devices, apparatuses, software, control systems, and methods of fabrication can be found in PCT/US17/39422, which is incorporated herein by reference in its entirety.

In some embodiments, a filtering mechanism may be operatively coupled with (e.g., to) at least one component of the layer dispensing mechanism, the pump (e.g., pressurizing pump), the gas flow mechanism, the ancillary chamber and/or the enclosure (e.g., processing chamber, and/or optical system enclosure). The filtering mechanism may be operatively coupled with (e.g., to) the gas flow mechanism. For example, the filtering mechanism may be operatively coupled (e.g., physically coupled) to the gas conveying channel of the gas flow mechanism. Physical coupling may comprise flowable coupling to allow at least flow of gas (e.g., and gas borne material). Operatively coupled may include fluid communication (e.g., a fluid connection, and/or a fluid conveying channel). Fluid communication may include a connection that allows a gas, liquid, and/or solid (e.g., particulate material) to flow through the connection. The filtering mechanism may be operatively coupled with (e.g., to) an outlet portion of the processing chamber. A gas comprising gas-borne materials may flow through the filtering mechanism. The gas borne material may be debris including soot, spatter, splatter, reactive species, pre-transformed material and/or any other debris carried by the gas flow. The filtering mechanism may be configured to facilitate separation of the gas-borne materials from gas. The filtering mechanism may comprise (e.g., one or more) filters or pumps. The one or more filters may comprise crude filters or fine filters (e.g., HEPA filters). The one or filters may be disposed before a pump and/or after a pump.

In some embodiments, the 3D printing system comprises gas flow in the processing chamber and/or in the optical chamber. The gas flow can be before, after, and/or during the 3D printing. The gas flow can be controlled manually and/or automatically. The automatic control may comprise using one or more controllers, e.g., as described herein.

FIG. 8 shows an example of an optical system in which an energy source 806 (e.g., a laser source) generates an energy beam 807 that travels between two reflective mirrors 805, through an optical window 804, and emerging as beam 803 that impinges upon an exposed surface 802 of a material bed.

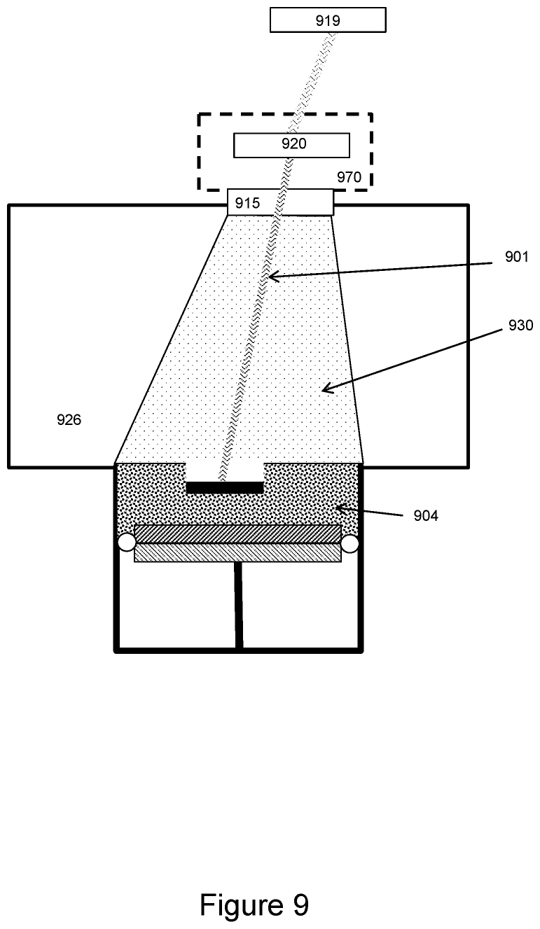

FIG. 9 shows an example of a 3D printing system having an energy source 921 generating an energy beam 901 that travels through an optical system 920 and an optical window 915 into an enclosed space 926 enclosing at atmosphere. Optical system 920 (e.g., comprising a scanner) is disposed in optical enclosure 970 contacting optical window 915. The optical system 920 causes energy beam 901 to traverse along a path with a portion of the processing chamber space that defines a processing cone 930 that takes the form of a truncated cone. Energy beam 901 traverses in the processing cone and impinges upon an exposed surface of material bed 904 to print at least a portion of a 3D object.

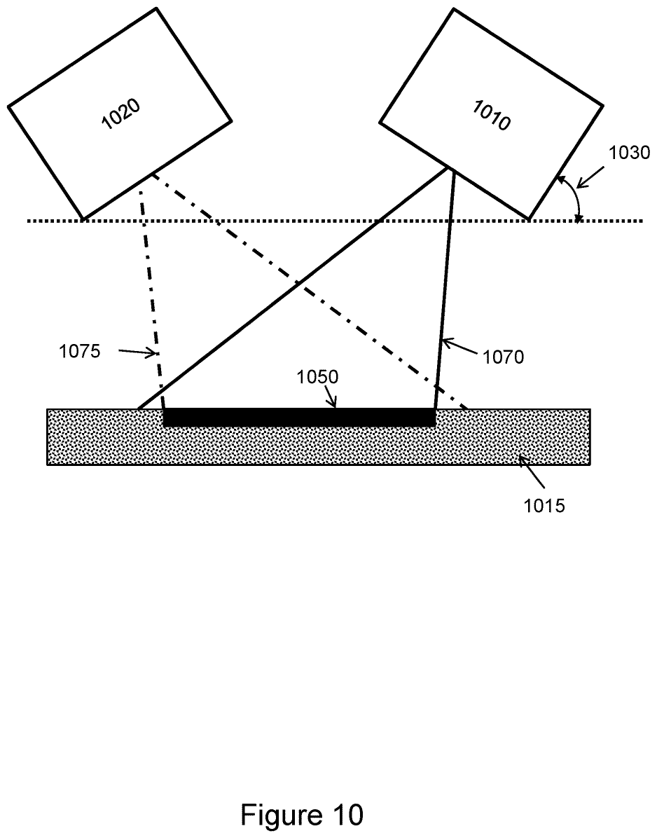

In some embodiments, each scanner of a plurality of scanners directs each energy beam of a plurality of energy beams respectively to the target surface, e.g., to different positions of the target surface. At least two of the energy beams may be of different characteristics (e.g., large vs. small cross section) and/or functionalities in the 3D printing process. The scanners may be controlled manually and/or by at least one controller. For example, at least two scanners may be directed by the same controller. For example, at least two scanners may be directed each by its own controller. At least two of the controllers may be operatively coupled with (e.g., to) each other. At least two of the energy beams may irradiate the surface simultaneously or sequentially. At least two of the energy beams may overlap in their irradiation times. At least two of the energy beams may be directed (i) towards the same position at the target surface, or (ii) to different positions at the target surface. The one or more scanners may be positioned at an angle (e.g., tilted) with respect to the material bed. A portion of the enclosure, that is occupied by the energy beam (e.g., the energy flux or the scanning energy beam) can define a processing cone. FIG. 10 shows an example of two scanners (e.g., 1020, 1010) that are tilted at an acute angle 1030 with respect to the target surface 1015. Each scanner may be positioned such that the processing cones of the scanners (e.g., FIG. 10, 1075, 1070) may have a large overlap region (e.g., 1050) of potential irradiation of the target surface. Positioned may include angular position (e.g., 1030). In some embodiments one or more scanners may be positioned at a normal to the target surface. The target surface may be the exposed surface of a material bed. Large may include covering a maximum number of positions on the target surface. Large may include covering all the positions on the target surface. Each position on the target surface may receive exposure from each of the scanners. At times, the target surface may be translated to achieve a requested exposure from each of the scanners. The scanners may comprise high conductivity and/or high reflectivity mirrors (e.g., sapphire mirrors, beryllium mirrors, or the like).

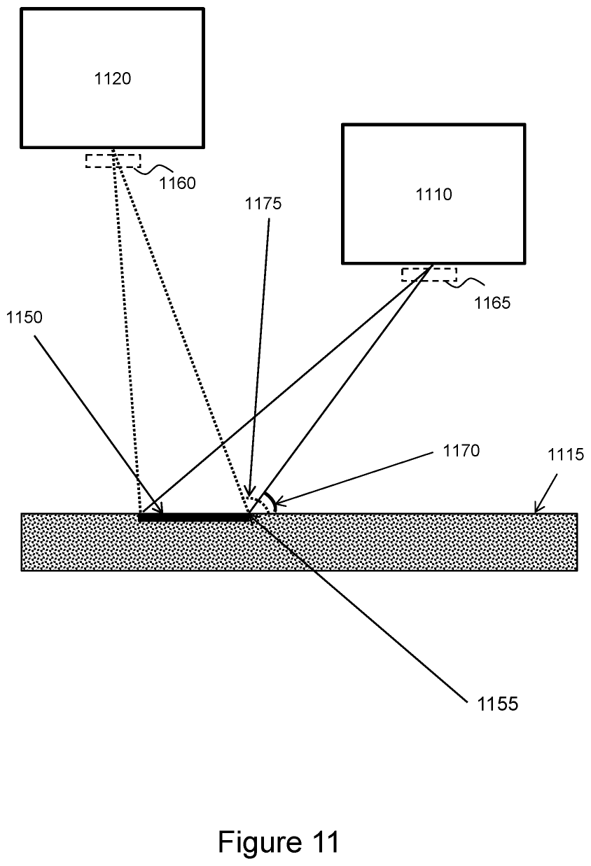

FIG. 11 illustrates an example of systematic variation within a 3D printer. A portion (e.g., 1150) of the target surface (e.g., 1115) or a position therein (e.g., 1155), may be viewed at a different angle (or range of angles) from one or more components of the 3D printer (e.g., with respect to the target surface). For example, a portion in the field of view (e.g., FIG. 11, 1150) may be viewed at a first angle (e.g., FIG. 11, 1175) from the optical system (e.g., FIG. 11, 1120), and from a second angle (e.g., FIG. 11, 1170) from a detection system (e.g., FIG. 11, 1110). The first angle may be different from the second angle. The difference in the first angle and/or second angle may induce a systematic (e.g., instrumentation) variation when measuring within the field of view. The systematic variation may be pre-calculated and/or calibrated. The pre-calculated systematic variation may be considered when performing measurement of one or more optical properties (e.g., XY offset of the energy beam relative to the target surface, or velocity of the energy beam).

In some embodiments, a detection system that is operationally coupled with (e.g., to) a 3D printing system (e.g., included as part of a 3D printer) comprises an apparatus configured to project structured electromagnetic radiation (e.g., structured light) within the 3D printing system (e.g., within its enclosure, e.g., within its processing chamber of). In some embodiments, an optical system may comprise a (e.g., structured) light projection apparatus (e.g., FIG. 11, 1120). The light projection apparatus may be configured to project (e.g., structured) light over a field of view of a surface, for example, a (e.g., portion and/or entirety of a) target surface (e.g., FIG. 11, 1115). The (e.g., structured light) detection system may comprise at least one detector (e.g., FIG. 11, 1110) configured to receive illumination (e.g., reflected, scattered, and/or a combination thereof) from the projected radiation, and to generate one or more signals therefrom (e.g., corresponding to an image). Examples of detection systems, 3D printing systems, related devices, apparatuses, software, control system, and methods of fabrication, can be found in International Patent Application Serial No. PCT/US2015/065297, filed Nov. 12, 2015, which is incorporated herein by reference in its entirety. The structured light apparatus may comprise a projector, a laser, or a combination thereof. The structured light apparatus can project any suitable pattern onto a surface for detection by the detector. The structured light may form a projection on a target surface. The structured light may be devoid of a pattern. The structured light may comprise a map or an image. The structured light may comprise a known and/or predetermined projection. Examples of patterns are alternating light and dark shapes (e.g., stripes and/or fringes), a (e.g., pixelated) grid, a (e.g., solid line) grid, and/or a (e.g., plurality of) spiral(s). The pattern may (e.g., controllably) evolve (e.g., change) over time. The change may comprise a change in an orientation and/or scale of at least part of the pattern. The pattern may be static, or moving (e.g., dynamic), for example, during at least part of projection time on the target surface. The pattern may be projected (on the target surface) during at least part of the 3D printing. For example, the pattern may be projected during processing of the energy beam. For example, the pattern may be projected during formation of a planar surface adjacent to the platform. Adjacent may be above.

In some embodiments, an optical path environment is maintained to have low level of contaminants, e.g., to facilitate a (e.g., substantially) clean optical path. One manner of maintaining a clean optical path can be to isolate the optical elements along the optical path from an exterior (e.g., external) atmosphere, e.g., in an optical enclosure. The isolation of the optical elements may comprise isolating of any related structures, such as support structures. An exterior atmosphere can be an ambient environment (e.g., external to enclosures of the 3D system) where personnel operate. An exterior atmosphere can comprise an atmosphere in a processing chamber of a 3D printing system. Isolation of the optical path can comprise disposing the optical element(s) in an optical chamber, which is also referred to herein as an “optical enclosure.” Isolation can take the form of (e.g., enclosure) channel(s) that surround and enclose the elements along the optical path, e.g., in the optical chamber. The channels can be covered channels (e.g., tubes). Isolation can take the form of a sealed optical chamber. The sealed optical camber can be hermetically sealed and/or gas tight. The sealed optical chamber can be sealed to deter ingress of debris into the optical chamber. The optical chamber may comprise a filter, e.g., to deter ingress of debris into the optical chamber. The sealed optical chamber can isolate the optical element in terms of gas and/or radiation. Isolation can comprise maintaining a positive pressure in the isolation component(s) including the enclosure channel(s) and/or the optical chamber. For example, the pressure in the area enclosing the isolation component(s) may be at a positive pressure with respect to the ambient pressure, e.g., at 1 atmosphere or about 1 atmosphere. For example, a pressure within the optical enclosure is about ambient pressure and a pressure within the enclosure channels is above ambient pressure. For example, a pressure within the optical enclosure and within the enclosure channels is above ambient pressure. For example, a pressure within the optical enclosure and within the enclosure channels is about ambient pressure. At times, a gas flow pressure within the isolation component(s) and the pressure directly adjacent to the isolation component(s), may be different. The raised pressure may be at least about 0.5 pounds/inch2 (psi), 1 psi, 2 psi, 3 psi, 4 psi, 5 psi, 6 psi, 7 psi, 8 psi, 9 psi, or 10 psi above the ambient pressure. The raised pressure may be any value between the afore-mentioned values, for example, from about 0.5 psi to about 10 psi, or from about 0.5 psi to about 5 psi. The raised pressure may be referred to herein as “positive pressure.” The raised pressure may be the pressure directly adjacent to the isolation component(s). The raised pressure may be the average pressure in the isolation component(s). Isolation can comprise maintaining an atmosphere that is filtered (e.g., using one or more filtration devices coupled with (e.g., to) intake and/or exit outlets). The gas intake and/or exit outlets may be coupled with (e.g., to) the optical chamber and/or to the channel(s). Gas flow exiting a gas outlet of the optical chamber can include solid and/or gaseous contaminants such as debris. In some embodiments, a filtration system filters out at least some of the solid (e.g., debris) and/or gaseous contaminants, thereby providing a clean gas (e.g., cleaner than gas flow outside of the optical path environment). The filtration system can include one or more filters. The filters may comprise oil filters, particulate filters, humidity filters or chemical filters (e.g., column). The particular filter may comprise high efficiency particulate air (HEPA) filters, 0.1 micron particulate filter, or the like. Isolation can comprise maintaining an atmosphere of a (e.g., substantially inert, dry, pure, and/or clean) gas composition. The gas composition may comprise clean air, or an inert gas. The inert gas may comprise argon gas, or nitrogen gas. The gas composition may comprise a reactive agent. The reactive agent may react with the starting material of the 3D printing, e.g., under ambient temperature and/or pressure. The reactive agent may comprise oxygen or humidity. The gas composition may comprise the reactive agent in a concentration similar to, or different from, its concentration at the ambient atmosphere external to the optical enclosure (e.g., where personnel operate). For example, the gas composition may comprise the reactive agent in a concentration lower than it concentration in the ambient atmosphere.

In some embodiments, enclosure channel(s) that surround and enclose the elements along the optical path comprise at least one of opening (e.g., holes, slits, vents, perforations). The opening may allow gas from within the enclosure channel(s) to exit therethrough (e.g., via positive pressure maintained within the enclosure channel(s) with respect to outside the enclosure channel(s)). The openings may be disposed at locations along the enclosure channel(s) that are removed from (e.g., not adjacent to) an optical element. Thus, (I) the gaseous atmosphere in a vicinity of the optical element(s) may be maintained at a condition of lower turbulence with respect to the atmosphere in the vicinity of the opening and/or (II) any contaminants that are present within the enclosure channel(s) may be less likely to contact and/or adhere to the optical element(s).

In some embodiments, the opening may be a miss fitted seal. In some embodiments, enclosure channel(s) comprise (e.g., at least two) segments joined by a (e.g., at least partially) mis-fitting seal, which mis-fitting seal comprises at least one seal surface having a controlled leak path. The (controlled leak path) mis-fitting seal may be referred to herein as “leaky” (e.g., a leaky seal). The leaky seal may allow gas from within the enclosure channels to exit therethrough (e.g., via positive pressure maintained within the enclosure channels with respect to outside the enclosure channels). The mis-fitting seal(s) may be disposed at locations along the enclosure channels that are removed from (e.g., not adjacent to) the optical element(s). In this manner the gaseous atmosphere in a vicinity of the optical element(s) may be maintained at a condition of lower turbulence in the channel with respect to the atmosphere in the vicinity of the leaky seal(s) external to the channels. Any contaminants that are present within the enclosure channels may be less likely to contact and adhere to the optical element(s) when a path of travel to an exit of the enclosure tubes (e.g., a leaky seal) is not adjacent to an optical element. Clean gas may be provided to the enclosure (e.g., to a sealed optical enclosure, and/or to enclosure channels comprising the opening and/or the leaky seals). Clean gas may be provided by means of an inlet and/or outlet port, one or more filters, a pump, inert gas(es), or a combination thereof. The term “clean gas” as understood herein may refer to a gas that is cleaner (e.g., has a lower concentration of contaminants) than an exterior of the enclosure tube.

In some embodiments, an optical enclosure is part of, or is operatively coupled to, the 3D printing system. The optical enclosure can be maintained at a positive pressure, such that atmospheric gases at a surrounding area of the optical enclosure (e.g., within a processing chamber and/or within an ambient environment) do not enter the environment of the optical enclosure. The optical enclosure can include an (e.g., at least one) inlet port and an (e.g., at least one) outlet port configured for gas exchange. The optical enclosure can comprise any filtration system, e.g., as described herein. One or more filters of the filtration system can be disposed adjacent to the inlet port, the outlet port, or a combination thereof. The optical enclosure can comprise one or more sensors, e.g., configured to detect particulates and/or other material (e.g., contaminants). The sensor(s) can be any sensors described herein. One or more contaminant sensors can be disposed at the inlet port, the outlet port, in proximity (e.g., adjacent) to one or more optical elements, or a combination thereof. The gas flow, filtration system, any components thereof (e.g., pumps, sensors, filters, and controllers), 3D printing systems, their related devices, apparatuses, software, control system, and methods of fabrication can be found in can be any of those described in International Patent Application Serial Nos. PCT/US17/60035, and in PCT/US19/14635 filed Dec. 9, 2019, each of which is incorporated herein by reference in its entirety.

In some embodiments, the 3D printing system comprises energy beams. The 3D printing system can include at least two energy beam sources: a first energy beam source and a second energy beam source which are each configured to generate corresponding energy beams. At times, there may be at least 2, 4, 5, 6, 8, 10, 12, 24, or 36 energy sources, each generating an energy beam that participates in the 3D printing. At times, there may be at least 2, 4, 5, 6, 8, 10, 12, 24, or 36 energy beams, each energy beam participating in the 3D printing. Optical mechanisms can be used to control aspects of the energy beams (e.g., their translation). For example, the optical mechanisms can control the trajectories, e.g., optical paths, of the respective energy beams through respective optical windows (which can also be referred to as windows), into the processing chamber, and towards a target surface. At least two of the energy beams may be different in at least one energy beam characteristic. At least two of the energy beams may be the same in at least one energy beam characteristic. The at least one energy beam characteristic may include, energy flux, rate, intensity, wavelength, amplitude, power, cross-section, and/or time exerted for the energy process, at least two of the energy beams are used together (e.g., sequentially and/or in parallel) during printing of a single layer of transformed material. In some embodiments, the first energy beam can be used to form a first layer of transformed material and second energy beam can be used to form a second layer of transformed material that is different than the first layer.

In some embodiments, an optical system includes a plurality of optical assemblies comprising optical elements. Each optical assembly may be configured to direct a different energy beam of a plurality of energy beams. An optical assembly may be enclosed (e.g., fully) within an optical housing, e.g., a modular optical housing, that is different from an optical housing enclosing (e.g., fully) a different optical assembly. For example, a first optical assembly configured to direct a first energy beam is enclosed (e.g., fully) within a first optical housing; and a second optical assembly is configured to direct a second energy beam is enclosed (e.g., fully) within a second optical housing. The housing(s) each enclosing an optical assembly can be housed within an optical enclosure. In some embodiments, the plurality of optical assemblies are enclosed (e.g., fully) within an optical enclosure.

In some embodiments, at least two optical housings are modular. The optical system can be configured to receive the modular optical housings. The optical system can be configured to receive at least 2, 4, 5, 6, 8, 10, 12, 24, or 36 modular optical housings arranged with respect to an optical enclosure. The optical housings may be operable to direct a respective energy beam through a respective optical window into the processing chamber and to a target surface. The target surface may be an exposed surface of a material bed. The optical system may be operable to receive a number of modular optical housings that is different than or equal to a number of optical windows. Different number may be a smaller number or a higher number.

In some embodiments, an optical system is coupled with (e.g., to) a processing chamber via optical windows. The optical system may be configured to direct energy beam(s) along respective beam paths through the optical windows into the processing chamber and incident on a target surface in the processing chamber. The target surface may be an exposed surface of a material bed. For example, the optical system may be configured to direct two or more energy beams along beam paths through a same optical window into the processing chamber to the target surface. For example, the optical system may be configured to direct each energy beam along a respective beam path through a different optical window. An interior of an optical enclosure of the optical system may be isolated from the interior of the processing chamber by a wall (e.g., the processing chamber ceiling) having one or more optical windows. A window holder for supporting a window (e.g., an optical window) and/or at least partially shielding a window from debris can have any suitable hollow shape (e.g., cylindrical, polyhedron, e.g., prism, or a truncated cone). For example, the window may have a first cross-sectional shape, and the window holder may have the same or a different second cross-sectional shape as the window. The first and/or second cross-sectional shapes may be a geometric shape (e.g., any polygon described herein). The first and/or second cross-sectional shapes may comprise a straight line or a curved line. The first and/or second cross-sectional shapes may comprise a random shape.

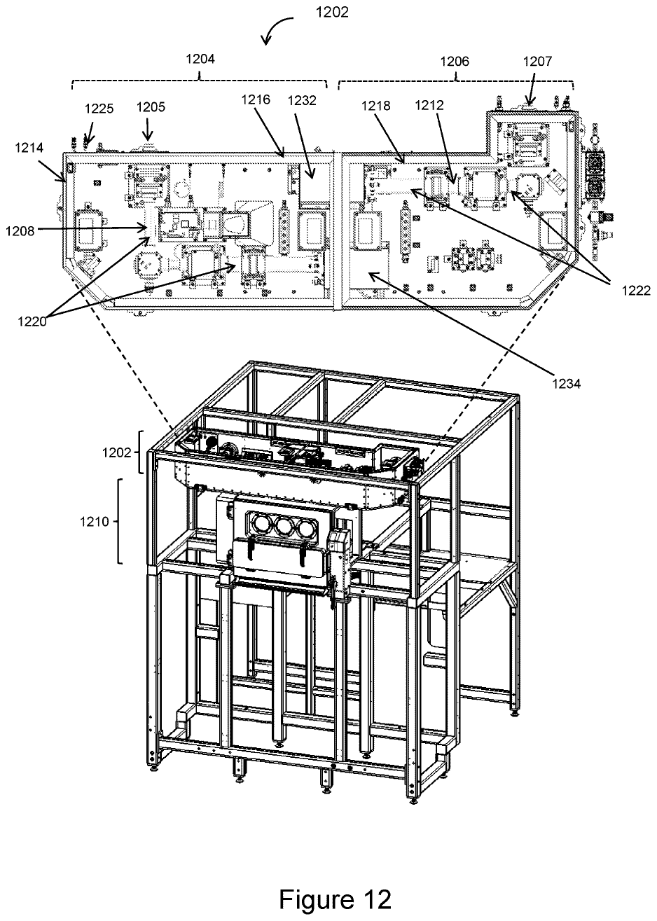

In some embodiments, an optical enclosure (e.g., fully) encompasses an optical system of a 3D printing system. FIG. 12 depicts an example of (e.g., a portion of) a 3D printing system comprising an optical system 1202. Optical system 1202 comprises optical assembly 1204 and optical assembly 1206. Optical assembly 1204 comprises a plurality of optical components. Optical assembly 1206 comprises a plurality of optical components. Optical assembly 1204 is configured to direct an energy beam (e.g., irradiating energy) from a first energy source along a first beam path 1208 through a first optical window into processing chamber 1210 and incident on an exposed surface (e.g., of a material bed). Optical assembly 1206 is configured to direct irradiating energy from a second energy source along a second beam path 1212 through a second optical window into the processing chamber 1210 and incident on the exposed surface (e.g., of a material bed). An optical enclosure 1214 surrounds and/or encloses the optical assembly 1204 and the optical assembly 1206 of the optical system 1202. As depicted, the optical enclosure 1214 comprises two optical housings 1216 and 1218. A first optical housing 1216 surrounds and/or encloses optical assembly 1204 configured to direct a first energy beam from an energy source along the first beam path portion 1208. The energy beam of the energy source can be directed (e.g., coupled) into optical assembly 1204 by a coupler 1205, for example, a fiber-coupler and/or free space optics. A second optical housing 1218 surrounds and/or encloses optical assembly 1206 configured to direct a second energy beam from an energy source along the second beam path portion 1212. The energy source coupled with (e.g., to) optical housing 1218 can be the same energy source to which enclosure 1214 couples, or a different energy source to which enclosure 1214 couples. The second energy beam can be directed (e.g., coupled) into optical assembly 1206 by a coupler 1207, for example, a fiber-coupler and/or free space optics. Optical enclosure 1214, the first optical housing 1216, and/or the second optical housing 1218 can form a (e.g., substantially) isolated environment. In some embodiments, the first optical housing and the second optical housing each form a (e.g., substantially) isolated environment from each other. Optical assembly 1204 includes enclosure channels 1220 configured to enclosure a portion of beam path such as 1208. Optical assembly 1206 includes enclosure channels 1222 enclosing a portion of beam path such as 1212. Gas flow may be introduced into optical housing 1216, optical housing 1218, and/or optical enclosure 1214 via one or more inlets such as 1225 to introduce gas, such as clean gas within optical housing 1216, optical housing 1218, and/or optical enclosure 1214. The inlets may generate a positive pressure of the atmosphere(s) within optical housing 1216, optical housing 1218, and/or optical enclosure 1214. In the example shown in FIG. 12, the two optical housings are coupled such that (A) optical housing 1216 includes scanner assembly 1232 configured to direct an energy beam propagating through channels 1222, and (B) optical housing 1218 includes scanner assembly 1234 configured to direct an energy beam propagating through channels 1220.

At times, it may be advantageous to allow for easy installation and/or components of the 3D printing system. For example, it may be advantageous if one or more components of the 3D printing system are easily maneuvered (e.g., insertable and/or removed). Easy maneuvering (e.g., removal and/or insertion) may include actions of a user facing the 3D system, and maneuvering (e.g., pulling, pushing, and/or otherwise moving) the one or more components to facilitate their maneuver (e.g., removal and/or insertion, respectively). For example, easy maneuvering may include actions of a personnel facing a front, a back, a side, a top, or a bottom of the 3D system, and maneuvering the one or more components to facilitate their maneuver. The one or more components may comprise: an energy source (e.g., laser generator), an optical system, a detection system, an optical system enclosure (also referred to herein as “optical enclosure”), a side cover, or an opening, e.g., a door. The front of the 3D printing system facing a user can include a door to the processing chamber. A top of the 3D printing system can face the platform, e.g., through the optical window(s). The top of the 3D printing system may be closer to the optical windows than to the platform. The top of the 3D printing system may face the optical system enclosure or include at least a portion of the optical system enclosure.

In some embodiments, the optical system comprising optical assemblies is subject to installation and/or maintenance. Maintenance and/or installation of the optical assemblies of the optical system has one or more benefits. The benefits may comprise being quicker, cheaper, simpler, requiring fewer personnel, being more robust, or being more reliable than optical systems comprising non-modular optical assemblies (e.g., optical assemblies that are not easy to remove from the 3D system).

In some embodiments, the optical system is operatively coupled with (e.g., to) one or more controllers. The one or more controllers may be configured to maneuver at least one of the optical components of the optical assembly(s). For example, the one or more controllers may be configured to alter a position and/or angle of the optical component(s) with respect to a reference. For example, the one or more controllers may be configured to alter a position and/or angle of the optical components with respect to each other. The one or more controllers may be part of the control system. The control system may comprise controllers that, e.g., may have a hierarchical structure. The hierarchical structure may comprise at least three levels of hierarchy. The control system may be configured to control one or more components of the 3D printing system. The control system may be configured to control the printing of one or more 3D objects by the 3D printing system, e.g., in a printing cycle. The control system may be configured to control maneuvering optical component(s) of optical assembly(s) (s) before, during (e.g., in real-time), and/or after operation of the 3D printer, e.g., to print one or more 3D objects (e.g., in a printing cycle). Examples of 3D printers, optical assemblies, optical components, controllers, related control system, related methods, apparatuses, systems, and program instructions (e.g., software) can be found in U.S. Provisional Patent Application Ser. No. U.S. 63/290,878 filed Dec. 17, 2021, and in U.S. Provisional Patent Application Ser. No. U.S. 63/290,894 filed Dec. 17, 2021, each of which is incorporated herein by reference in its entirety.

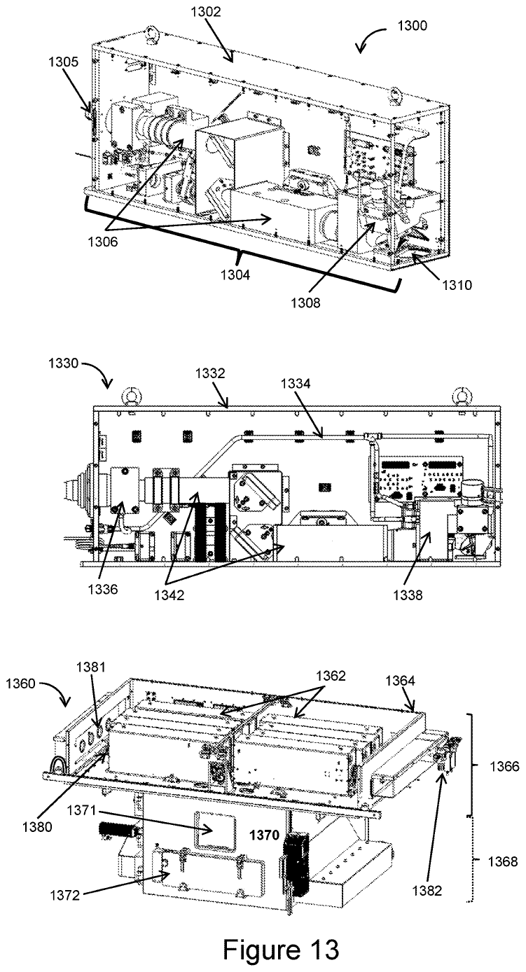

FIG. 13 depicts views of various components of a 3D printing system. As depicted in FIG. 13, a modular optical unit 1300 comprises an optical housing 1302 enclosing (e.g., fully) an optical assembly 1304 including optical components. A portion of an optical path of an energy beam is enclosed by enclosure channels 1306. An optical assembly can comprise optical components comprising a mirror, lens, prism, beam splitter, collimator, or the like. Optical assembly 1304 comprises a scanner 1308. Optical assembly 1304 comprises a coupler 1305, e.g., a fiber-coupler or free space optics coupling, to direct light from an energy source, e.g., a laser source, into the optical assembly 1304. Optical assembly 1304 is configured to direct an energy beam along a beam path and through an opening in the optical housing 1302. When the modular optical unit 1300 is aligned within an optical enclosure of an optical system and aligned with a processing chamber, optical assembly 1304 is configured to direct an energy beam along a beam path through opening 1310 and through an optical window located between the optical enclosure and the processing chamber such that the energy beam is directed toward a target surface disposed in the processing chamber, such as an exposed surface of a material bed.

FIG. 13 depicts a schematic view 1360 of an optical system comprising eight modular optical units such as 1362 (each with its own housing) arranged within an optical enclosure 1364 of an optical system 1366. The eight modular optical units 1362 are each arranged within the optical enclosure 1364 to align each modular optical unit such as 1362 with a respective optical window of the processing chamber 1368. For example, each modular optical unit such as 1362 is arranged within the optical enclosure 1364 to align a beam path of an energy beam directed by an optical assembly of the modular optical unit through an optical window of the processing chamber 1368 and toward an exposed surface (e.g., of a material bed) within the processing chamber 1368 having a primary door 1370 equipped with a viewing window 1371 and a secondary door 1320 (e.g., to a glove box). The eight modular optical units (including optical units 1362) are each arranged within the optical enclosure 1364, e.g., to align each modular optical unit with a respective energy source via an optical coupler of the modular optical unit, e.g., optical coupler 1380 of modular optical unit. An optical coupler 1380 can be, for example, a fiber-coupler or free-space optics. The optical couplers of the modular optical units may be arranged with respect to ports such as port 1381 of the optical enclosure to allow for coupling between the optical couplers and respective energy sources, e.g., laser sources. For example, an optical coupler 1380 of a modular optical unit is arranged with respect to a port to align an energy source with the optical coupler 1380.

In some embodiments, optical windows (e.g., and their corresponding window holders) are arranged symmetrically. The symmetry may comprise mirror symmetry, rotational axis symmetry (e.g., C₂ axis), or inversion symmetry. The symmetry may exclude inversion symmetry. For example, the optical window may be symmetrically disposed, which symmetry includes inversion symmetry. For example, the optical window holders may be symmetrically disposed, which symmetry may exclude inversion symmetry (e.g., due to a 3D shape of the window holder). The 3D shape of the window holder may comprise a hollow truncated cone, a hollow cylinder, or a hollow prism. The window holder may be closed on one of its open ends with the optical window. The optical windows (e.g., and their corresponding window holders) in the optical window arrangement may symmetrically relate to each other using one or more mirror symmetry planes, one or more rotational axis planes, and/or using an inversion point.

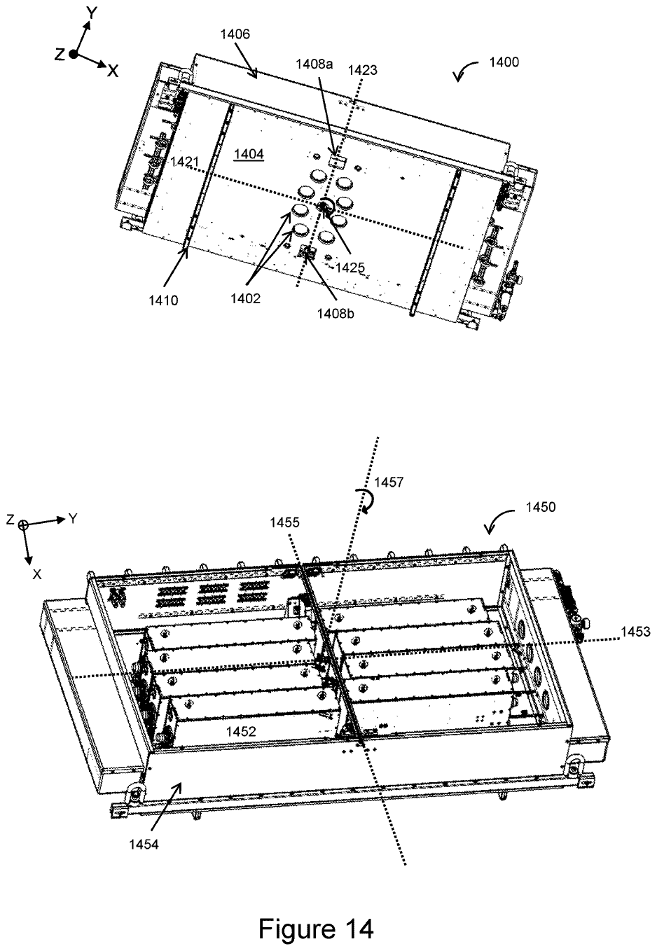

FIG. 14 shows schematic view 1400 of an example configuration of optical window holders 1402 that are symmetrically arranged using symmetrical relations that include (i) a mirror symmetry plane parallel to the XZ plane and along dotted line 1421, (ii) a mirror symmetry plane parallel to the XZ plane and along dotted line 1423, (iii) a C₂ (180 degrees) rotational axis running through point 1425 and aligned parallel to the Z axis, (iv) a C₂ (180 degrees) rotational axis running along dotted line 1421, and (iv) a C₂ (180°) rotational axis running along dotted line 1423. The optical windows in the window holders 1402 would be similarly symmetrically related, except that they would also be related by an invention symmetry through point 1425. Examples of 3D printers, optical assemblies, optical components, controllers, related control system, related methods, apparatuses, systems, and program instructions (e.g., software) can be found in PCT/US2022/016550 that is incorporated herein by reference in its entirety.

As depicted in the example view 1400, window holders 1402 are arranged on a surface 1404 of an optical enclosure 1406 located between the optical enclosure and a processing chamber of a 3D printing system. Optical enclosure 1406 includes viewports 1408a and 1408b through which sensors, detectors, other optical beam(s), other optical measurement, and/or optical test equipment, may have line of sight of the target surface within the processing chamber. Optical enclosure 1406 includes mounting hardware, e.g., rails 1410, to affix or couple the optical enclosure 1406 to the processing chamber.

FIG. 14 shows a schematic view 1450 of an example configuration of an optical system comprising eight modular optical units 1452 arranged within an optical enclosure 1454, e.g., optical enclosure 1406. The modular optical units such as 1452, e.g., modular optical units such as 1362 of FIG. 13, are arranged using symmetrical relationships including (i) a mirror symmetry plane perpendicular to an XZ plane along dotted line 1453 (ii) a mirror symmetry plane perpendicular to the XZ plane and along dotted line 1455, and/or (iii) a C₂ (180° (degrees)) rotation about axis 1457 and aligned parallel to the Y axis. Each of the modular optical units (e.g., 1452) is arranged within optical enclosure 1454 such that an energy beam directed through a modular optical unit is directed through an opening in the optical housing of the modular optical unit 1452 and through an optical window retained by a corresponding optical window holder, e.g., optical window holder 1402. This discussion re symmetry relationship in FIG. 14 does not consider any couplers and/or ports, e.g., disposed at any end of the optical units, or an interior arrangement in the optical units, which may limit some of the symmetry relations.

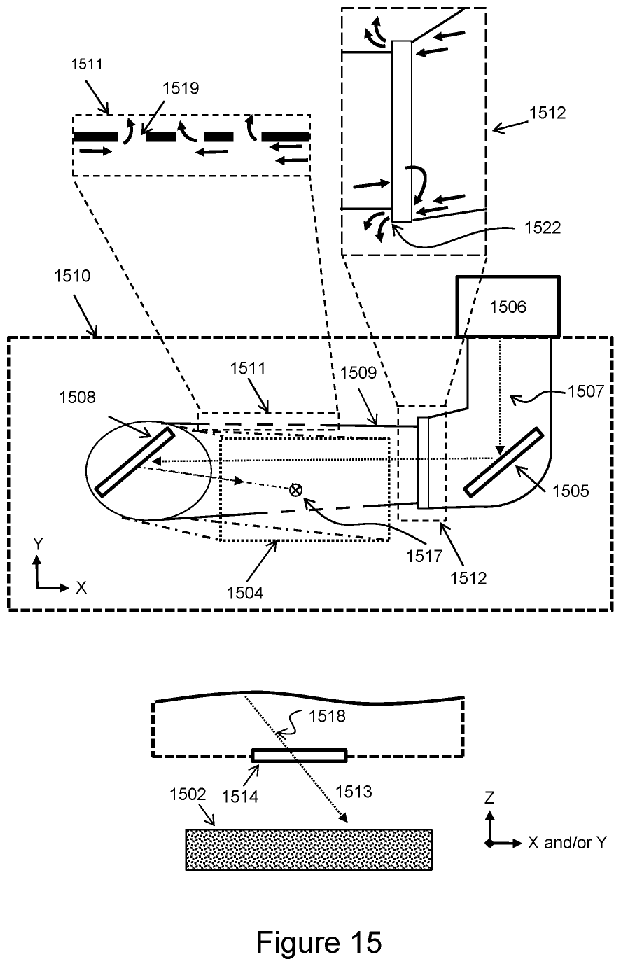

FIG. 15 depicts a horizontal view example of a portion of a 3D printing system comprising an optical system 1510 configured to direct irradiating energy (e.g., energy beam) from an energy source 1506 to travel between mirrors 1505 and 1508 along a beam path 1507, the beam path continuing down 1517 through an optical window 1504. FIG. 15 depicts a vertical view example of an energy beam following a beam path 1518 in an optical system, through an optical window 1514, to a position on a target surface 1502 (e.g., exposed surface of a material bed). The optical window may comprise a coating and/or a filter, forming a modified irradiating energy beam (e.g., FIG. 15, along path 1513). In the example of FIG. 15, an enclosure channel 1509 surrounds and/or encloses the optical elements (e.g., 1504, 1505, and 1508), including the entry point of the irradiating energy beam from the energy source. In the example of FIG. 15, the enclosure channel 1509 comprises a section 1511 having a plurality of openings such as 1519, and a mis-fitting seal 1512 comprising a leaky region 1522. In the example FIG. 15, magnified regions corresponding to 1511 and 1512 depict arrows representing a flow of gas within the enclosure tube, e.g., exit flow out of the openings and leaky seal, respectively.

In some embodiments, a 3D printing system includes, or is operationally couple with (e.g., to), one or more gas recycling systems. The gas recycling system can be at least a portion of the gas flow mechanism. FIG. 16 shows a schematic side view of an example 3D printing system 1600 that is coupled with (e.g., to) a gas recycling system 1603 in accordance with some embodiments. 3D printing system 1600 includes processing chamber 1602, which includes gas inlets 1604 and gas outlet 1605. The gas recycling system (e.g., 1603) of a 3D printing system can be configured to recirculate the flow of gas from the gas outlet (e.g., 1605) back into the processing chamber (e.g., 1602) via the gas inlets (e.g., 1604). Gas flow (e.g., 1606) exiting the gas outlet can include solid and/or gaseous contaminants such as debris (e.g., soot). In some embodiments, a filtration system (e.g., 1608) filters out at least some of the solid and/or gaseous contaminants, thereby providing a clean gas (e.g., 1609) (e.g., cleaner than gas flow 1606). The filtration system can include one or more filters. The filters may comprise physical filters or chemical filters. The clean gas (e.g., 1609) exiting the filtering mechanism (also herein “filtration system”) can be under lower pressure relative to the incoming gas pressure into the filtering mechanism. The clean gas can be directed through a pump (e.g., 1610) to regulate (e.g., increase) its relative pressure prior to entry to the processing chamber. Clean gas (e.g., 1611) with a regulated pressure that exits the pump can be directed through one or more sensors (e.g., 1612). The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within processing chamber (see example values of positive pressure described herein). A first portion of the clean gas can be directed through an inlet (e.g., 1604) of a gas inlet portion of the enclosure, while a second portion of the clean gas can be directed to first and/or second window holders (e.g., 1614 and 1616) that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter (e.g., 1617) prior to reaching one or both of the window holders. In some embodiments, the one or more filters (e.g., as part of filters 1617 and/or filtration system 1608) are configured to filter out particles having nanometer-scale (e.g., about 10 nm to about 500 nm) diameters. In some embodiments, the gas recycling system provides clean gas to a recessed portion (e.g., 1618) of the enclosure. In some embodiments, gas flow (e.g., 1650a and 1650b) from the recessed portion (e.g., 1618) of the enclosure can be directed through the gas recycling system (e.g., 1603). In some embodiments, gas flow from the recessed portion can be directed through one or more filters of a filtration system. In some embodiments, the gas recycling system provides clean gas directed to first and/or second window holders (e.g., 1614 and 1616).

In some embodiments, the flow dynamics of the gas as it exits a gas inlet portion and directed over a target surface, is controlled. For example, a turbulence of the flow of gas from the gas exit port can be reduced using a flow aligning structure (also referred to herein as flow aligner). The flow alignment structure can be more proximate to the platform than the baffle(s). The flow alignment structure can be more proximate to the outlet port of the gas inlet portion than the baffle(s). The flow alignment structure can direct gas within the gas inlet portion toward the outlet port or include the outlet port. In some embodiments, the flow aligning structure is part of (e.g., within) an outlet port section of the gas inlet portion. The outlet port section can have an elongated shape (e.g., in accordance with an elongated shape of the outlet port. FIG. 17 shows examples of perspective views of flow aligning structures 1700 and 1720, respectively, in accordance with some embodiments. The flow aligning structure (e.g., 1700 or 1720) can include flow aligning walls (e.g., 1702 or 1722) (which can be referred to as walls, partitions, separators, dividers, or other suitable term), which walls can at least partially define flow aligning passages (e.g., 1704 or 1724) that are configured to allow gas to flow therethrough. The flow aligning passages can be referred to as channels, tunnels, elongated holes, elongated openings, conduit, pipe, tube, or other suitable term. The flow aligning passages can run lengthwise in accordance with a flow gas (e.g., in the X direction in FIG. 17) such that flow aligning walls (e.g., 1702 or 1722) can reduce gas flow widthwise and/or height-wise (e.g., in Y and Z directions in FIGS. 17A, and 17B), thereby channeling gas flow along their lengthwise direction (e.g., in the X direction of FIG. 17 (e.g., direction 1706 or 1726 respectively)). The walls of the flow aligning structure can align different portions of the flow gas in accordance with a desired direction (e.g., X direction). The length of the flow aligning structure (e.g., l in each of 1700 and 1720 of FIG. 17) can vary. In some embodiments, length of the flow aligning structure (e.g., comprising the flow aligning channels) is in accordance with a length of the gas exit port. In some embodiments, a length of the flow aligning structure (e.g., as measured from a top of the target surface (e.g., material bed) to a top of the flow aligning structure) is at most about 5″ (inches), 4″, 3″, 2″, 1″, or 0.5″. In some embodiments, the height of the flow aligning structure ranges between any of the afore-mentioned heights (e.g., between 0.5″ and 5″, between 0.5″ and 3″, or between 3″ and 5″). The number and shape of the channels of the flow aligning structure can vary. In some embodiments, flow aligning passage has a polygonal (e.g., hexagonal) cross sections (e.g., as shown in the example of FIG. 17, 1700). The polygon may be a space filling polygon. The flow aligning passage may comprise a prism, a cone, or a cylinder. The prism may comprise a polygonal cross section (e.g., any polygon described herein). The flow aligning passages can (i) have a cross section that facilitates, and/or (ii) can be packed in, a space-saving configuration that maximizes the cross-sectional area of flow aligning passages (e.g., in a direction perpendicular to the direction of flow). In some embodiments, the flow aligning passage may have a round cross section (e.g., as shown in FIG. 17, 1726), thereby forming flow aligning passage having corresponding round cross sections (e.g., a cylindrical shaped passage)—which may be packed in a space saving configuration (e.g., cubic closed packed, a.k.a., face-centered cubic configuration). In some embodiments, a ratio of the total cross-sectional area of flow aligning passages is at least about 80%, 85%, 90%, 94%, 95%, 96%, 98, or 99% of a respective total cross sectional area of the flow aligning structure (e.g., which includes the thicknesses of the flow-aligning walls). It should be noted that the flow aligning structures described herein is not limited to honeycomb shaped or cylindrical shaped flow aligning walls and/or passages. That is, the flow aligning structures can have flow aligning walls and/or passages having any suitable 3D shape or combination of shapes (e.g., polyhedron, prism, cone (e.g., having an elliptical base, e.g., circular base), cylinder (e.g., right elliptical cone, e.g., right circular cone), pyramid (e.g., having a polygonal base), or any combination thereof). For example, the flow aligning walls and/or passages can have any suitable 3D or cross-sectional shape described herein with reference to FIGS. 16 and 17. Furthermore, flow aligning structures described herein can have any suitable number of passages (e.g., channels), and walls having any suitable thickness. In some embodiments, the flow aligning structure comprises a (e.g., substantially) two-dimensional structure that amounts to a mesh structure or plate that includes perforations (i.e., a perforated plate) for allowing gas to flow therethrough. In some embodiments, more than one flow aligning structure is used in combination.

In some embodiments, the gas flowing into at least a portion of the 3D printing system is aligned and/or directed. As described herein, the gas inlet portion of the 3D printing system can include flow aligning structures that align (e.g., straighten) the flow of gas as it exits the gas inlet portion and/or enters the processing chamber. In some embodiments, the flow aligning structure is not limited to being within an outlet port section. It should be noted that the various embodiments of structures, features, and mechanisms of 3D printing systems described herein can be combined in any suitable arrangement. For example, a gas inlet portion can include features that direct gas flow (I) toward a target surface, e.g., an exposed surface of a material bed, and/or (II) gas flow channeling structures such as gas manifolds, e.g., of the optical system. As another example, a window purging system can be combined in any suitable way with a window recessed portion and/or a window housing. The window purging system can be unidirectional. As an example, gas outlet portions can be combined in any suitable way with any feature of a gas inlet portion. That is, the various advantages provided by individual structures, features, and mechanisms described herein can be combined an any suitable way within a 3D printing system. The gas directing structure may comprise closed packed hollow prisms.

FIG. 17 shows an example of flow aligning structure 1700 that comprises closed packed hollow hexagonal prisms such as 1704 having length (I) 1702. Gas can flow through structure 1700 in the direction 1706, or in a direction opposing to 1706. FIG. 17 shows an example of flow aligning structure 1720 comprising closed packed hollow cylinders disposed in a closed packed (e.g., face center cubic) arrangement, which cylinders have a length 1722 (I), and a circular cross section 1724. Gas can flow through structure 1720 in the direction 1726, or in a direction opposing to 1726.

In some embodiments, the 3D printing system comprises a flow aligning structure. The one or more channels in the flow aligning structure may be configured and/or adjusted to facilitate a gas flow trajectory (e.g., alignment), velocity, chemical makeup, or temperature of the gas flow. The velocity and/or trajectory may of the gas flow expelled from the aligning structure may minimally alter the target surface. For example, a temperature of the one or more channels may adjust (e.g., heat or cool) during passing of the gas flow adjacent thereto. For example, a temperature of the gas flow may adjust (e.g., heat or cool) during its passage through the aligning structure. The adjustment may be before, after, and/or during at least a portion of a 3D printing operation (e.g., during a period when the energy beam irradiates material bed, or when no energy beam irradiates a material bed). The adjustment may be controlled manually and/or automatically (e.g., using a controller). In some embodiments, one or more channels in the aligning structure are exchangeable, movable, expandable, and/or contractible. In some cases, the one or more channels are heated and/or cooled. In some embodiments, the one or more channels comprise a desiccant (e.g., molecular sieves or silica). The desiccant may be covalently bound, or adhered, to an interior surface of the one or more channels. The desiccant may be embedded in a matrix that is casted onto the internal surface of the one or more channels. In some cases, the one or more channels may be operatively coupled with (e.g., to) one or more sensors (e.g., humidity, temperature, and/or oxygen sensors) for measuring characteristics of the gas flow within the aligning structure. The one or more channels may be operatively coupled with (e.g., to) one or more sensors. The one or more sensors may comprise humidity, temperature, or oxygen sensors.

FIG. 18 illustrates an example of a portion of a 3D printing system 1800. The portion of the 3D printing system 1800 comprises a processing chamber 1802, which may contain an atmosphere (e.g., a pressurized atmosphere). The portion of the 3D printing system 1800 comprises a garage portion 1804 with an excess powder exit port 1806. The portion of a 3D printing system 1800 comprises a gas flow system portion. The gas flow system portion comprises a main channel 1810 having an opening port 1812. The main channel connects to a first channel 1814 directing gas into a first manifold 1816, and a second channel 1818 directing gas into a second manifold 1820. The first manifold 1816 directs gas to a first set of nozzles such as nozzle 1822, each surrounding a respective optical window of a first set of optical windows such as optical window 1824, which nozzles 1822 direct gas into the processing chamber 1802. The second manifold 1820 directs gas to a second set of nozzles such as nozzle 1826, each surrounding a respective optical window of a second set of optical windows such as optical window 1828, which nozzles 1826 direct gas into the processing chamber 1802. The processing chamber has a portion of a floor 1829. Garage portion 1804 is configured to accommodate a layer dispensing mechanism (e.g., recoater) configured to dispense at least a portion of a material bed (e.g., a layer of the material bed). Excess starting material from the recoater is released through exit port 1806. FIG. 18 depicts window 1826 of a metrological detection system, e.g., height mapper. The window may be utilized for a projector or for a sensor. The metrology detection system may determine a topographical map of an exposed surface of the material bed, e.g., in real time during the printing. The metrological detection system may comprise three windows (e.g., two in addition to window 1826) arranged in a single file. For example, two windows at either side of the optical windows, and one in the center of the optical window set.

FIG. 18 illustrates an example of a gas flow system and manifold assembly 1850. The gas flow system and manifold assembly 1850 comprises a main channel 1852 having an opening portion 1854 that receives gas flow into the main channel 1852. The main channel 1852 connects to and directs gas into a first channel 1856a-1856b and a second channel 1858a-1858b. The gas flow system is configured to facilitate gas flow through main channel 1852, first channel 1856a-1856b, and into first manifold 1860 to exit each of the openings, e.g., along path 1891 showing exit through one of the openings as an example. The gas flow system is configured to facilitate gas flow through main channel 1852, second channel 1858a-1858b, and into second manifold 1862 to exit each of the openings, e.g., along path 1892 showing exit through one of the openings as an example. The first channel as a first portion 1856a having a circular vertical cross section, and a second portion 1856b having a rectangular cross section. A baffle may be disposed in the connection of the first portion 1856a and the second portion 1856b. The second channel as a first portion 1858a having a circular vertical cross section, and a second portion 1858b having a rectangular cross section. A baffle may be disposed in the connection of the first portion 1858a and the second portion 1858b. The first channel 1856a-1856b is disposed closer to the opening portion 1854 than the second channel 1858a-1858b. The first channel 1856a-1856b is connected to and directs gas into a first manifold 1860 and the second channel 1858a-1858b is connected to and directs gas into a second manifold 1862. The first manifold 1860 is a hollow casing configured to direct gas toward a first set of openings such as 1864. The first manifold has a height 1871. The second manifold 1862 is a hollow casing configured to direct gas toward a second set of openings such as 1866. The second manifold has a height 1872. The first and second sets of openings are configured to operatively engage optical windows and/or nozzles. Manifold assembly 1850 in FIG. 18 may be configured for disposition relative to gravitational vector 1899 pointing towards gravitational center G.

In some embodiments the optical assembly is configured to direct one or more energy beams (e.g., an energy beam from an energy source) toward a target surface. The target surface may comprise an exposure surface of a material bed such as one in which one or more 3D objects are printed in a printing cycle. The optical assembly may include optical elements. The optical elements may comprise a mirror, a mirror mount, a lens, a beam splitter, a collimator, or a prism. The lens may be configured to focus the energy beam. The optical assembly, (e.g., optical assembly of FIG. 12, 1204, 1206, and FIG. 13, 1304), can be configured to direct the energy beam to translate along a region of the target surface, e.g., propagate along a path on the target surface. The optical assembly may comprise a scanner. The scanner may comprise one or more mirrors. The mirrors may be operatively coupled with (e.g., to) one or more actuators. The actuator may be operatively coupled with (e.g., to) one or more controllers. The optical assembly may include a scanner configured to deflect the energy beam to translate along the region of the target surface. The scanner may comprise a galvanometric scanner, a piezoelectric device, or the like. The scanner may be configured to deflect the energy beam through multiple degrees of freedom (e.g., about multiple axes), for example, a one-axis scanner, a two-axis scanner, one-degree of freedom scanner, two-degree of freedom scanner, at least three-degrees of freedom scanner. The scanner may be a two-axis scanner including two mirrors, e.g., X-axis and Y-axis, configured to deflect the energy beam. The optical assembly may include one or more optical elements arranged to direct one or more energy beams toward the target surface.

In some embodiments, the optical assembly includes a scanner. The scanner can include one or more mirrors, e.g., to deflect an energy beam through multiple degrees of freedom (e.g., about an X-axis and a Y-axis). For example, the scanner may comprise at least 1, 2, or 3 mirrors. The scanner can include a first mirror and a second mirror (e.g., an X mirror and a Y mirror) to direct one or more energy beams from an energy source towards a target surface. The scanner may be disposed in a first enclosure (e.g., optical housing) and the target surface may be disposed in a second enclosure (e.g., processing chamber). An optical window may be disposed between the optical housing and the processing chamber. For example, the optical window may border the optical housing and the processing chamber. The scanner may be configured to direct the energy beam(s) from the optical housing through the optical window, into the processing chamber. The energy source may be disposed adjacent to the processing chamber and adjacent to the optical housing. The first mirror and/or the second mirror of the scanner can be affixed, each on a respective mirror mount. A mirror of the scanner may be affixed to its mounting using an adhesive, a mounting hardware, or any combination thereof. At least two mirrors of the scanner may have a different FLS. At least two mirrors of the scanner may have (e.g., substantially) the same FLS. The mirror of the scanner can have a FLS of at least about 30 millimeters (mm). The mirror of the scanner can have a FLS of at most about 100 mm. The FLS of the scanner mirror can be of any value between the aforementioned values (e.g., from about 30 mm to about 100 mm). For example, the first mirror may have a FLS of between 30 mm and 70 mm. The second mirror may have an FLS of 40 mm and 90 mm. Each mirror can be configured to be arranged with respect to a beam path of one or more energy beams such it may deflect the energy beam about an axis, e.g., about an X-axis, about a Y-axis. The mirror mounts may be affixed to an optical assembly enclosure (e.g., also herein an “optical enclosure”) using mounting hardware. The mirror mounts may be affixed to an optical housing disposed in the optical enclosure. For example, 2 mm diameter hardware (e.g., M2 hardware), 3 mm diameter hardware (e.g., M3 hardware), 4 mm diameter hardware (e.g., M4 hardware), or the like. The mounting hardware for affixing mirror mounts with respect to the optical assembly within the optical assembly enclosure may comprise torque specifications for example, of at least about 0.5 Newton*meter (Nm), 1 Nm, 1.5 Nm, 2.0 Nm, 2.5 Nm, 4.0 Nm, 5.0 Nm, or 10.0 Nm. The torque specification may be between the aforementioned torque values, for example, from about 0.95 Nm to about 1.5 Nm, from about 1.5 Nm to about 2.5 Nm, from about 0.5 Nm to about 10 Nm, or the like. A mirror of the scanner may be affixed to its mounting using an adhesive having a phase transition temperature of at least about 110° C., 120° C., 130° C., 140° C., or 150° C. A phase transition temperature can comprise a liquidous phase transition, a glass transition, a liquification, or the like.

In some embodiments, the optical assembly including a scanner is configured to direct an energy beam along an optical path towards an exposed surface (e.g., of a material bed) within a processing chamber. The scanner may be a two-axis scanner comprising two mirrors, e.g., an X mirror and a Y mirror. X mirror can be coupled with (e.g., to) an actuator, e.g., an X motor. Y mirror can be coupled with (e.g., to) an actuator, e.g., a Y motor. In some embodiments, the optical assembly including a scanner is configured to direct an energy beam along an optical path such that the Y mirror of the scanner directs the energy beam into the processing chamber. A distance from a target surface in the processing chamber to a rotational axis of the Y motor of a two-axis galvanometric scanner can range from about 500 mm to about 1000 mm, from about 650 mm to 850 mm, from about 650 mm to about 950 mm, or from about 650 mm to about 1000 mm. A distance from the target surface to a rotational axis of the Y motor of the scanner can be at least about 500 mm, 650 mm, 750 mm, 850 mm, 1000 mm, or above. A distance from the target surface to a rotational axis of the Y motor of the scanner can be at most about 950 mm, 850 mm, 750 mm, 650 mm, 550 mm or below. The target surface can be an exposed surface of a material bed in the processing chamber.

At times, portions of the optical assembly (e.g., of the scanner and/or portions of the optical elements) may be exposed to stray radiation. For example, during a printing process, an energy beam can reflect from a target surface. For example, the energy beam can reflect from an exposed surface of a material bed and/or off a printed portion of a 3D object being printed. The reflection may comprise a diffused and/or a specular reflection. Reflected radiation incident on optical element(s) of the optical assembly via an optical window, direct and/or indirect such as via another optical element, may induce thermal heating of the optical element(s). For example, stray radiation includes direct reflection from an exposure surface of a material bed. Such radiation may comprise specular reflection. For example, stray radiation includes indirect reflection of radiation from a surface of an optical element of the optical assembly. For example, stray radiation includes direct reflection and indirect reflection. The optical elements may include a mirror or a prism. The optical elements may comprise components of a galvanometric scanner. The heated optical elements may comprise the optical element (e.g., mirror) and/or its mount.

At times, the stray radiation locally heats the optical element(s) (e.g., mirrors and/or mirror mounts of the galvanometric scanner). The heating may result in degraded performance, e.g., a drift in the frequency response of galvanometric scanner. Drift may occur in-situ and in real time during a 3D printing process. Drift in a frequency response can result in a drift in expected location of an energy beam along an optical path. A drift in the frequency response of the galvanometric scanner can be from about 1 Hz/deg ° C. to about 5 Hz/deg ° C., from about 1.7 Hz/deg ° C. to about 3 Hz/deg ° C., or from about 1.5 Hz/deg ° C. to about 2.5 Hz/deg ° C. A drift in the frequency response of the galvanometric scanner can be at least about 1 Hz/deg ° C., 1.5 Hz/deg ° C., 1.7 Hz/deg ° C., 3 Hz/deg ° C., 5 Hz/deg ° C., or above. A drift in the frequency response of the galvanometric scanner can be at most about 4 Hz/deg ° C., 3 Hz/deg ° C., 1.7 Hz/deg ° C., 1.6 Hz/deg ° C., 1.3 Hz/deg ° C., or lower. In some embodiments, a threshold frequency drift at most about 300 Hertz (Hz), 200 Hz, 100 Hz, 75 Hz, 50 Hz, or 25 Hz, in the frequency response of the optical assembly. For example, a threshold drift in the frequency response of the galvanometric scanner can be at most about 4 Hz/deg ° C., 3 Hz/deg ° C., 1.7 Hz/deg ° C., 1.6 Hz/deg ° C., 1.3 Hz/deg ° C., or lower. For example, a threshold drift in the frequency response of the galvanometric scanner can be from about 1 Hz/deg ° C. to about 5 Hz/deg ° C., from about 1.7 Hz/deg ° C. to about 3 Hz/deg ° C., or from about 1.5 Hz/deg ° C. to about 2.5 Hz/deg ° C. To reduce thermal effects of stray radiation, e.g., reduce thermal heating, integrated measures can be implemented. The integrated measures can be implemented to reduce thermal heating from about 10° C. to about 60° C., from about 25° C. to about 50° C., from about 30° C. to about 80° C., or from about 30° C. to about 50° C. For example, integrated measures can be implemented to reduce thermal heating by at least about 20° C., 30° C., 40° C., 50° C., 80° C., or more. For example, integrated temperature conditioning can be utilized to adjust the temperature of one or more optical components. The temperature conditioning can comprise cooling. Adjusting the temperature of the one or more optical components can comprise reducing their thermal heating. For example, guards can be utilized to shield (e.g., block a portion of) an optical element(s) from stray radiation to prevent any blocked radiation from heating the optical element(s). For example, integrated temperature conditioning (e.g., cooling) components with the guards can reduce thermal heating of the optical components that have been heated.

In some embodiments, the optical enclosure is coupled with (e.g., to) the gas flow mechanism that is coupled with (e.g., to) the processing chamber. In some embodiments, the optical enclosure is coupled with (e.g., to) a gas flow assembly that is not coupled with (e.g., to) the processing chamber. The gas flow assembly may service the optical enclosure rather than other components of the 3D printing system. For example, the gas flow assembly may be dedicated to the optical enclosure.

In some embodiments, gas flow of at least about 0.5 psi, can be directed through the optical enclosure. For example, gas flow may be at least about 0.5 pounds/inch² (psi), 1 psi, 2 psi, 3 psi, 4 psi, 5 psi, 6 psi, 7 psi, 8 psi, 9 psi, or 10 psi, above the ambient pressure of gas flow. The gas flow may be any value between the afore-mentioned values, for example, from about 0.5 psi to about 10 psi, or from about 0.5 psi to about 5 psi. The gas flow into the optical enclosure may or may not have a gas composition (e.g., makeup) of the ambient atmosphere external to the optical enclosure. The gas in the optical enclosure may or may not have a gas makeup of the internal atmosphere of the processing chamber. Gas in the internal atmosphere of the processing chamber may include clean dry air (CDA), filtered air, argon, nitrogen, and/or another inert gas. Gas in the optical enclosure may include clean dry air (CDA), filtered air, argon, nitrogen, and/or another inert gas. In some embodiments, a filtration system filters out at least some of the solid (e.g., debris) and/or gaseous contaminants from a gas flow, e.g., at an inlet into the optical enclosure and/or at an outlet from the optical enclosure. The filtration system may filter gas flow into the optical enclosure providing a clean gas (e.g., cleaner than gas flow outside of the optical path environment). The filtration system may filter gas flow out of the optical enclosure, e.g., removing contaminants that may be present in the gas flow within the optical enclosure. The filtration system can include one or more filters. The filters may comprise oil filters, particulate filters (e.g., HEPA filters, 0.1 micron particulate filter, or the like), humidity filters or chemical filters (e.g., column). The particulate filter may comprise high efficiency particulate air (HEPA) filters, particulate filter configured to filter particles having a FLS of at least about 0.1 microns or larger, or the like.

In some embodiments, the optical enclosure is coupled with (e.g., to) a cooling system. The cooling system may comprise a coolant. The coolant can be a gas, a liquid, or a semisolid (e.g., gel). In some examples, the cooling system comprises water-based cooling, gas-based cooling, or a combination thereof. Cooling system for the optical enclosure may be coupled with (e.g., to) a gas flow mechanism. Cooling system may be a gas flow assembly or include a gas flow assembly. Cooling system can be utilized to reduce a thermal load on one or more optical components of the optical enclosure, e.g., through heat exchange between a gas or water running adjacent and/or in contact with the one or more optical components. For example, optical system 1366 can include an inlet(s) 1382 to couple the optical system 1366 to a temperature conditioning (e.g., cooling) system, e.g., to a gas flow assembly.

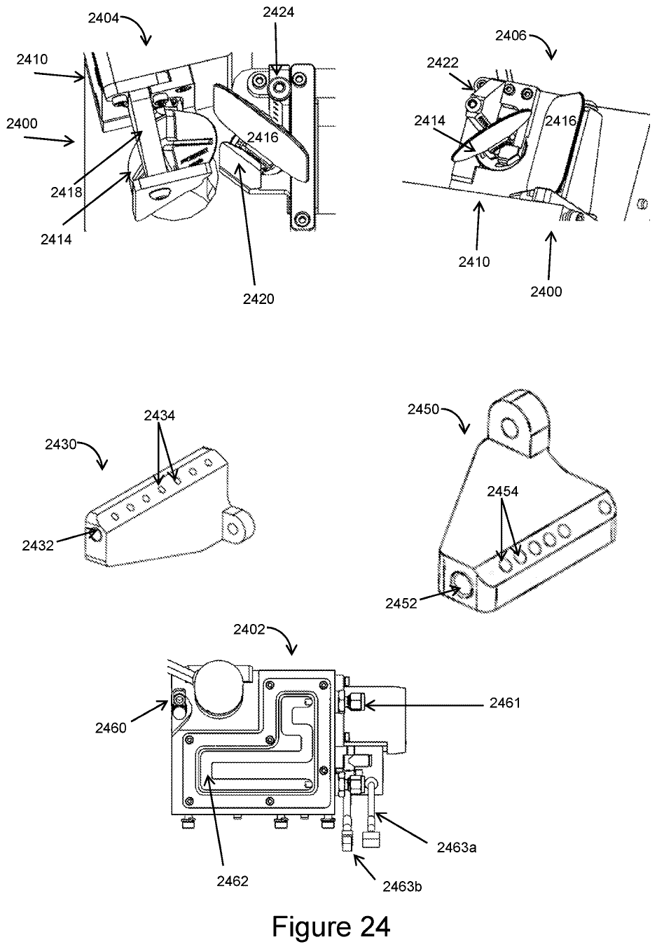

FIG. 13 depicts a schematic view 1330 example of a modular optical unit 1332, e.g., modular optical unit 1300. Modular optical unit 1332 comprises a cooling system 1334. Cooling system 1334 comprises coolant lines for directing coolant flow within the modular optical unit 1332. For example, coolant lines may be configured to distribute a coolant flow from an inlet of the cooling system 1334 to one or more components of the optical assembly. Cooling system 1334 can include water cooling and/or gas flow, e.g., to reduce a thermal load on one or more components of the optical assembly. Cooling system 1334 can provide water cooling to a collimator 1336 and/or to portions of the scanner 1338, e.g., the actuators of the scanner. The cooling system 1334 can be configured to provide gas flow within the optical housing 1302. Cooling system 1334 can include a gas flow assembly, e.g., as described with reference to FIG. 24. The cooling system 1334 can provide a positive pressure (e.g., about 1 atmosphere or greater than 1 atmosphere) within the optical housing 1302. For example, cooling system 1334 can provide gas flow to one or more optical components, e.g., scanner 1338, of the optical assembly and/or provide a gas flow within one or more enclosure channels 1342 of the modular optical unit 1332.

In some embodiments, gas-based cooling is utilized to reduce thermal heating. Gas flow can be directed through the optical enclosure, such as via a gas flow assembly, towards one or more of the optical elements to reduce a thermal heating of the optical elements. The gas may comprise clean dry air (CDA), nitrogen, argon, an inert gas, or the like. Gas flow may be vented out of the optical enclosure. A maximum gas flow for gas-based cooling of optical elements may be selected based at least in part on effects of gas flow compromising performance of the optical elements. A gas flow exceeding a maximum gas flow may induce vibration in optical element(s).

At times, a flow of gas-based temperature conditioning, such as cooling, is utilized in maintaining a standard operation of the optical elements for their intended purpose. In some embodiments, the intended purpose of the optical elements is to direct translation of the energy beam(s) along a target surface in a way that does not (e.g., measurably and/or substantially) deviate from a predetermined path. For such purpose, the gas should not exceed a threshold velocity and/or acceleration as it impinges on the optical element(s). At times, the maximum gas flow is insufficient to condition the temperature (e.g., cool) the optical elements such that the optical elements maintain its standard (e.g., and prescribed) operation. For example, utilizing a maximum gas flow impinging on the optical element(s) may not result in a threshold temperature reduction (e.g., due to thermal heating) for a given time span. For example, utilizing a gas flow that impinges on the optical element(s) may result in a threshold temperature reduction (e.g., due to thermal heating) for a given time span, but such gas flow may exceed the maximum threshold velocity and/or acceleration that may in turn result in a detectable deviation from the path of the energy beam impinging on the optical element(s). Such path deviation may result in defective 3D object(s).

In some embodiments, the optical assembly comprises one or more guards such as radiation guards. The one or more guards can be arranged with respect to the optical assembly, e.g., to reduce the stray radiation incident on the exposed portions of the optical assembly. For example, the one or more guards may be arranged with respect to the scanner and/or optical elements. For example, guards can be arranged with respect to mirrors and/or mirror mounts of the scanner. A profile of a guard can be selected to minimize shielding of the beam path of the energy beam. A guard can shield from direct stray radiation and/or of from shadow effect of the stray radiation upon the optical element(s). The guards may be (i) machined, (ii) casted, (iii) 3D printed, or (iv) any combination thereof. The guards may include a material comprising elemental metal or metal alloy. The guards may comprise a material that is highly reflective such as a material inducing specular reflectivity. The material may reflect at least about 80 percent (%), 90%, 95%, 97%, 98%, or 99% of the radiation impinging upon it. The guards may be formed from, for example, aluminum, black anodized aluminum, chromium, platinum, gold, or any other suitable material. The material may be deposited (e.g., plated) on a surface of the guard. The guard may be affixed within the optical assembly, e.g., to an optical element mount. The guard may be affixed within the optical assembly with mounting hardware. The guard may be arranged with respect to the optical element to shield a respective portion of the optical element from the stray radiation. The optical elements may comprise mirror(s), mirror mount(s), lens, prism(s), collimator, beam splitter, or the like. A plurality of guards may be implemented in an optical system (e.g., within an optical assembly). For example, a guard may shield a portion of the back of a mirror of a scanner. For example, a guard may shield a portion of a mirror mount of a scanner from direct and indirect reflection. For example, a guard may shield a portion of a Y mirror and/or an X mount of a scanner. Materials and/or coatings of guards can be selected, for example, based at least in part on a threshold reflectivity of the material and/or coating. For example, gold-plating may be used on mirror mounts and/or guards to obtain a threshold reflectivity, e.g., having a reflectivity value as delineated above. For example, a diffuse coating may be used on mirror mounts and/or guards.

In some embodiments, the optical elements of the optical assembly have a (e.g., substantially) stable positioning. The (e.g., substantially) stable positioning includes having (e.g., substantially) the same position across a temperature range and/or vibration, e.g., as disclosed herein. Mounting hardware, e.g., hardware for mounting mirror to mirror mounts, mirror mounts to the optical enclosure, guards to the optical assembly, or the like, can be selected to have a minimum torque specification. For example, a minimum torque value of at least about 0.5 Newton*meter (Nm), 1 Nm, 1.5 Nm, 2.0 Nm, 2.5 Nm, 4.0 Nm, 5.0 Nm, or 10.0 Nm. The torque specification may be between the aforementioned torque values, for example, from about 0.95 Nm to about 1.5 Nm, from about 1.5 Nm to about 2.5 Nm, from about 0.5 Nm to about 10.0 Nm, or the like. For example, hardware may be configured to withstand a torque of the minimum torque value. Hardware of the optical assembly can be configured to have a major diameter from at least about 2 mm to about 5 mm. Hardware can be configured to have a major diameter of at least about 2 mm, 3 mm, 4 mm, or more. For example, 2 mm diameter hardware (e.g., M2 hardware), 3 mm diameter hardware (e.g., M3 hardware), 4 mm diameter hardware (e.g., M4 hardware), or the like. The hardware (e.g., nuts) may include a material comprising elemental metal or metal alloy. For example, the hardware may include a material comprising titanium, stainless steel, or Inconel. For example, hardware may be configured to operate for its intended purpose at a temperature of at least about. 70° C., 75° C., 80° C., 85° C., 90° C., 100° C., 110° C., 120° C., 130° C., 140° C., or 150° C. For example, hardware may be configured to operate for its intended purpose at temperature variation (e.g., delta) of at least about 40° C., 50° C., 100° C., 150° C., 200° C., or 250° C. The temperature variation can be of any variation value between the aforementioned valuations (e.g., from about 50° C. to about 250° C.). An adhesive for mounting mirror to mirror mount can be select to have an associated melting temperature or a glass transition temperature of at least about 100° C., 110° C., 120° C., 130° C., 140° C., 150° C., or 160° C. For example, the adhesive may comprise a resin or a polymer. For example, the adhesive may comprise epoxy. One or more guards can be arranged with respect to optical elements of the optical housing, e.g., to shield the respective optical elements from stray radiation. A guard may be arranged with respect to a path of the one or more energy beams, e.g., a main path of the energy beam traversing in the optical housing. The energy beam may be directed to impinge on an optical element (e.g., mirror) at a target location. The guard may be configured to minimize shadowing of the guard on the target location, e.g., to allow undisturbed interaction between the energy beam and the target location of the optical element. One or more of the guards may comprise a basic geometric shape. One or more of the guards may comprise a shape that is a composition, e.g., combination or superposition, of basic geometric shapes. Basic geometric shapes may include polygons and/or ellipsoids. Basic geometric shapes may comprise a circle, oval, triangle, square, rectangle, trapezoid, pentagon, hexagon, or an octagon. Basic geometric shapes may include elongated polygons or ellipsoids, e.g., a slotted shape. At least two of the guards implemented in an optical assembly may each have a different shape. At least two of the guards implemented in an optical assembly may have the same shape.

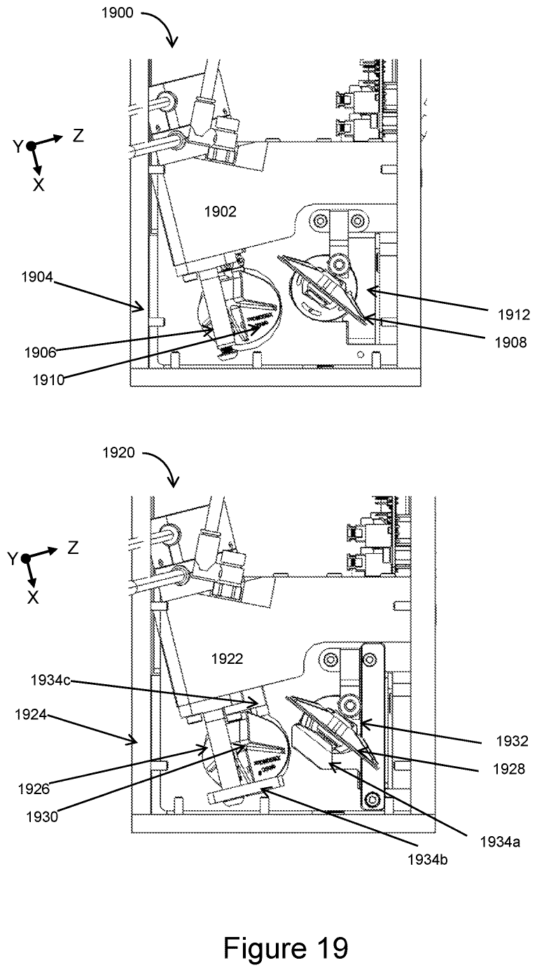

FIG. 19 shows an example of optical assembly 1900 including a galvanometric scanner 1902. A partial top view is shown of the optical assembly 1900 enclosed by a portion of an optical enclosure portion 1904. As depicted in FIG. 19, the galvanometric scanner 1902 is a two-axis scanner and includes (A) a first mirror 1906, e.g., an X mirror, and (B) a second mirror 1908, e.g., a Y mirror. X and Y are axes in a Cartesian coordinate system depicted in FIG. 19. The first mirror 1906 is affixed by mirror mount 1910; and the second mirror 1908 is affixed by mirror mount 1912. Mirror mounts 1910, 1912 are affixed with respect to the galvanometric scanner 1902 of the optical assembly 1900. First mirror 1906 and/or the second mirrors 1908 are adjustable about the respective axes (e.g., about an X-axis, or about a Y-axis respectively), such that an energy beam incident on the mirrors can be deflected about the respective axes.

FIG. 19 shows an example of optical assembly 1920 that includes a galvanometric scanner 1922 enclosed by optical enclosure portion 1924, where a portion of the optical elements of the galvanometric scanner are shielded by guards 1934a, 1934b, and 1934c. As depicted, the galvanometric scanner 1922 is a two-axis scanner and includes a first mirror 1926 and second mirror 1928. The first mirror 1926 is affixed with respect to the optical assembly 1920 by mirror mount 1930. The second mirror 1928 is affixed with respect to the optical assembly 1920 by mirror mount 1932. Guards 1934a, 1934b, and 1934c are each arranged with respect to the mirrors 1926, 1928 and mirror mounts 1930, 1932 such that each guard 1934a-c shields a portion of a mirror and/or mirror mount, e.g., from stray radiation.

In some embodiments, the optical assembly has two optical elements of the same type. The optical elements may comprise any optical element, e.g., as disclosed herein. For example, the optical assembly may comprise two mirrors, two mirror mounts, or two lenses. At least two of the optical elements of the same type may be different from each other, such as in a different shape, comprising a different material, and/or having a different FLS. At least two of the optical elements of the same type may be (e.g., substantially) the same, such as of the same shape, comprising the same material, and/or having the same FLS. For example, at least two of the mirrors of the optical assembly may have different shapes. For example, at least two of the mirrors of the optical assembly can have (e.g., substantially) the same shape.

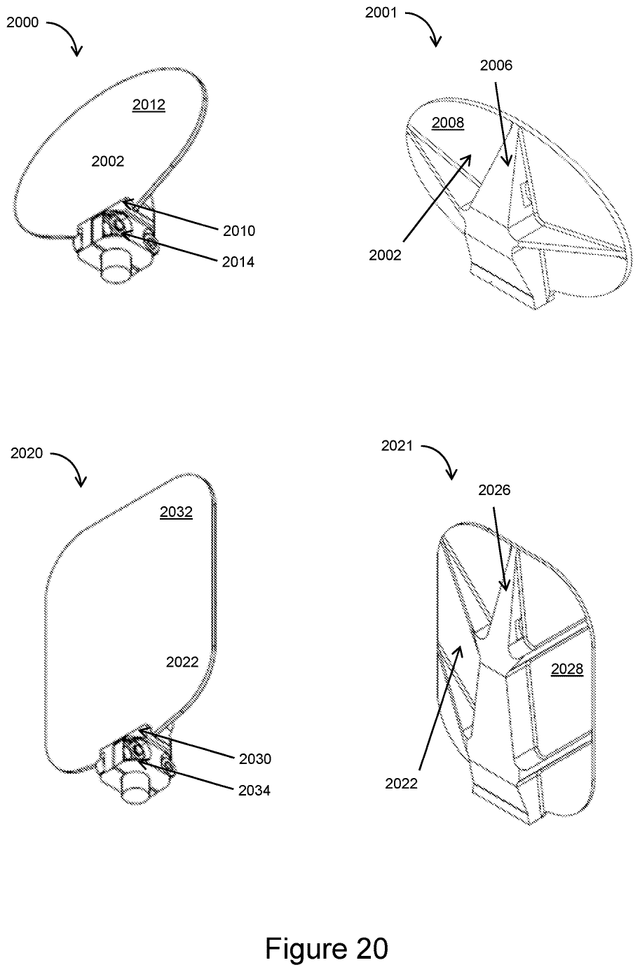

FIG. 20 depicts views 2000, 2001 of an example mirror 2002 that is a circular mirror. Mirror 2002 can be a component of a scanner, e.g., galvanometric scanner 1902. Mirror 2002 can be, for example, an X mirror of a galvanometric scanner, e.g., first mirror 1926. As depicted in view 2001 of mirror 2002, the mirror 2002 is affixed to a mirror mount 2014, e.g., by an adhesive. In some embodiments, an adhesive used to affix mirror 2002 to mirror mount 2014. Mirror mount 2014 include arms 2006 affixed to a back surface 2008 of mirror 2002, e.g., using adhesive. Mirror mount 2014 includes a lip 2010 supportive of a portion of a front surface 2012 of mirror 2002. Mirror mount 2014 includes additional hardware for mounting mirror 2002 to the optical assembly, e.g., to an actuator in a scanner.

FIG. 20 depicts views 2020, 2021 of an example mirror 2022 that is a rectangular mirror having curved edges. Mirror 2022 can be a component of a scanner, e.g., galvanometric scanner 1902. Mirror 2022 can be, for example, a Y mirror of a galvanometric scanner, e.g., second mirror 1928. As depicted in view 2021 of mirror 2022, the mirror 2022 is affixed to a mirror mount 2034, e.g., by an adhesive. In some embodiments, an adhesive used to affix mirror 2022 to mirror mount 2034. Mirror mount 2034 include arms 2026 affixed to a back surface 2028 of mirror 2022, e.g., using adhesive. Mirror mount 2034 includes a lip 2030 supportive of a portion of a front surface 2032 of mirror 2022. Mirror mount 2034 includes additional hardware for mounting mirror 2022 to the optical assembly, e.g., to an actuator in a scanner.

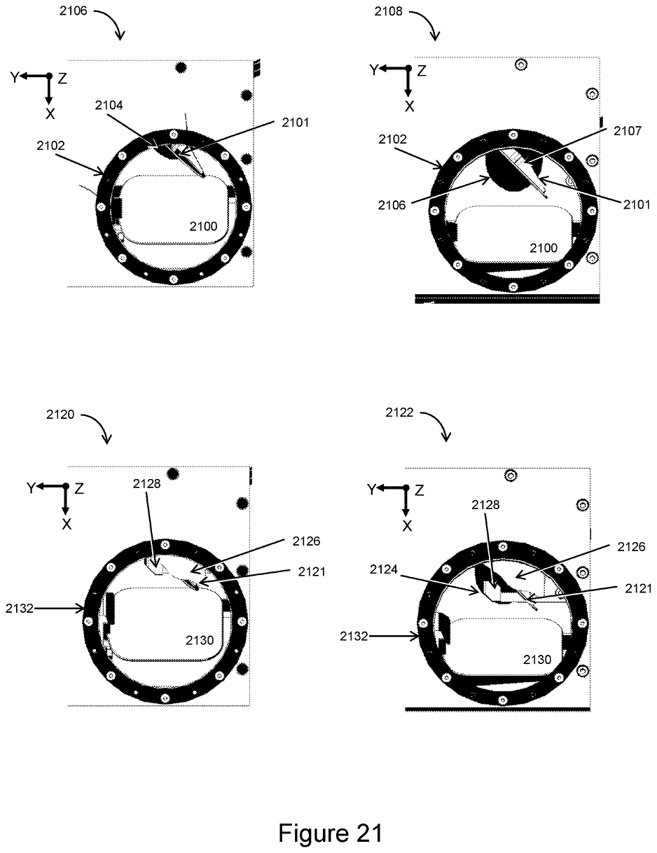

At times, stray radiation is reflected off an exposed surface in the processing chamber, e.g., from an exposes surface of the material bed, and can be incident on an optical window and/or optical element(s) located adjacent to the optical window with line-of-sight of the optical window. Stray radiation can reflect off of the exposed surface in the processing chamber at a range of angles such that reflected radiation can be incident on the optical window and optical element(s) located adjacent to the optical window (e.g., FIG. 21, 2102) with line-of-sight of the optical window for a range of incident angles. Stray radiation incident on optical element(s) may result in thermal heating of the optical elements. At times, thermal heating of optical elements may result in degradation of the standard operation of the optical elements and further, degradation of the reliability of the 3D printing system to print the requested 3D object(s).

FIG. 21 depicts examples of various schematic views of optical elements of an optical assembly as viewed through an optical window disposed between a processing chamber and an optical system, e.g., rectangular mirrors 2100, 2101. For example, mirror 2100 can be a component of a scanner, e.g., a galvanometric scanner similar to 1902 of FIG. 19, having a shape of mirror 2022 of FIG. 20. Mirror 2100 can be, for example, a Y mirror of a galvanometric scanner, e.g., similar to mirror 1928 of FIG. 19, having a shape of mirror 2022 of FIG. 20. For example, mirror 2101 can be, for example, an X mirror of a galvanometric scanner, e.g., similar to mirror 1926 of FIG. 19, having a shape of mirror 2002 of FIG. 20. Optical window 2102 can be, for example, an optical window located between a processing chamber and an optical enclosure of an optical system. At times, e.g., during operation of a 3D printing system, stray radiation is reflected off an exposed surface in the processing chamber, e.g., from a material bed, and can be incident on optical window 2102 and optical elements located adjacent to the optical window 2102 with line-of-sight of the optical window 2102. Stray radiation can reflect off the exposed surface in the processing chamber at a range of angles such that reflected radiation can be incident on the optical window 2102 and optical elements located adjacent to the optical window 2102 with line-of-sight of the optical window 2102 for a range of incident angles. For example, as depicted in view 2106, stray radiation with normal incidence along the Z-axis on the optical window 2102 can be incident on mirror 2100 and a portion of mirror 2101 and/or a portion of mirror mount 2104. For example, as depicted view 2108, stray radiation with about a 15° angle of incidence with respect to the Z-axis on the optical window 2102 can be incident on mirror 2100 and a portion of mirror 2101 and/or a portion of mirror mount 2104. Stray radiation incident on the mirror 2101 can generate thermal heating of i) the mirror 2101, ii) mirror mount 2104, or iii) a combination thereof.

FIG. 21 depicts examples of guards 2126, 2128 arranged with respect to mirror 2121 and mirror mount 2124. Guards 2126, 2128 are configured to shield portions of mirror 2121 and/or mirror mount 2124 from stray radiation that is incident on optical window 2130. For example, as depicted in view 2120, guards 2126 and 2128 can shield portions of mirror 2121 and mirror mount 2124 from stray radiation with normal incidence along the Z-axis on the optical window 2132. For example, as depicted in view 2122, guards 2126 and 2128 can shield portions of mirror 2121 and mirror mount 2124 from stray radiation with about a 15° angle of incidence with respect to the Z-axis on the optical window 2132.

At times, one or more guard(s) arranged to shield optical component(s) from stray radiation are configured to minimize shadowing due to the guard(s) on a target location of the optical element to allow undisturbed interaction between the energy beam and the target location of the optical element. For example, a configuration of a guard with respect to the energy beam can include (i) selecting a shape of a guard, (ii) selected a position of a guard with respect to the optical components, (iii) selecting a position of a guard with respect to the energy beam, or (iv) any combination of two or more of (i)-(iii).

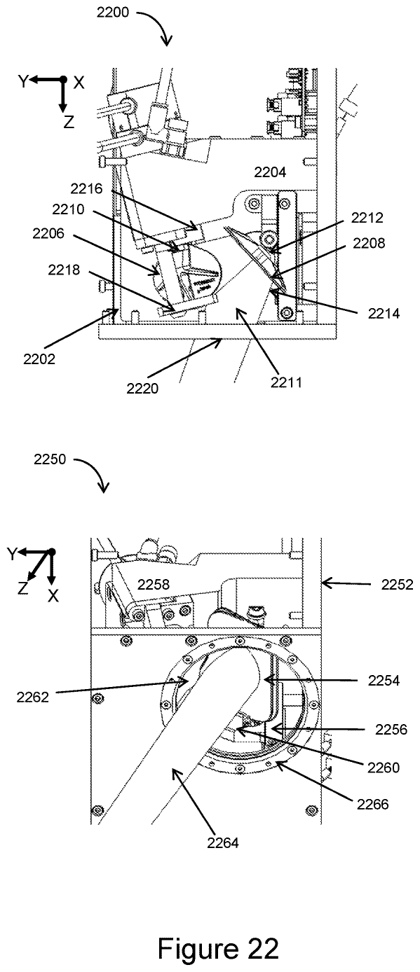

FIG. 22 depicts example schematic views of a portion of an optical assembly of a galvanometric scanner. A partial top view is shown of the optical assembly 2200 enclosed by a portion of an optical enclosure 2202. As depicted in FIG. 22, the galvanometric scanner 2204 is a two-axis scanner and includes (A) a first mirror 2206, e.g., an X mirror, and (B) a second mirror 2208, e.g., a Y mirror. X and Y are axes in a Cartesian coordinate system. The first mirror 2206 is affixed by mirror mount 2210; and the second mirror 2208 is affixed by mirror mount 2212. Mirror mounts 2210, 2212 can be affixed with respect to the galvanometric scanner 2204 of the optical assembly 2200. First mirror 2206 and/or the second mirrors 2208 are adjustable about the respective axes (e.g., about an X-axis, or about a Y-axis), such that an energy beam 2211 incident on the mirrors can be deflected about the respective axes. Energy beam 2211 incident on the mirrors can be deflected through an opening 2220 of the optical enclosure 2202 and incident on an optical window of a processing chamber. The energy beam can be directed by the galvanometer scanner to trace a path an exposed surface (e.g., of a material bed) disposed in the processing chamber. Guards 2214, 2216, and 2218 are each arranged with respect to the mirrors 2206, 2208 and mirror mounts 2210, 2212 such that each guard 2214, 2216, and 2218 shields a portion of a mirror and/or mirror mount, e.g., from stray radiation. For example, stray radiation can include indirect reflection of radiation from a surface of an optical element of the optical assembly, e.g., from mirror 2208 onto mirror 2206 and/or mirror mount 2210. For example, stray radiation can include direct reflect from an exposed surface disposed in the processing chamber.

As depicted in the examples shown in FIG. 22, guard 2218 is arranged to shield a portion of the back of mirror 2206, e.g., of an X mirror of the scanner 2204 from direct and indirect reflection(s). Guard 2216 is arranged to shield a portion of mirror mount 2210, e.g., of an X mirror mount of the scanner 2204 from direct and indirect reflection(s). Guard 2214 is arranged to shield a portion of mirror mount 2212, e.g., a Y mirror mount of the scanner 2204 from direct and indirect reflection(s). Guards 2214, 2216, and 2218 are arranged with respect to mirrors 2206, 2208, mirror mounts 2210, 2212 to reduce an amount of stray radiation incident on the optical elements. Guards 2214, 2216 are arranged with respect to energy beam 2211 to reduce effects of shadowing (e.g., attenuation) of the energy beam 2211 that is incident on mirrors 2206, 2208, e.g., along an optical path.

FIG. 22 depicts a partial view of optical assembly 2250 enclosed by a portion of an optical enclosure 2252. A first mirror 2254 and mirror mount (with guard) 2256 of a galvanometric scanner 2258 is partially shielded from stray radiation by a guard 2260. A guard 2262 is arranged within the optical enclosure 2252 to shield a mirror and mirror mount (not depicted), e.g., mirror 2206 and mirror mount 2210, from stray radiation generated from indirect and/or direct reflections. Guards 2260 and 2262 are arranged with respect to an energy beam 2264 to minimize an amount of shadowing (e.g., attenuation) of the energy beam 2264 as it is deflected by optical components through optical window 2266 and into a processing chamber. For example, guards 2260 and 2262 are arranged to minimize a shadow effect on active portions of mirrors of the scanner 2258 (e.g., portions of the mirror used to direct the energy beam 2264).

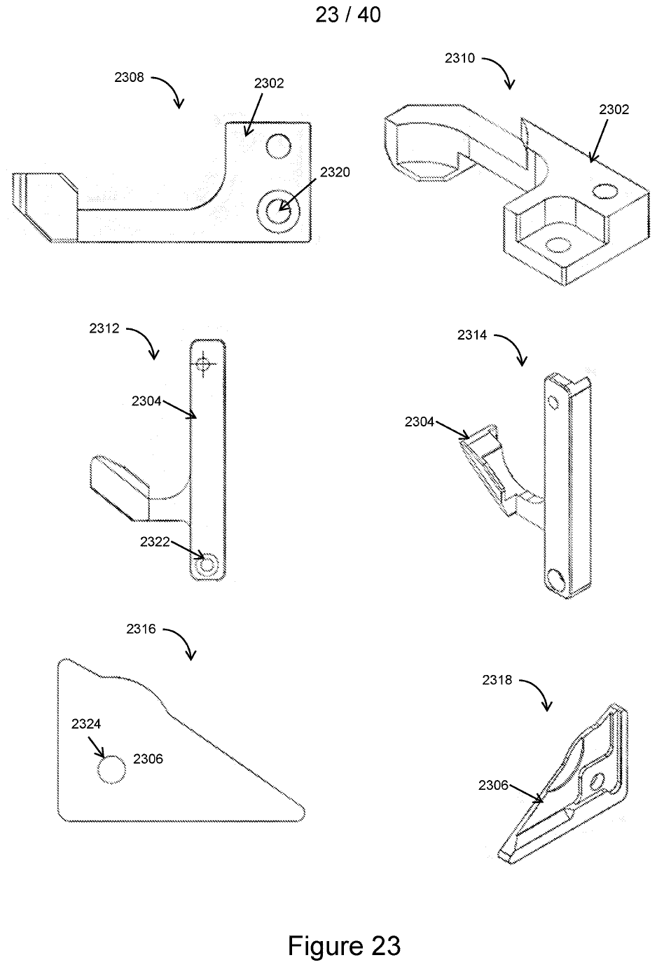

FIG. 23 depicts schematic examples of guards for use in an optical assembly, e.g., of a 3D printing system. As depicted, each of guards 2302, 2304, and 2306 has a different shape from each other guard. Views 2308, 2310 depict two orientations of guard 2302. Views 2312, 2314 depict two orientations of guard 2304. Views 2316, 2318 depict two orientations of guard 2306. A shape of guard 2302 can be selected from a combination (e.g., superposition) of basic geometric shapes, e.g., ellipsoids and/or polygons. A shape of guard 2304 can be selected from a combination of basic geometric shapes, e.g., ellipsoids and/or polygons. A shape of guard 2306 can be selected from a combination of basic geometric shapes, e.g., ellipsoids and/or polygons. An FLS of guards 2302, 2304, and 2306 can be at least about 1 mm, 2 mm, 2.5 mm, or 5 mm. An FLS of guards 2302, 2304, and 2306 can be at most about 50 mm, 100 mm or 150 mm. An FLS of guards 2302, 2304, and 2306 can range, for example, between 1 mm and 150 mm. Guards 2302, 2304, and 2306 can include mounting locations 2320, 2322, 2324, e.g., slots and/or holes for mounting the guards within an optical assembly. Dimensions of the mounting locations can be selected based in part on dimensions of the mounting hardware used to affix the guards within the optical enclosure.

In some embodiments, a gas flow assembly is configured to direct a flow of gas (e.g., a positive pressure of gas) into a region including the optical assembly, e.g., within an optical enclosure. The positive pressure can be above ambient pressure external to the optical enclosure. The optical enclosure may be referred herein as a housing of one or more optical elements. The optical assembly may be configured to (e.g., dynamically) direct a path of an energy beam. The dynamic direction may be controlled, e.g., by at least one controller. The at least one controller can be configured to control an energy source generating the energy beam. The at least one controller can be part of a control system of the 3D printing system configured to control at least one other components of the 3D printing system such as the gas flow mechanism. At times, gas in the optical enclosure is directed into channel(s). The channel(s) may enclose at least a portion of an optical path of an energy beam (e.g., laser beam) propagating in the optical enclosure. The optical enclosure and/or channels may be configured to facilitate minimum dispersion of the energy beam, e.g., due to gas borne debris. Examples of an optical enclosures, optical channels, optical elements, associated control systems, usage in three-dimensional printing, and three-dimensional printing systems, can be found in International Patent Application Serial No. PCT/US18/12250, filed Jan. 3, 2018 that is incorporated herein by reference in its entirety. The optical assembly may include one or more optical elements (e.g., a scanner). The gas flow assembly may be configured receive a gas flow through an inlet and to direct a flow of gas into a region including one or more optical elements. In some embodiments, the gas flow assembly is separate from the gas flow mechanism flowing gas into the processing chamber. For example, the gas flow assembly can flow a different type of gas makeup than the gas flow mechanism. In some embodiments, the gas flow assembly is integrated in the gas flow mechanism. For example, the gas flow assembly can flow the same type of gas makeup than the gas flow mechanism. The gas flow assembly may be configured to direct a flow of gas through the optical assembly and incident onto a surface of one or more optical elements via apertures. The aperture may comprise a hole, an opening, or a gap. The gas flow assembly may include one or more apertures configured to direct the flow of gas as it exits the gas flow assembly into the region including the optical assembly. For example, the apertures may include an arrangement of holes, perforations, slots, slits, and/or other regular or irregular shapes, that are located in a region including the optical assembly and configured to direct the flow of gas. The apertures of the gas flow assembly may be arranged with respect to the optical assembly to direct a flow of gas incident on a portion of the optical assembly. For example, the apertures of the gas flow assembly may be arranged to direct a flow of gas incident on a portion of an optical element, e.g., onto at least a portion of at least one mirror e.g., onto a portion of a mirror. At times, portions of the optical assembly may be exposed to stray radiation. Stray radiation can lead to thermal heating of the optical assembly. A flow of gas from the gas flow assembly into a region including the optical assembly can reduce an amount of thermal heating of a portion of the optical assembly, e.g., reduce an amount of the thermal heating due to stray radiation. For example, the flow of gas from the gas flow assembly incident on an optical element can reduce a temperature of a portion of the optical element by a threshold amount, e.g., reduce a temperature of a mirror by a threshold amount. The gas in the flow of gas may be temperature adjusted. For example, the gas may be cooled prior to its flow onto the optical element.

In some embodiments, a gas flow assembly may define an interior cavity through which gas (e.g., at positive pressure) flows. The positive pressure may be controlled (e.g., manually and/or automatically). The gas flow assembly can include an interior cavity configured to direct gas through the interior cavity toward a plurality of apertures disposed adjacent to optical elements, e.g., optical elements of an optical assembly. The gas flow assembly may be, or may include, a gas directing component. A portion of the interior cavity of the gas flow assembly may be defined within optical elements, e.g., within a portion of a mirror mount. The manifold may comprise a plurality of apertures disposed adjacent to optical elements. A number of apertures can include, for example, at least 1, 2, 5, 10, or 15 apertures. The aperture(s) may be disposed facing towards, e.g., having line of sight of, a surface of the optical element(s). For example, the aperture(s) may be disposed facing towards a non-active surface of an optical element. For example, the aperture(s) facing towards a non-reflective surface (e.g., a backside) of a mirror. The aperture(s) may be disposed facing towards a plurality of optical elements. The aperture(s) may be disposed such that a flow of gas existing the aperture(s) is incident on a surface of one or more optical elements. For example, at least two of the aperture(s) may be configured such that a flow of gas existing the aperture(s) is incident on the same optical element. For example, at least two of the aperture(s) may be configured such that a flow of gas existing the aperture(s) is incident different optical elements (e.g., respectively). For example, each optical element of a plurality of optical element has an aperture disposed facing toward the respective optical element. The optical elements may comprise a mirror, a mirror mount, a lens, a beam splitter, a collimator, or a prism. The aperture(s) may be disposed facing towards a portion of a scanner, e.g., such that a flow of gas existing the aperture(s) is incident on a surface of at least one component of the scanner. The scanner may comprise an actuator, or a mirror. The actuator may comprise a motor (e.g., servomotor). Facing towards an optical element may enable directing a gas flow towards the optical element. The gas flow may impinge on the optical element at an angle between the direction of gas flow and the optical element at the impingement location. The angle may be an obtuse angle, a right angle, or an acute angle. The angle may be at most about 170°, 150°, 120°, 90°, 60°, 30°, or 10°. The angle may be any angle between the aforementioned angles (e.g., from about 170° to about 10°, from about 170° to about 60°, or from about 120° to about) 10°. The gas flow may be (e.g., substantially) parallel to a surface of the optical element at the impingement location. In some embodiments, facing towards an optical element includes enabling a gas flow directed towards the optical element at (e.g., substantially) a right angle between the gas flow and the surface of the optical element at the impingement location. A portion of the interior cavity of the gas flow assembly may be defined within a portion of an optical element such that one or more apertures are disposed on a surface of an optical element, e.g., apertures connected to the gas flow assembly and located on a mirror mount. Apertures in the manifold may be uniform in shape. Apertures in the manifold may be periodically spaced. Apertures in the manifold may be non-uniform in shape. Apertures in the manifold may be randomly spaced. The apertures may have an elliptical cross section (e.g., a circle or oval), a polygonal cross section, or an irregular cross section. The apertures may be slits, slots, or another elongated shape. The apertures may include a combination of cross-sectional shapes, e.g., at least one elliptical and at least one polygonal cross-section shape. The apertures may be grouped. For example, a gas flow assembly can have a group of apertures. Apertures in a group may be arranged, e.g., in a single file or in a lattice arrangement including rows and columns. Dimensions of the apertures may have FLS of at least about 2 mm. For example, apertures may have FLS of at least about 2 mm, 3 mm, 4 mm, 5 mm, or 10 mm. The manifold may include an inlet to receive a gas flow into the interior cavity. The manifold be configured to deliver the gas to a plurality of gas flow component having respective apertures. The manifold may be configured to direct gas flow toward a respective optical element via a plurality of apertures disposed adjacent to the optical element. Gas flow of at least about 0.5 psi, can be directed through the apertures of the manifold toward an optical element. For example, gas flow may be at least about 0.5 pounds/inch² (psi), 1 psi, 2 psi, 3 psi, 4 psi, 5 psi, 6 psi, 7 psi, 8 psi, 9 psi, or 10 psi above the ambient pressure of gas flow. The gas flow may be any value between the afore-mentioned values, for example, from about 0.5 psi to about 10 psi, or from about 0.5 psi to about 5 psi. The gas in the optical enclosure may or may not have a gas composition (e.g., makeup) of the ambient atmosphere external to the enclosure. The gas in the optical enclosure may or may not have a gas makeup of the internal atmosphere of the processing chamber. Gas in the optical enclosure may include clean dry air (CDA), filtered air, argon, nitrogen, and/or another inert gas. A flow rate and/or temperature of the gas flow may be selected to reduce a thermal heating of the optical element by a threshold amount. For example, a flow can be directed through the apertures of the manifold to reduce a temperature of a portion of the optical element by at least about 25° C. For example, reduce a temperature of the optical element by at least about 5 degrees Celsius (° C.), 10° C., or 30° C. For example, reduce a temperature of the optical element by between about 5° C. to 50° C. For example, reduce a temperature of the optical element by at least about 30° C. For example, reduce a temperature of the optical element by at least about 25° C., 50° C., or 75° C. A flow rate of the gas flow may be selected to minimize disturbance of the optical element in response to the incident gas upon the optical element, e.g., to minimize vibration of a mirror due to gas flow incident on the mirror. The gas flow may be such that it (e.g., substantially and/or measurably) retains the stability of the optical element towards which it is directed. Disturbing the stability of the optical element may comprise vibrating, moving, or shifting the optical element. The gas flow may be such that it does not (e.g., measurably) disturb the stability of the energy beam interacting with the optical element towards which that gas flow is directed. The gas flowing onto an optical element may be temperature conditioned. For example, the gas may be cooled. The gas may contact during its flow a temperature conditioned surface. For example, the gas may contact a surface of cooling pipes through which a coolant flows (e.g., water or another cooling liquid). The coolant may comprise liquid or semi-solid (e.g., gel). The surface may comprise a heatsink. The surface may comprise a heat conductive material (e.g., copper or silver). The heat conductive material may comprise an elemental metal or a metal alloy, e.g., as disclosed herein. One or more optical elements may be directly temperature conditioned by the coolant. The one or more optical elements may comprise a collimator and an actuator (e.g., a motor). The motor may be operatively coupled with (e.g., to) a mirror, e.g., of a scanner.

FIG. 24 shows views 2404 and 2406 of an example portion of an optical assembly 2400 a scanner having two dissimilar mirrors. Views 2404, 2406 of the portion of the optical assembly enclosed by a portion of an optical enclosure 2410 are shown. As depicted views 2404 and 2406, the optical assembly 2400 includes a two-axis scanner and includes (A) a first mirror 2414 and (B) a second mirror 2416. The first mirror can have a different shape as the second mirror. For example, FIG. 24 shows an example of mirror 2414 having an elliptical (e.g., a circular) shape, and mirror 2416 is rectangular mirror having rounded corners. The first mirror 2414 is affixed by mirror mount disposed on its back surface, and the second mirror 2416 is affixed by mirror mount (with guard) 2420. First mirror 2414 is disposed next to gas flow components (e.g., gas manifold) 2418. Mirror mounts can be affixed with respect to the scanner of the optical assembly portion 2400. Gas flow components 2422, 2424 are located with respect to mirrors 2414 and 2416 respectively, where each of gas flow components 2422 and 2424 includes a plurality of apertures through which the gas flow assembly may direct a flow of gas entering into the gas flow component through an inlet.

As depicted in the example shown in FIG. 24, gas flow component 2430 includes an inlet 2432 configured to receive a gas flow. Gas flow component 2430 includes a group of apertures including apertures 2434, which apertures are periodically arranged along a surface of the gas flow component 2430 in a single file. Gas flow component 2430 can be configured to direct gas flow to a surface of an optical element. For example, gas flow component 2424 is configured to direct gas flow (e.g., expelled gas through the apertures) to a back surface of mirror 2416. The back surface of the mirror opposes a side of the mirror configured to interact with the energy beam propagating along an optical path and reflect it in a direction. For example, gas flow component 2430 can be configured to direct gas flow to a back surface of a mirror via the group of apertures including apertures 2434.

As depicted in the example shown in FIG. 24, gas flow component 2450 includes an inlet 2452 configured to receive a gas flow. Gas flow component 2450 includes a group of apertures including apertures 2454, which apertures are periodically arranged in a single file along a surface of the gas flow component 2450. The apertures of gas flow component 2450 can be configured to direct gas flow (e.g., expelled gas through the apertures) to a surface of an optical element. For example, gas flow component 2422 is configured to direct gas flow to a back surface of mirror 2414. For example, gas flow component 2450 can be configured to direct gas flow to a back surface of mirror 2414 via apertures 2454. Optical assembly 2400 can include a manifold 2402. Manifold 2402 shows an example of coolant channel 2462 configured to condition a temperature of (i) gas flowing thereon or there adjacent, (ii) a component which it is contacting, and/or (iii) a component having flowable connection to the manifold. For example, the manifold can direct the coolant to another component via channel(s) (e.g., tubing). A coolant may be introduced into manifold 2402 via an inlet 2460 and directed into channels 2462 of the gas flow component, and exits through outlet 2461. Manifold 2402 is coupled with electrical connectors 2463a and 2463b each connect to a motor that rotates a scanner mirror about an axis. For example, manifold 2402 can direct gas flow into gas flow components 2424, 2422. For example, manifold 2402 can direct gas flow into gas flow components 2430 via inlet 2432. For example, manifold 2402 can direct gas flow into gas flow component 2450 via inlet 2452. The gas flow component(s) may be part of a gas flow component. For example, manifold 2402 can direct a coolant (e.g., water) to a collimator of the energy beam and/or to at least one actuator of the scanner. The manifold may condition temperature(s) of one or more coolant types (e.g., gas and liquid coolants).

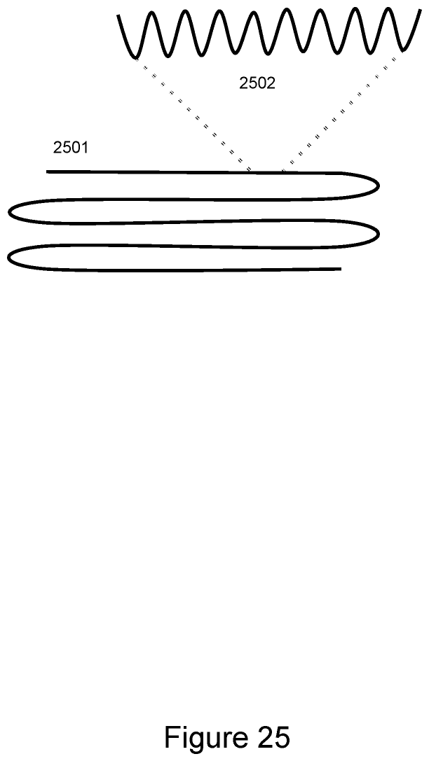

In some embodiments, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 25 shows an example of a path 2501 of an energy beam comprising a zigzag sub-pattern (e.g., 2502 shown as an expansion (e.g., blow-up) of a portion of the path 2501). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof.

In some embodiments, the path comprises successive lines. The successive lines may touch each other. The successive lines may overlap each other in at least one point. The successive lines may substantially overlap each other. The successive lines may be spaced by a first distance (e.g., hatch spacing). Examples of materials, 3D printers and associated methods (e.g., including using successive lines), software, systems, device and apparatuses can be found in PCT/US17/60035 and PCT/US22/16550, each of which is entirely incorporated herein by reference.

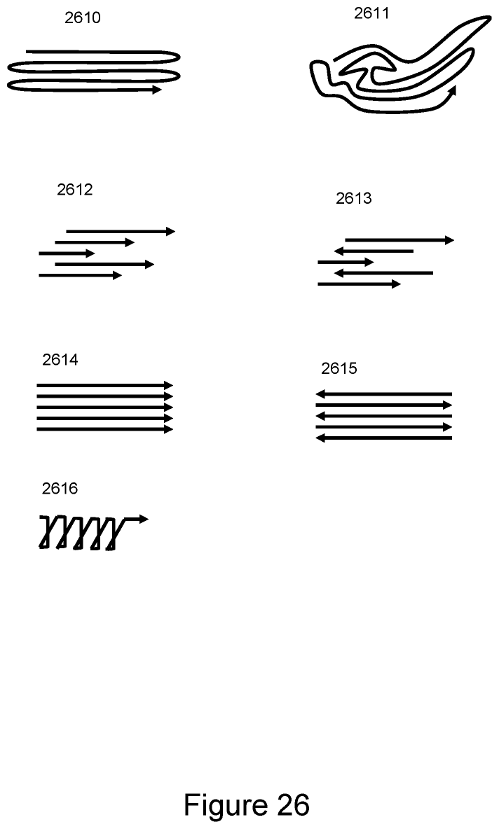

In some embodiments, the path may follow a spiraling shape, or a random shape (e.g., FIG. 26, 2611). The path may be overlapping (e.g., FIG. 26, 2616) or non-overlapping. The path may comprise at least one overlap. The path may be substantially devoid of overlap (e.g., FIG. 26, 2610). The path may comprise a hatch line or a tile (e.g., irradiation stamp).

FIG. 26 shows various examples of paths. The energy beam and/or flux may travel in each of these types of paths. The path may substantially exclude a curvature (e.g., 2612-2615). The path may include a curvature (e.g., 2610-2611). The path may comprise hatching (e.g., 2612-2615). The progression of the energy beam and/or flux along the path may be directed in the same direction (e.g., 2612 or 2614). Every adjacent path may be directed in an opposite direction (e.g., 2613 or 2615). The paths may have the same length (e.g., 2614 or 2615). The paths may have varied length (e.g., 2612 or 2613). The spacing between two adjacent path sections may be substantially identical (e.g., 2610) or non-identical (e.g., 2611). The path may comprise a repetitive feature (e.g., 2610), or be substantially non-repetitive (e.g., 2611). The path may comprise non-overlapping sections (e.g., 2610), or overlapping sections (e.g., 2616). The path may comprise a spiraling progression (e.g., 2616).

In some embodiments, a progression of the energy beam along a hatching pattern path comprises one or more rapid maneuvers of the energy beam and/or flux along the path. For example, a rapid maneuver can comprise a change in direction of the energy beam along the path, e.g., a change in direction by at least about 45°, 90°, 120°, 150°, 180°, or more. For example, a change in direction can be a U-turn maneuver. In some embodiments, an associated timescale for completing a rapid maneuver can be from about 100 microseconds (usec) to 30 milliseconds (msec). An associated timescale for completing a rapid maneuver can be at most about 30 msec, 20 msec, 10 msec, 5 msec, 500 μsec, 300 μsec, 100 μsec, or less.

In some embodiments, the 3D printing system comprises a window holder configured to hold an optical window. The window holder for supporting a window and/or at least partially shielding a window from debris can have any suitable shape (e.g., cylindrical, polyhedron, truncated cone, e.g., prism). For example, the window may have a first cross-sectional shape, and the window holder may have the same or a different second cross-sectional shape as the window. The first and/or second cross-sectional shapes may be a geometric shape (e.g., any polygon described herein). The first and/or second cross-sectional shapes may comprise a straight line or a curved line. The first and/or second cross-sectional shapes may comprise a random shape. Examples of materials, 3D printers and associated methods, software, systems, apparatuses and devices such as other window holders, can be found in International Patent Application Serial Nos. PCT/US17/60035 and PCT/US22/16550, each of which is entirely incorporated herein by reference.

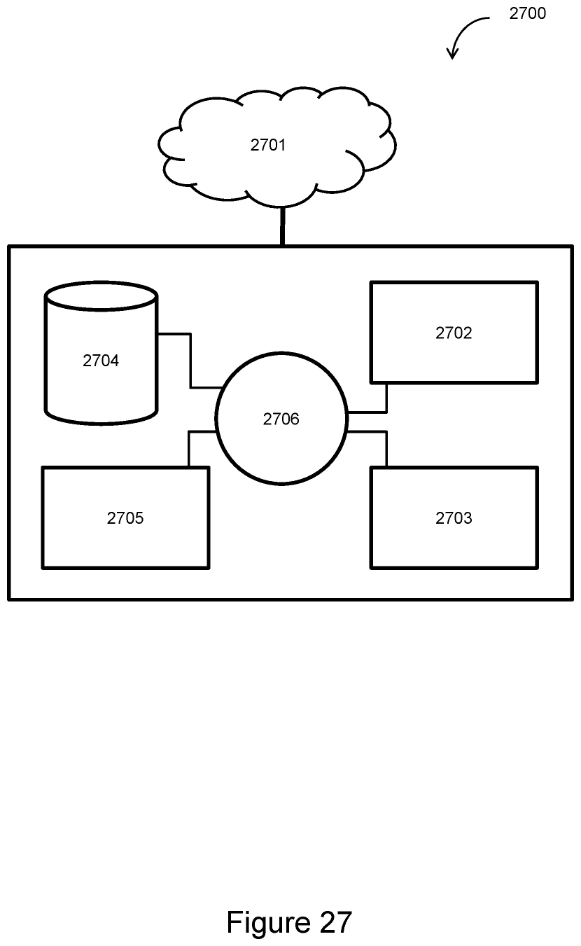

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 27 is a schematic example of a computer system 2700 that is programmed or otherwise configured to facilitate the formation of a 3D object according to the methods provided herein. The computer system 2700 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 2701 can be part of, or be in communication with, a 3D printing system or apparatus. The computer may be coupled with (e.g., to) one or more mechanisms disclosed herein, and/or any parts thereof. For example, the computer may be coupled with (e.g., to) one or more sensors, valves, switches, motors, pumps, scanners, optical components, or any combination thereof. The computer system 2700 can include a processing unit 2706 (also “processor,” “computer” and “computer processor” used herein). The computer system may include memory or memory location 2702 (e.g., random-access memory, read-only memory, flash memory), electronic storage unit 2704 (e.g., hard disk), communication interface 2703 (e.g., network adapter) for communicating with one or more other systems, and peripheral devices 2705, such as cache, other memory, data storage and/or electronic display adapters. The memory 2702, storage unit 2704, interface 2703, and peripheral devices 2705 are in communication with the processing unit 2706 through a communication bus (solid lines), such as a motherboard. The storage unit can be a data storage unit (or data repository) for storing data. The computer system can be operatively coupled with (e.g., to) a computer network (“network”) 2701 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with (e.g., to) the computer system to behave as a client or a server. The processing unit can execute a sequence of machine-readable instructions, which can be embodied in a program or software. The instructions may be stored in a memory location, such as the memory 2702. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2700 can be included in the circuit.

In some embodiments, the storage unit 2704 stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the 3D printer comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory 2702 or electronic storage unit 2704. The machine executable or machine-readable code can be provided in the form of software. During use, the processor 2706 can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine have a processer adapted to execute the code, or can be compiled during runtime. The code can be supplied in a programming language that can be selected to enable the code to execute in a pre-compiled or as-compiled fashion.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise a computational scheme (e.g., an algorithm).

In some instances, the computer system includes configurable computing, partially reconfigurable computing, reconfigurable computing, or any combination thereof. The computer system may include a FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the computational scheme (e.g., control algorithm). In some instances, the controller uses calculations, real time measurements, or any combination thereof to regulate the energy beam(s).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some examples, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the computer system utilizes a machine readable medium/media to execute, or direct execution of, operation(s). The program instructions can be inscribed in a machine executable code. A machine-readable medium/media, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system includes a user interface. The computer system can include, or be in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the desired printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise an oxidizing gas (e.g., oxygen), hydrogen, water vapor, or any of the gasses mentioned herein. The gas may comprise a reactive agent. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the desired result). Examples of materials, 3D printers and associated methods, software, systems, device and apparatuses such as a controller (e.g., its control scheme) can be found in PCT/US17/18191, which is incorporated herein by reference in their entirety.

In some embodiments, the 3D printer comprises and/or communicates with a plurality of processors. The processors may form a network architecture. The 3D printer may comprise at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer systems. The machine interface one or more processors may be connected to at least one 3D printer processor. The connection may be through a wire (e.g., cable) and/or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly or indirectly). The printer controller may direct start (e.g., initiation) of a 3D printing process, stopping a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (, boot log, status change, safety events, motion control commands (e.g., of the energy beam, or of the layer dispensing mechanism), or printed 3D object status (e.g., what layer number is being printed),

In some embodiments, the machine interface processor allows controlling (e.g., monitoring) the 3D print job management. The 3D print job management may comprise status of each build enclosure, e.g., atmosphere condition, power levels of the energy beam, type of pre-transformed material loaded, 3D printing operation diagnostics, status of a filter, or the like. The machine interface processor (e.g., output device thereof) may allow viewing and/or editing any of the job management and/or one or more printing parameters. The machine interface processor may show the permission level given to the user (e.g., view, or edit). The machine interface processor may allow prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated in the 3D printer. One or more users may interact with the one or more 3D printing processors through one or more user processors (e.g., respectively). The interaction may be in parallel and/or sequentially. The users may be clients. The users may belong to entities that desire a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

In some embodiments, a user develops at least one 3D printing instruction and directs the 3D printer (e.g., through communication with the 3D printer processor) to print in a desired manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based at least in part on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the fundamental length scale (e.g., the diameter, spherical equivalent diameter, diameter of a bounding circle, or largest of height, width, depth, and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

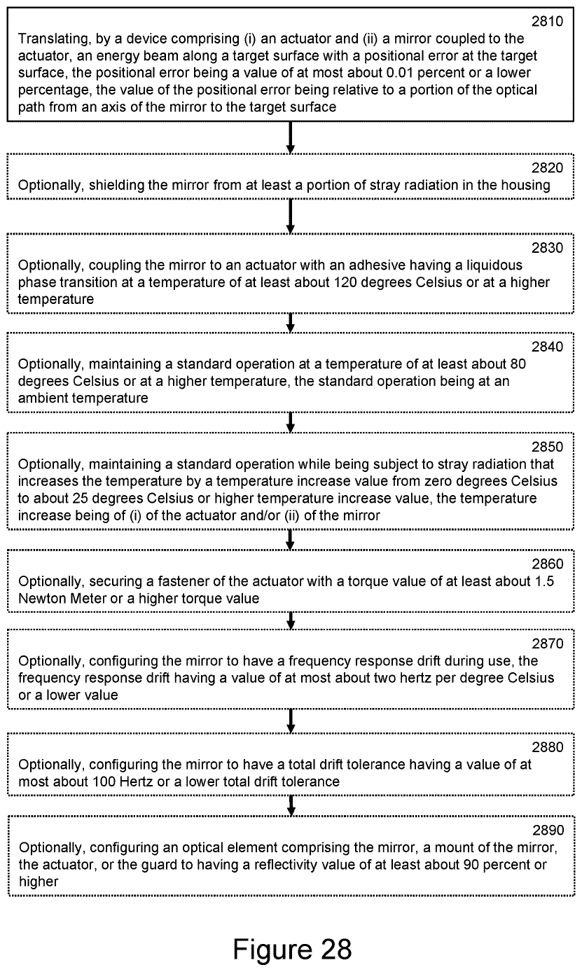

FIG. 28 shows an example of a flow diagram of an example process of a 3D system. A device comprising (i) an actuator and (ii) a mirror coupled with (e.g., to) the actuator translates an energy beam along a target surface with a positional error at the target surface, where the positional error is a value of at most about 0.01 percent or a lower percentage, and where the value of the positional error is relative to a portion of the optical path from an axis of the mirror to the target surface (2810). In some embodiments, a device is a scanner, e.g., a galvanometric scanner. A scanner can be a two-axis scanner. For example, a scanner 2204 comprising mirrors 2206, 2208 of FIG. 22.

Optionally, the mirror is shielded from at least a portion of stray radiation in the housing (2820). In some embodiments, the mirror is shielded from stray radiation by one or more guards. For example, mirrors 2206, 2208 of scanner 2204 are guarded (e.g., shielded) by guards 2214, 2216, or 2218 of FIG. 22. In some embodiments, a mirror and/or a mirror mount may be shielded from stray radiation in the housing. For example, mirror mounts 2210, 2212 may be shielded from stray radiation by guards 2214, 2216, or 2218 of FIG. 22.

Optionally, the mirror is coupled with (e.g., to) an actuator with an adhesive having a liquidous phase transition at a temperature of at least about 120° C. or at a higher temperature (2830). For example, the mirror 2206 may be coupled with (e.g., to) mirror mount 2210 by an adhesive having a liquidous phase transition, e.g., as disclosed herein. For example, a liquidous phase transition of at least 120° C., at least 140° C., or the like, e.g., or to another phase transition temperature as disclosed herein.

Optionally, a standard operation is maintained at a temperature of at least about 80° C. or at a higher temperature, (or to another temperature as disclosed herein) where the standard operation is at an ambient temperature (2840). For example, a standard operation of a scanner 2204 is controlled at a temperature of at least about 80° C. or at a higher temperature, e.g., or to another temperature as disclosed herein.

Optionally, a standard operation is maintained while being subject to stray radiation that increases the temperature by a temperature increase value from 0° C. to about 25° C. or higher temperature increase value such as to about 50° C., or to about 75° C., where the temperature increase being of (i) the actuator and/or (ii) the mirror (2850), e.g., to another temperature increase value or range as disclosed herein. For example, a standard operation of a scanner 2204 is maintained at a temperature increase value from about 0° C. to about 25° C. or a higher temperature such as to about 50° C., or to about 75° C. of (i) an actuator, e.g., a servo motor of the scanner, and/or of (ii) a mirror, e.g., an X mirror or Y mirror.

Optionally, a fastener of the actuator is secured with a torque value of at least about 1.5 Newton*meters (Nm) of a higher torque value (e.g., FIG. 28, block 2860), e.g., or to another torque value as disclosed herein. In some embodiments, mounting hardware for mounting an actuator, e.g., servo motor, and/or a mirror mount within an optical enclosure has a torque value of at least about 1.5 Nm or higher, e.g., as or to another torque value as disclosed herein, e.g., torque specification or minimum torque value. The fastener can be, for example, M3 hardware, M4 hardware, or the like, which is used to affix an optical component within the optical enclosure.

Optionally, the mirror is configured to have a frequency response drift during use, where the frequency response drift has a value of at most about 2 Hz per° C. or a lower value (2870), e.g., or to another frequency per° C. as disclosed herein.

Optionally, the mirror is configured to have a total drift tolerance value of at most about 100 Hz or a lower total drift tolerance (2880), e.g., or to another drift tolerance value as disclosed herein.

Optionally, an optical element comprising a mirror, a mount of the mirror, the actuator, or the guard, is configured to have a reflectivity value of at least about 90 percent or higher (2890), e.g., or to another reflectivity value as disclosed herein. For example, a material and/or coating of the optical element can have a reflectivity value of at least about 90 percent or higher, e.g., or to another reflectivity value as disclosed herein.

At times, a positional accuracy with which an optical element is positioned and/or controlled (e.g., maintained) is a factor in the accuracy with which an energy beam is directed onto a target surface. For example, the accuracy with which an optical element in a variable focus mechanism is positioned measured, and/or controlled (e.g., maintained). For example, the accuracy with which an energy beam path is: positioned measured, and/or controlled (e.g., maintained). For example, a positioning of an optical element may comprise a kinematic mounting of a guidance system, e.g., a galvanometric scanner. In some embodiments, an optical element is coupled with a stage. The stage may be a linear, tilt and/or rotary stage. The positional accuracy may be subject to a (e.g., threshold) requirement. A requirement may be such that (e.g., normal) operation of a 3D printer is maintained (e.g., with respect to an energy beam positioning on a target surface). For example, the requirement may be an accuracy of an energy beam (e.g., spot or footprint) position on a target surface that is at most about 20 microns (μm), 15 μm, 10 μm, 5 μm, 3 μm, or 1 μm, from a targeted position on the target surface. The accuracy of the position of the energy beam may be any value between the afore-mentioned values (e.g., from about 20 μm to about 1 μm, from about 20 μm to about 10 μm, or from about 10 μm to about 1 μm). For example, the requirement may be an accuracy of an optical element position with respect to a target angular position of the optical element. The angular requirement may be at most about 20 micro-radians (μRads), 15 μRads, 10 μRads, 5 μRads, 3 μRads, or 1 μRads, from a target angular position of the optical element. The accuracy of the angular position of the optical element may be any value between the afore-mentioned values (e.g., from about 20 μRads to about 1 μRads, from about 20 μRads to about 10 μRads, or from about 10 μRads to about 1 μRads).

In some embodiments, the systems, devices, and/or apparatuses disclosed herein (e.g., an energy beam path selection element) comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may be optical, capacitive, inductive and/or mechanical. The switches may comprise homing or limit switches. The motors may comprise actuators. The motors may comprise linear actuators. The motors may comprise belt driven actuators. The motors may comprise lead screw driven actuators. The motors may comprise a material such as copper, stainless steel, iron, rare-earth magnet (e.g., an element in the lanthanide series of the periodic chart). The motors may comprise any material disclosed herein. The actuators may comprise linear actuators. The systems and/or apparatuses disclosed herein may comprise one or more pistons. The systems and/or apparatuses disclosed herein may comprise one or more encoders (e.g., for positional feedback).

In some embodiments, a (e.g., residual) error remains in a position of at least one optical element in an energy beam selection path (e.g., following a movement of the at least one optical element). The residual error may comprise a variation in a (e.g., actual) position of an energy beam (e.g., as guided by a guidance system) from a requested position (e.g., at a target surface). The residual error may be a variation in a (e.g., actual) lateral and/or angular position of at least one optical element (e.g., in a guidance selection beam path and/or a guidance system) from a requested lateral and/or angular position. The residual error may comprise a vertical error, e.g., a difference between the actual vs. requested focal point of the energy beam with respect to the target surface. In some embodiments, a residual error in an energy beam position (e.g., at a target surface) and/or an optical element (e.g., angular) position may be compensated (e.g., corrected). Compensation may be effectuated at least in part by a (e.g., energy beam) calibration. At times, an energy beam calibration comprises formation of one or more (e.g., printed) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source. Examples of the calibration, control systems, controllers and operation thereof, 3D printing systems and processes, apparatus, methods, and computer programs, can be found in International Patent Application Serial No. PCT/US19/14635, filed Jan. 22, 2019, which is incorporated herein by reference in its entirety.

In some embodiments, a calibration comprises a comparison of a commanded energy beam position (e.g., at the target surface) with an actual (e.g., measured) energy beam position at the target surface. A variation of the measured energy beam position from the commanded energy beam position (e.g., at the target surface) may be termed a “distortion.” A variation of the measured energy beam position of a first energy beam (e.g., as directed by a first guidance system) with respect to a measured energy beam position of a second energy beam (e.g., as directed by a first guidance system), compared to a commanded first energy beam position with respect to a commanded second energy beam position, may be termed an “overlay offset” or a “beam-to-beam overlay offset.” A calibrated energy beam position (e.g., regarding distortion and/or overlay offset, e.g., at a target surface) may comprise a measured position that may be at most about 350 microns (μm), 250 μm, 150 μm, 100 μm, 50 μm, 40 μm, 30 μm, 20 μm, 10 μm, 5 μm, or 2 μm from a commanded position of the energy beam. The measured position may be any value between the afore-mentioned values (e.g., from about 2 μm to about 350 μm, from about 150 μm to about 350 μm, or from about 2 μm to about 150 μm). A calibrated energy beam position may comprise a measured angular position of a guidance system and/or guidance beam selection path optical element (e.g., a mirror). The optical element may be an element of the optical system. The measured angular position may deviate from a requested angular position by (e.g., comprise an error of) at most about 40 micro-radians (μRads), 30 μRads, 20 μRads, 15 μRads, or 10 μRads from a commanded angular position of the guidance system element. A deviation of the measured angular position from a requested angular position may be any value between the afore-mentioned values (e.g., from about 10 μRads to about 50 μRads, from about 30 μRads to about 50 μRads, or from about 10 μRads to about 30 μRads). These angular position accuracies may correspond to position accuracies at the target surface (e.g., an X-Y position accuracy) from about 2 μm to about 350 μm, from about 150 μm to about 350 μm, or from about 2 μm to about 150 μm.

In some embodiments, the calibration system is configured to calibrate one or more characteristics of the irradiating energy (e.g., energy beam). For example, the calibration system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with a second energy beam position at the (e.g., target) surface, and/or (iv) the XY offset of the energy beam with respect to the (e.g., target) surface. The characteristics of the energy beam may be calibrated along a field of view of the optical system (e.g., and/or detector). Calibration systems, control systems, controllers and operation thereof, 3D printing systems and processes, apparatus, methods, computer programs, are disclosed in PCT/US19/14635, and in U.S. Provisional Patent Application Ser. No. U.S. 63/290,878 filed on Dec. 17, 2021, each of which is incorporated herein by reference in its entirety.

In some embodiments, the calibration system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the material bed can depend in part on dimensions of one or more of the mirrors of a scanner, e.g., galvanometric scanner, utilized to direct a path of the energy beam about the target surface.

At times, standard operation of a plant, e.g., a system comprising multiple components, in response to an input signal is outside of one or more operational parameters. For example, a plant can be a scanner. The plant can comprise multiple components. For example, the plant can comprise multiple optical components. The plant may comprise components that (i) dissipate energy (e.g., dampers.), (ii) components that conserve energy (e.g., springs), or (iii) any combination thereof. An assembly of such components may form a complex system that responds to an input stimulus that can be modeled as a system of poles and zeros. For example, poles correspond to amplification of a sinusoidal input signal at the plant output (e.g., resonances). For example, zeros correspond to attenuation of a sinusoidal input signals at the plant output. For example, each mode is associated with its frequency, amount of the amplification or attenuation (e.g., magnitude), and a delay of the sinusoidal input signal propagation to the plant output (e.g., phase). The plant modes may affect how plant output reacts to a plant input.

At times, plant modes include slow response to the input signal (e.g., lag), oscillation of the plant output in response to non-oscillatory input, and/or inability to reach the target set point (e.g., steady state error). Plant poles and zeros properties may be defined by mechanical properties of the optical components, e.g., by mechanical properties of galvanometer motor(s), mirror(s), mounting hardware, or the like.

At times, plant output is affected by disturbances. Disturbances can comprise vibrations, friction, variable load, noises in electrical signals, or the like. System identification can be utilized to stabilize properties (e.g., operational parameters) of the plant using plant poles and zeros. For example, a result of the system identification of the plant comprises a set of poles and zeros properties (e.g., a plant model).

At times, drift in the response of the plant to input control signals results in process issues during a 3D printing process. For example, a drift in response of an optical element of the optical assembly can cause the energy beam that is directed by the optical assembly, to have positional drift. For example, a drift in response of a scanner, e.g., mirrors and/or actuators of a scanner, can cause an energy beam that is directed by the scanner to have positional drift. For example, a position of an energy beam can drift from its intended (e.g., prescribed) location due to a drift in the scanner and error propagation resulting from a long optical path length between the axial mirror of the galvanometric scanner and a target surface such as an exposed surface of the material bed. For example, drift in response of the scanner to input control signals can result in a hatch pattern that is different than the intended pattern. As compared to long monotonic energy beam path, the effect of such drift may be pronounced in a shorter sequence undergoing a larger change in the energy beam path, e.g., fast U turns in a hatch pattern.

In some embodiments, plant response to an input stimulus is modified utilizing a feedforward control filter, e.g., a feedforward controller can be used as part of the control scheme. The feed forward control scheme can modify input signal before it reaches the plant. For example, (I) by attenuating input signal at frequencies where the plant has amplifications and/or (II) by amplifying the input signal where the plant has attenuation. For example, a modified input signal is generated by matching controller poles with plant zeros and matching controller zeros with plant poles (e.g., cancel plant poles and zeros with the controller zeros and poles).

In some embodiments, a feedback control scheme is used to reduce effects of disturbances on the plant output. The feedback controller may compare actual plant output (e.g., measured output) with a nominal plant output (e.g., set point) and modify the plant input to match plant output with the set point (e.g., closed loop mode). At times, a feedback control scheme can generate plant instabilities as the feedback controller(s) feeds back measured plant output to the plant input. To reduce feedback controller-generated instabilities, the feedback control scheme can use zeros to cancel plant poles and poles to cancel plant zeros. For example, tuning can be utilized by the controller(s) to stabilize the plant, e.g., to determine feedback and feedforward poles and zeros. Such tuning can be utilized at least in part to establish a robust performance requirement for a control system, e.g., to satisfy minimal performance requirements for the system including the plant.

In some embodiments, a plant is an optical assembly comprising optical components. A plant can be a scanner, such as any of the scanners disclosed herein. A plant can be a two-axis galvanometric scanner including an X mirror and a Y mirror. Standard operation of the plant may be affected by an external source, which may result in the plant responding to input signal outside one or more operational parameters. The external source may comprise stray radiation incident on the plant. Thermal heating of optical elements can result in drift of operational parameters of one or more optical elements, e.g., a frequency response of the scanner. A change in the frequency response of the scanner can comprise (i) a change in location(s) of poles of the frequency response, (ii) a change in location(s) of zeros of the frequency response, or (iii) any combination thereof. Thermal heating of optical elements can be due to direct and/or stray radiation incident on the optical elements.

At times, thermal heating of optical elements can result in one or more operational parameters of the optical elements exceeding a threshold drift of the one or more operational parameters, e.g., as disclosed herein. For example, a threshold drift in frequency response of a galvanometric scanner. A drift in a frequency response of the galvanometric scanner can result in errors further along a process. Such error may be substantial and/or measurable, e.g., due to a large optical path between mirror of the galvanometric scanner and the target surface. Errors due to drift of operational parameters may yield magnified errors at other points of a 3D printing system. A control scheme may be implemented to compensate for drift of operational parameters. For example, a control scheme can include (i) a closed loop control, (ii) an open loop control, or (iii) any combination thereof. For example, a control scheme can include (I) a feedforward control, (II) a feedback control, or (III) any combination thereof.

At times, plant behavior may change with temperature (e.g., changes in plant poles and zeros properties). One or more material properties of the components of the optical system may be affected by temperature of the scanner and/or of the components of the optical system, e.g., scanner. One or more mechanical properties of the components of the plant may be affected by temperature of the plant and/or of the components of the plant. For example, changes in adhesive response to temperature, hardware response to temperature, change in refractive index, change in reflectivity, and/or other factors. For example, changes in glue tractability and/or stiffness, changes in clamping force due to screw and/or bolt expansion, change in refractive index of the lens, change in reflectivity of the guard surface, and/or other factors. Changes in characteristics of plant poles and zeros properties can cause mismatch between controller poles and zeros and locations of zeros and poles of a plant. Mismatch of plant poles/zeros and controller poles/zero may result in a decrease of performance of the feed forward controller(s) and may result in instability in the feedback controller(s).

In some embodiments, the feedback controller may be tuned such that a closed loop for the plant remains stable over a range of temperatures, e.g., within an operating range of temperatures for the plant. For example, operating temperatures may include at least about 20° C., 35° C., 50° C., or 75° C. above ambient temperature, or any other temperature increase value disclosed herein. For example, operating temperatures may include at least about 70° C., 80° C., 85° C., 100° C., 120° C., 150° C., or 250° C., or any other temperature value disclosed herein. For example, operating temperatures may range between about ambient temperature and 250° C.

In some embodiments, empirical methods may be used to generate a plant model operable over a range of temperatures, e.g., identifying plant poles/zeros over the range of temperatures. One or more plant models can be generated, which correspond to minimal performance requirements for a respective temperature range. The feedback controller can be tuned to be stable when paired with the (e.g., each) of the one or more plant models satisfying minimal performance requirements. Tuning scheme(s) can (A) receive a plurality of plant models and (B) select a plant model variation of the plurality of plant models for use at different temperatures. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based at least in part on previously identified models. The control scheme(s) may be inscribed as program instructions (e.g., software). Examples of controllers, control schemes, software, apparatuses, devices, system, and related 3D object printing methodologies, can be found in U.S. patent application Ser. No. 15/435,078, filed Feb. 16, 2017, which is incorporated herein by reference in its entirety.

In some embodiments, a control scheme is generated that corresponds to at least minimal requested performance requirements of the plant for a temperature range. For example, a control scheme is generated such that plant operation for the temperature range meets the minimal performance requirements for the temperature range. Plant operation at a temperature of the temperature range can be non-optimal and meeting minimal performance requirement(s). For example, a control scheme may utilize a plant model having a central tendency of values for the temperature range of operating conditions of the plant, e.g., an average of plant poles and zeros. The plant can be the optical system. The central tendency may comprise mean, median, or mode. The mean may comprise a geometric mean.

In some embodiments, data analysis techniques described herein involves one or more regression analysis(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naïve Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). The learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the computational schemes (e.g., algorithms) disclosed herein. The controller and/or processor may comprise the non-transitory computer media. The software may comprise any of the computational schemes disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g. at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based at least in part on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. The at least one computer model may receive sensed parameter(s) value(s) from one or more sensors, e.g., temperature and/or positional sensors. The computer model may use (e.g., in real-time) the sensed parameter(s) value(s) for a prediction and/or adjustment of the target position. Off-line may be during the time a 3D object is not printed, when the optical system is not operational, and/or during “off” time of the energy beam and/or energy source. For a given temperature, the computer model may compare a sensed value (e.g., by the one or more sensors) to an estimated value of the target parameter (e.g., position). The computer model may (e.g., further) calculate an error term and readjust the at least one computer model to achieve convergence, e.g., of a requested position of the energy beam at the target surface and/or a requested position of the optical element(s).

In some embodiments plant comprises multiple optical components. A first set of one or more of the optical components of the plant may receive an input to the plant, e.g., a control signal, and generate an intermediary output. The intermediary output may be combined, e.g., as a summation, weighted summation, a central tendency, any combination thereof, or the like, of output signal(s) from the first set of one or more optical components. The intermediate output may comprise a central tendency. The central tendency may comprise mean, median, or mode. The mean may comprise a geometric mean. The intermediary output can be provided to a second set of one or more optical components as an input. The second set of one or more optical components can generate output signal(s). Output signal(s) from the second set of one or more optical components can be combined, e.g., in a summation, a weight summation, as central tendency, any combination thereof, or the like, of output signal(s) from the first set of one or more optical components. The output can be provided from the plant.

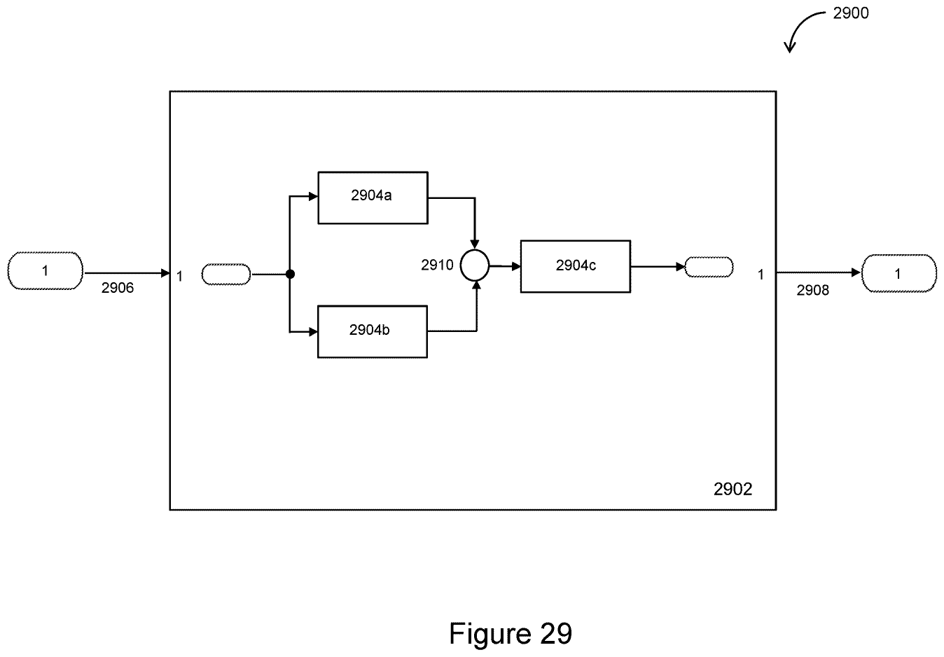

FIG. 29 depicts a block diagram of an example control scheme 2900. Control scheme 2900 comprises a model of a plant 2902. Plant 2902 comprises multiple components 2904a, 2904b, 2904c. The plant 2902 is configured to receive an input 2906, e.g., a control signal, and provide an output 2908, e.g., a mechanical output. As depicted, components 2904a and 2904b receive input 2906 and provide an intermediary output 2910 to component 2904c. Intermediary output 2910 is a combination of output(s) of each of component 2904a and 2904b. Component 2904c receives the intermediary output as an input generates output 2908 from the plant 2902. For example, plant 2902 is a two-axis scanner (e.g., galvanometric scanner) comprising (i) at least one actuator and (ii) at least one mirror coupled with (e.g., to) the actuator. The two-axis scanner comprises a first component (a first actuator) and a second component (a second actuator), e.g., an X motor and a Y motor. Each actuator is coupled with (e.g., to) a mirror, e.g., an X mirror and a Y mirror, respectively. An input to a first component is an input to an actuator, e.g., a control signal to a servo motor that causes the servo motor to adjust a position by a corresponding amount. The first component provides an intermediary output to a third component, e.g., the actuator can adjust a position a mirror that is coupled with (e.g., to) the actuator. An output from the third component can be the output of the plant, e.g., a final position of the mirror is an output of the scanner.

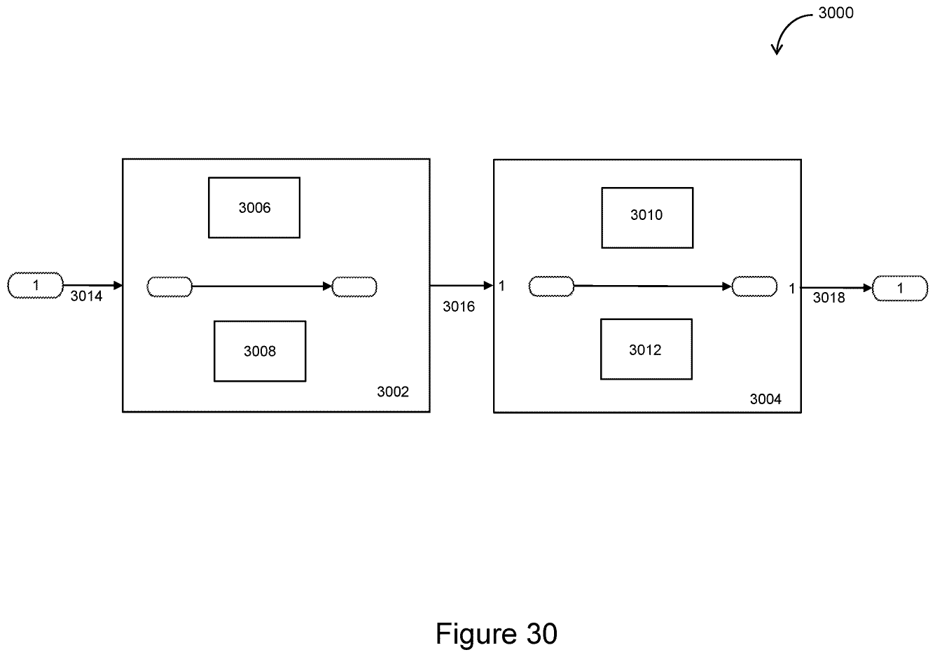

In some embodiments, a feedforward controller can be utilized in a closed loop scheme to provide a compensated input to a plant. FIG. 30 depicts a block diagram of an example control scheme 3000. Control scheme 3000 comprises a feedforward controller 3002 and a model of plant 3004, e.g., a model of plant behavior. The feedforward controller 3002 comprises zeros 3006 and poles 3008 selected to stabilize identified zeros 3010 and poles 3012 of the plant. Control scheme 3000 includes providing an input 3014 to the feedforward controller 3002, e.g., a control signal, and modifying the input 3014 to generate a compensated signal 3016 as an output of the feedforward controller 3002. The compensated signal 3016 is provided as input to the plant 3004. The plant 3004 receives the compensated signal 3016 and generates an output 3018.

For example, plant 3004 is a two-axis scanner comprising i) an actuator and ii) a mirror coupled with (e.g., to) the actuator. The scanner response (e.g., mechanical response) to control signals can be defined using a scanner model comprising zeros 3010 and poles 3012. A feedforward controller 3002 can generate zeros 3006 and poles 3008 that match (e.g., substantially match) the poles 3012 and zeros 3010 of the scanner model, respectively. The feedforward controller 3002 modifies the input signal 3014, e.g., a control signal to the scanner, with the zeros 3010 and poles 3012 and provides the compensated signal 3016 as input to the scanner, e.g., plant 3004. The scanner performs one or more operations in response to the compensated signal 3016, e.g., moves an actuator to adjust a mirror position.

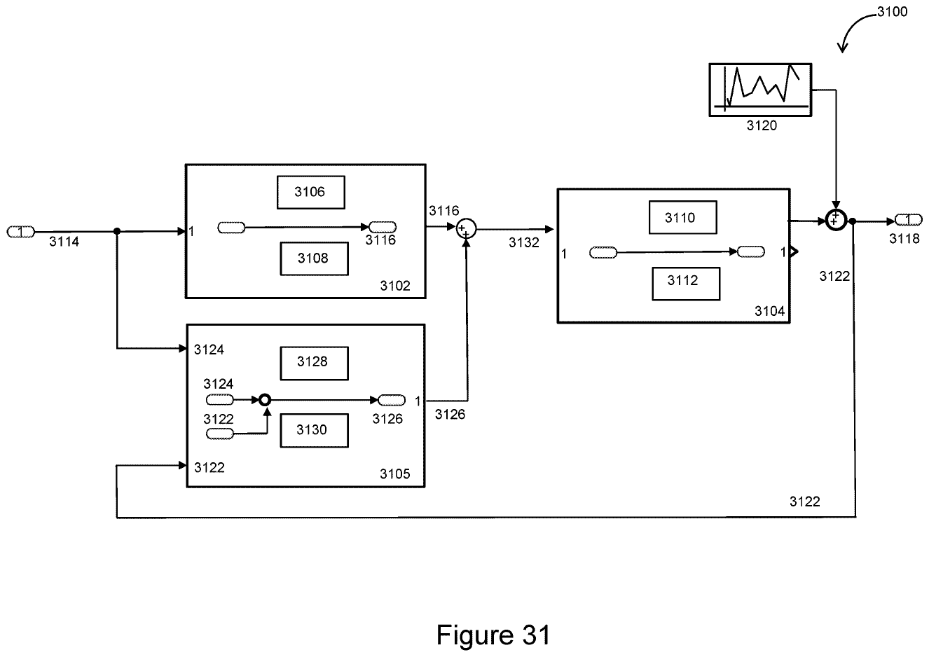

In some embodiments, a feedback controller can be utilized in a closed loop scheme to provide feedback to a plant. FIG. 31 depicts a block diagram of an example control scheme 3100. Control scheme 3100 comprises a feedforward controller 3102, a plant 3104, and a feedback controller 3105. The feedforward controller 3102 comprises zeros 3106 and poles 3108 selected to stabilize identified zeros 3110 and poles 3112 of a model of the plant behavior. Control scheme 3100 includes providing an input 3114 to the feedforward controller 3102, e.g., a control signal, and modifying the input 3114 to generate a compensated signal 3116 as an output of the feedforward controller 3102. The compensated signal 3116 is provided as input to the plant 3104. The plant 3104 receives the compensated signal 3116 and generates an output 3118. Disturbances 3120 can act upon an output 3118 of the plant 3104 such that a real output of the plant 3104 comprises a variation from a target output. Feedback controller 3105 receives a real output of the plant 3104 including disturbances 3120 as feedback 3122. The feedback controller receives the feedback 3122 and control signals values 3124, e.g., set point values, as input. The feedback controller can compare the feedback 3122 and control signal values 3124 and generate a tuned signal 3126. At times, the tuned signal 3126 comprises feedback controller zeros 3128 to cancel plant poles 3112 and feedback controller poles 3130 to cancel plant zeros 3110. For example, controller tuning can be utilized to stabilize the plant, e.g., to determine feedback and feedforward poles and zeros. The tuned signal 3126 is combined with the compensated signal 3116 to generate a plant input 3132.

For example, the plant 3104 is a two-axis scanner comprising i) an actuator and ii) a mirror coupled with (e.g., to) the actuator. The scanner response (e.g., mechanical response) to control signals can be modeled using zeros 3110 and poles 3112. A feedforward controller 3102 can generate zeros 3106 and poles 3108 that match (e.g., substantially match) the poles 3112 and zeros 3110 of the scanner model, respectively. The feedforward controller 3102 modifies the input signal 3114, e.g., a control signal to the scanner, with the zeros 3110 and poles 3112 and provides the compensated signal 3116 as input to the scanner, e.g., plant 3104. The scanner performs one or more operations in response to the compensated signal 3116, e.g., moves an actuator to adjust a mirror position. Feedback 3122 from the scanner, e.g., a measured position of the mirror or actuator in response to the input control signal 3114 can be measured, e.g., using a linear encoder. The feedback 3122 is provided to a feedback controller 3105 which can generate a tuned signal 3126 based at least in part on a comparison between the control signal values 3124 and feedback 3122 (e.g., the measured position of the actuator in response to the control signal values 3124). The feedback controller 3105 may additionally (or alternatively) generate a tuned signal using zeros 3128 and poles 3130 to cancel out (e.g., minimize the effects of) the scanner poles 3112 and zeros 3110, respectively. The tuned signal 3126 and compensated signal 3116 can be combined and provided as input to the plant 3104, e.g., as input to the scanner.

A Bode plot is a graph of a frequency response of a plant. A Bode plot may comprise (i) a Bode magnitude plot, e.g., expressing a magnitude of the frequency response of the plant, and (ii) a Bode phase plot, e.g., expressing a phase shift of the frequency response of the plant. A Bode plot of plant response to an input signal may be utilized to determine locations (e.g., approximate locations) of poles and zeros of the plant. A Bode plot of plant response to an input signal may be utilized to select poles and zeros for a feedforward controller to cancel out the plant zeros and poles, respectively. A Bode plot of plant response to an input signal may be utilized by a feedback controller to select zeros and poles to tune a real (e.g., measured) output of the plant to match (e.g., closely match) an intended output.

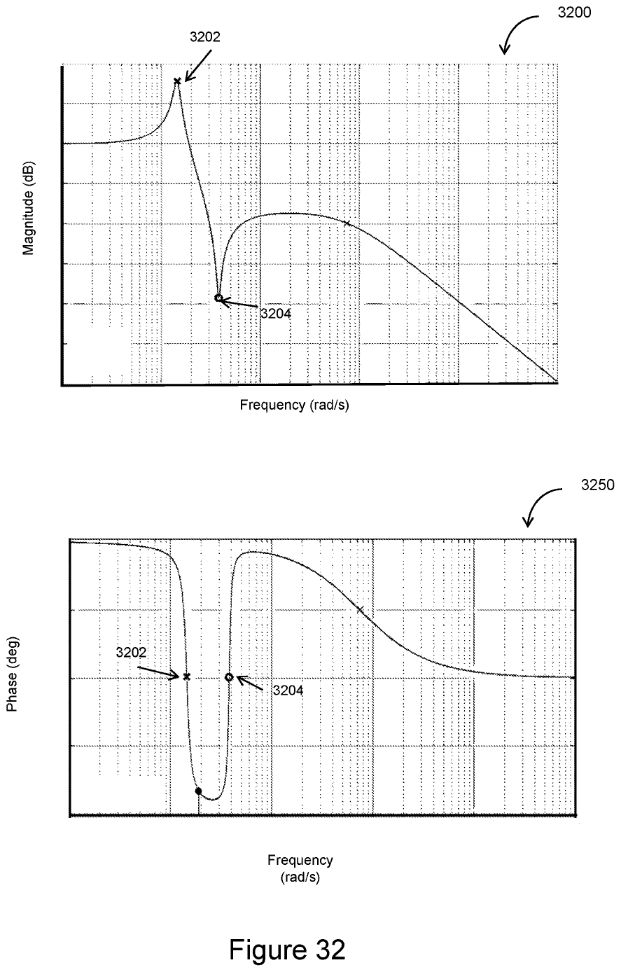

FIG. 32 depicts example Bode plots for a plant, e.g., a scanner comprising (i) an actuator and (ii) a mirror coupled with (e.g., to) the actuator. A Bode magnitude plot 3200 and Bode phase plot 3250 depict locations of a pole 3202 and a zero 3204 in the frequency response of the plant.

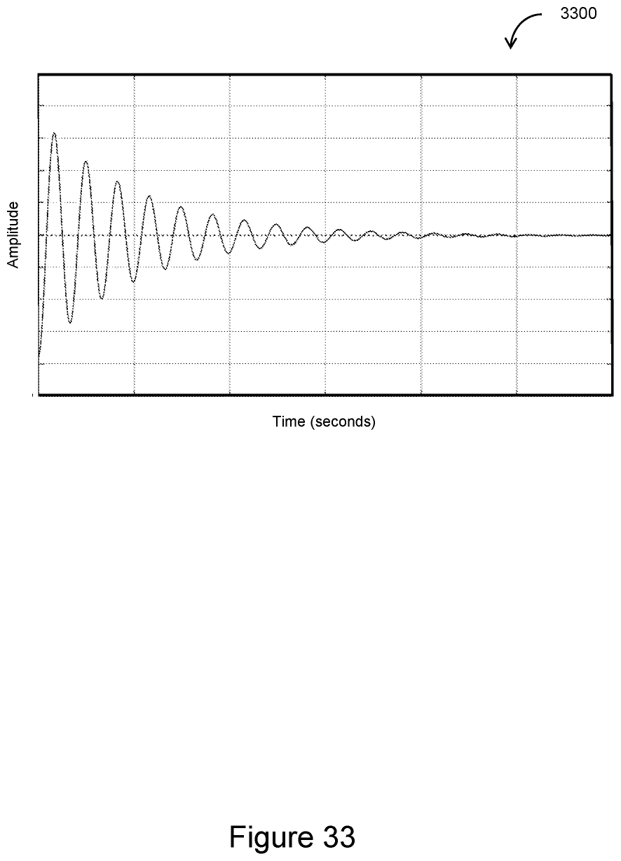

FIG. 33 depicts example oscillatory response plot of a plant to an input signal. Step response plot 3300 depicts an amplitude response of a plant, e.g., a scanner comprising i) an actuator and ii) a mirror coupled with (e.g., to) the actuator, in response to a step input signal provide to the plant. An oscillatory behavior of the plant response to the input signal can be utilized to determine further tuning of the control scheme for the plant.

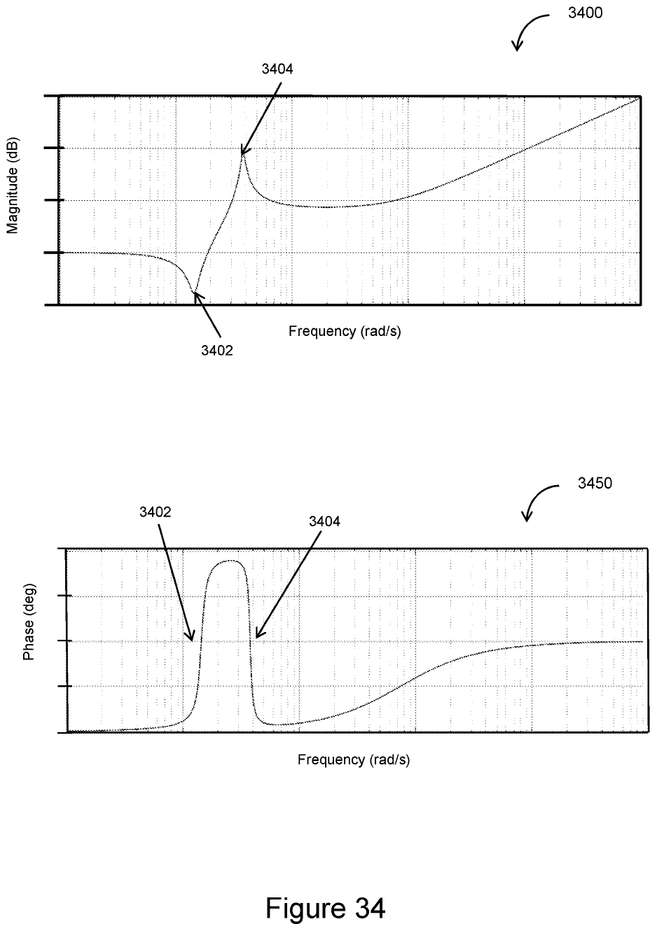

FIG. 34 depicts example Bode plots for a matching controller. As depicted in FIG. 34, Bode magnitude plot 3400 and Bode phase plot 3450 are generated by a controller, e.g., a feedforward controller, to have a zero 3402 at a location where the plant has a pole (e.g., pole 3202), and a pole 3404 where the plant has a zero (e.g., zero 3204).

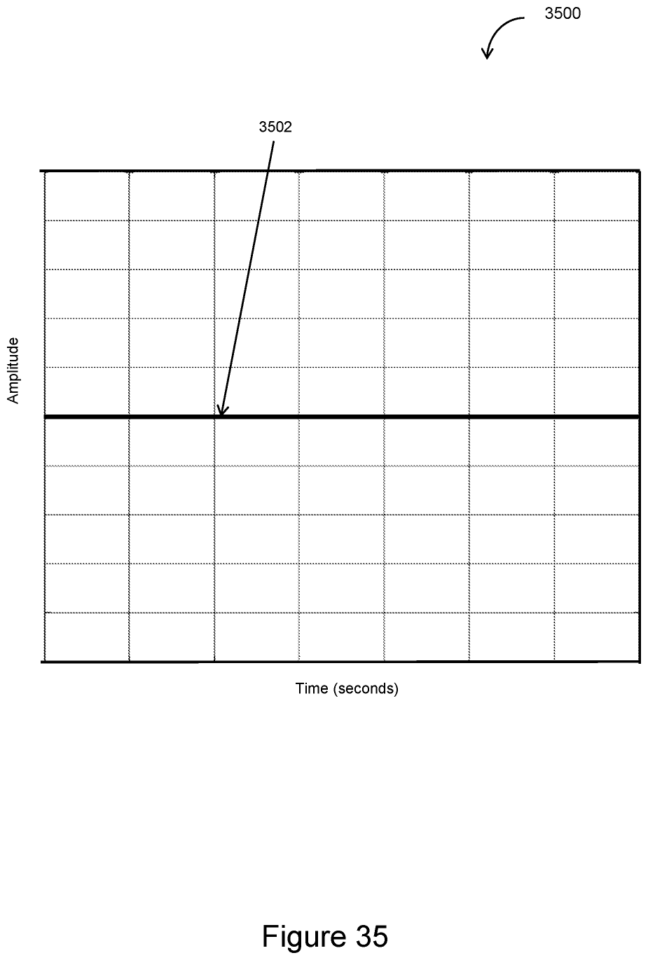

FIG. 35 depicts example response plot of a plant to a modified step function. Plot 3500 depicts a plant response to an input step function is a modified step function, e.g., by a feedforward controller, by matching (e.g., nearly matching) poles/zeros of the plant to zeros/poles of a controller. As depicted, plant response 3502 results in a minimal amount of oscillatory behavior in response to the modified input step function. For example, plot 3500 may result from an input of a step function that is modified by a controller using poles/zeros identified in FIG. 34 and that is provided to a plant with the poles/zeros identified in FIG. 33.

In some embodiments, a plant is a scanner comprising (i) an actuator and (ii) a mirror coupled with (e.g., to) the actuator, where the scanner response to control signal can change with temperature (e.g., changes in plant poles and zeros properties). One or more material properties of the components of the optical system may be affected by a temperature of the scanner and/or of the components of the optical system, e.g., scanner. One or more mechanical properties of the components of the optical system (e.g., scanner) may be affected by a temperature of the scanner and/or of the components of the scanner. For example, changes in adhesive response to temperature, hardware response to temperature, change in refractive index, change in reflectivity, and/or other factors.

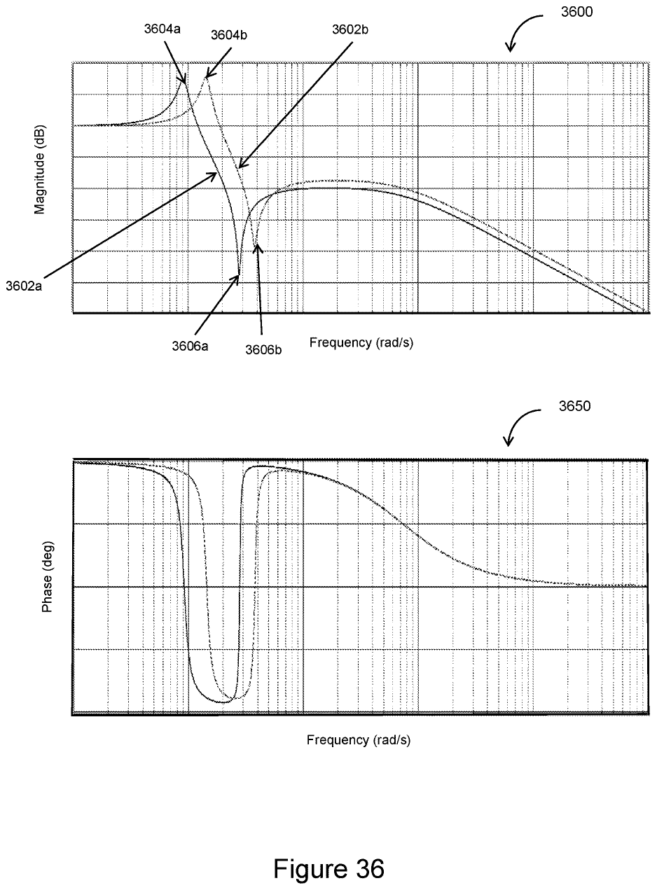

FIG. 36 depicts example Bode plots for a system response that changes with different temperatures. As depicted in Bode magnitude plot 3600 and Bode phase plot 3650, response of the scanner shifts at different temperatures. For example, a first response 3602a at a first operating temperature of the scanner and/or optical component(s) of the scanner, and a second response 3602b at a second, different operating temperature of the scanner and/or optical component(s) of the scanner. Response curve 3602a at a first temperature has a different behavior than plot 3602b in response to a second temperature. Response curve 3602a has a first pole 3604a and a first zero 3606a. Response curve 3606b has a second pole 3604b and a second zero 3606b. The locations of the poles 3604a and 3604b are different. The locations of the zeros 3606a and 3606b are different.

In some embodiments, the control system controlling the optical system, energy source and/or energy beam can minimize offset due to operating conditions (e.g., temperature increase). For example, plots similar to the ones shown in FIG. 36 can be measured as a response to different temperature, e.g., along the range of temperature operations of the optical system (e.g., of the scanner). The plots may be utilized to anticipate the behavior of the optical system at the operating temperature (e.g., range), and compensate for those changes, e.g., using a computational scheme and/or program instructions. The plot may be generated using any of the methodologies disclosed herein. For example, the plot can be generated using historical measurements, e.g., (i) operating the optical system, (ii) measuring its temperature, (iii) and detecting the behavior of components of the optical system. The detection may comprise detecting at a given temperature (a) the position of the energy beam on the target surface, (b) the position of the actuator, and/or (c) the position of the mirror. For example, the plot can be generated using a physics simulation, e.g., (i) simulating operation of the optical system at a temperature, (iii) and predicting the behavior of components of the optical system. For example, the plot may be generated using artificial intelligence engine such as by utilizing the historical measurements as a learning set for a machine learning simulation.

At times, scanner behavior, e.g., a response of a scanner to input control signals, may change in response to temperature changes of the scanner and/or optical components. For example, changes in poles and/or zeros of the scanner response can cause a mismatch to arise between the controller poles/zeros and the poles/zeros of a scanner model utilized in a control scheme, e.g., control scheme 3100. A mismatch between controller poles/zeros and scanner poles/zeros can lead to a decrease of performance of the feedforward controller and cause instability in the feedback controller. In some embodiments, the feedback controller may be tuned such that a closed loop for the plant remains stable over a range of temperatures, e.g., within an operating range of temperatures for the plant. In some embodiments, a control scheme may include multiple temperature-dependent operating modes which may be selected in response to a temperature of the plant.

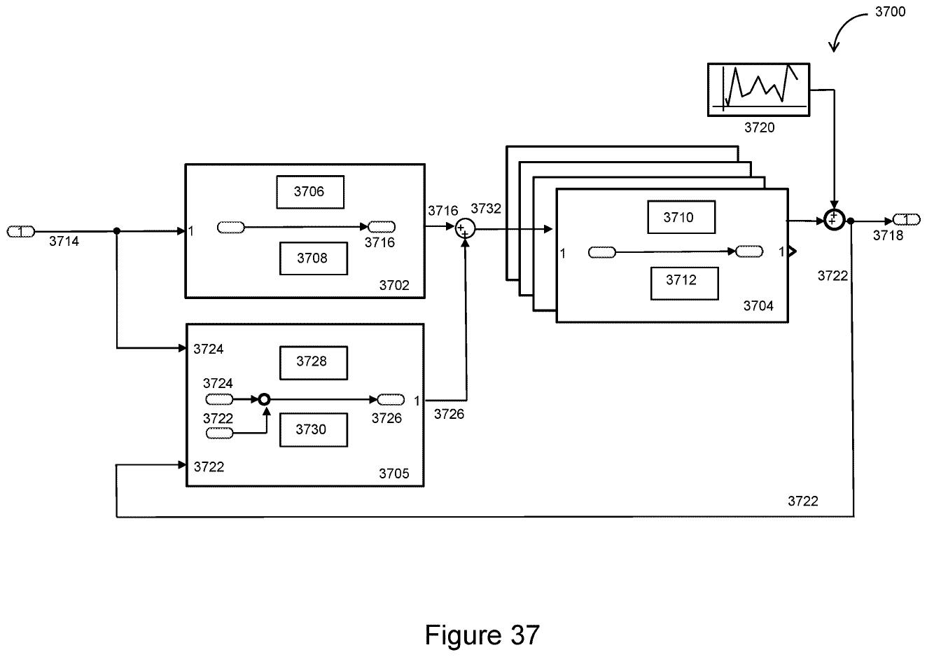

FIG. 37 depicts a block diagram of an example control scheme 3700. Control scheme 3700 comprises a feedforward controller 3702, a plant 3704, and a feedback controller 3705. At times, control scheme 3700 comprises a plurality of plant models that describe plant behavior in response to an input control signal, e.g., plant(s) 3704. Each plant 3704 corresponds to a temperature or temperature range of the plant. The feedforward controller 3702 comprises zeros 3706 and poles 3708 selected to stabilize identified zeros 3710 and poles 3712 of the plant. Control scheme 3700 includes providing an input control signal 3714 to the feedforward controller 3702, e.g., a control signal, and modifying the input control signal 3714 to generate a compensated signal 3716 as an output of the feedforward controller 3702. The compensated signal 3716 is provided as input to the plant 3704. The plant 3704 receives the compensated signal 3716 and generates an output 3718. Disturbances 3720 can act upon an output 3718 of the plant 3704 such that a real output of the plant 3704 comprises a variation from a target output. Feedback controller 3705 receives a real output of the plant 3704 including disturbances 3720 as feedback 3722. The feedback controller receives the feedback 3722 and control signals values 3724, e.g., set point values, as input. The feedback controller can compare the feedback 3722 and control signal values 3724 and generate a tuned signal 3726. At times, the tuned signal 3726 comprises feedback controller zeros 3728 to cancel plant poles 3712 and feedback controller poles 3730 to cancel plant zeros 3710. For example, controller tuning can be utilized to stabilize the plant, e.g., to determine feedback and feedforward poles and zeros. The tuned signal 3726 is combined with the compensated signal 3716 to generate a plant input signal 3732. Control scheme 3700 comprises a plurality of models of plant 3704 corresponding to plant behavior at different temperatures and/or temperature ranges. For each model of plant 3704 at a corresponding operating temperature and/or temperature range, the control scheme may update the compensated signal 3716 from the feedforward controller 3702 and/or the tuned signal 3726 from the feedback controller 3705 to generate a plant input signal 3732 to stabilize the plant behavior of the plant 3704 at the operating temperature and/or temperature range. For example, at each operating temperature and/or temperature range, the control scheme 3700 may update one or more properties of the poles/zeros of (i) the feedforward controller 3702, (ii) feedback controller 3705, or (iii) a combination thereof. Plant behavior at different operating temperatures and/or temperature ranges can be determined empirically. For example, adjusting the plant temperature and tuning the feedforward controller and/or feedback controller to stabilize the plant behavior, e.g., to obtain a response 3502 as depicted in FIG. 35. The tuned parameters can be stored in a look-up table (LUT) and/or used to train a model that may be utilized to adjust the control scheme 3700 in real-time in response to changes in plant temperature and/or plant behavior. For example, the plant 3704 is a two-axis scanner comprising (i) an actuator and (ii) a mirror coupled with (e.g., to) the actuator. The scanner response (e.g., mechanical response) to control signals can be defined using zeros 3710 and poles 3712. A feedforward controller 3702 can generate zeros 3706 and poles 3708 that match (e.g., substantially match) the zeros 3710 and poles 3712 of the scanner, respectively. The feedforward controller 3702 modifies the input control signal 3714, e.g., a control signal to the scanner, with the zeros 3706 and poles 3708 and provides the compensated signal 3716 as input to the scanner, e.g., plant 3704. The scanner performs one or more operations in response to the compensated signal 3716, e.g., moves an actuator to adjust a mirror position. Feedback 3722 from the scanner, e.g., a measured position of the mirror or actuator in response to the input control signal 3714 can be measured, e.g., using a linear encoder. The feedback 3722 is provided to a feedback controller 3705 which can generate a tuned signal 3726 based at least in part on a comparison between the control signal values 3724 and feedback 3722 (e.g., the measured position of the actuator in response to the control signal values 3724). The feedback controller 3705 may additionally (or alternatively) generate a tuned signal using poles 3730 and zeros 3728 to cancel out (e.g., minimize the effects of) the scanner zeros 3710 and poles 3712, respectively. The tuned signal 3726 and compensated signal 3716 can be combined and provided as input to the plant 3704, e.g., as input to the scanner. Control scheme 3700 includes a plurality of models of plant 3704 (e.g., a plurality of models of the scanner), corresponding to different operating temperatures of the scanner and/or optical components. For example, a behavior of a mirror can depend on a temperature of the mirror (e.g., due to changes in the glue affixing the mirror to a mirror mount, mirror flexing, temperature-sensitive mounting hardware affixing the mirror mount to an optical enclosure, and the like). For example, a behavior of an actuator (e.g., servo motor) of the scanner can depend on a temperature of the actuator. Empirical methods can be used to determine properties of the control scheme 3700, e.g., poles/zeros for the feedforward controller 3702 and/or feedback controller 3705, at various temperatures or temperature ranges. During operation of the scanner (e.g., in real-time), control software may update properties of the control scheme 3700, e.g., poles/zeros values, in response to scanner behavior and/or measured temperature of the scanner. For example, control software may observe drift in the scanner response, e.g., oscillatory behavior of the scanner operation exceeding a threshold behavior, and update control scheme properties in response. For example, control software may measure a temperature of the scanner (e.g., using a thermocouple) and select updates control scheme properties in response, e.g., using a LUT.

At times, it may be advantageous to allow for easy installation and/or components of the 3D printing system. For example, it may be advantageous if one or more components of the 3D printing system are easily maneuvered (e.g., insertable and/or removed). Easy maneuvering (e.g., removal and/or insertion) may include actions of a user facing the 3D system, and maneuvering (e.g., pulling and/or pushing) the one or more components to facilitate their maneuver (e.g., removal and/or insertion, respectively). For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an (e.g., laser generator), an optical system, a detection system, an optical system enclosure, a side cover, or a door. The front of the 3D printing system can include a door to the processing chamber. A top of the 3D printing system can facing the platform through the optical window(s). The top of the 3D printing system may be closer to the optical windows than to the platform.

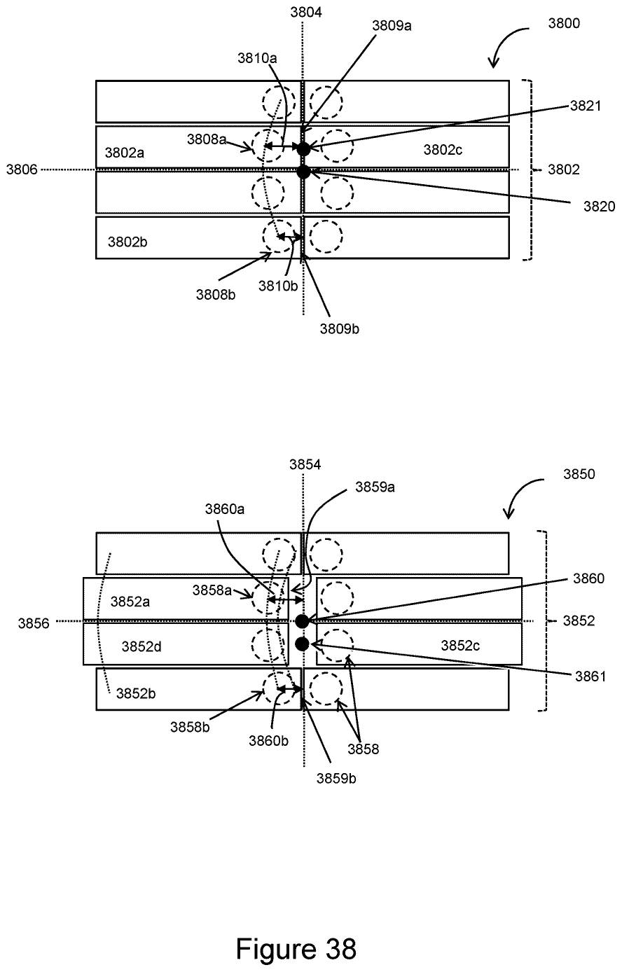

FIG. 38 schematically illustrates various 3D printer components. As depicted in FIG. 38, an arrangement 3800 of a plurality of optical enclosures 3802 each enclosing (e.g., retaining) an optical assembly, can align the optical enclosures symmetrically about a first mirror plane 3804 and about a second mirror plane 3806. As depicted, an optical enclosure 3802a is oriented with respect to an optical window 3808a that is different than an orientation of at least one other optical enclosure 3802b with respect to another optical window 3808b. For example, the optical window 3808a with respect an edge 3809a of the optical enclosure 3802a has a first offset 3810a perpendicular to the first mirror plane 3804 and optical window 3808b with respect to an edge 3809b of the optical enclosure 3802b has a second, different offset 3810b perpendicular to the first mirror plane 3804. Edge 3809a of the optical enclosure 3802a and edge 3809b of the optical enclosure 3802b are aligned with the first mirror plane 3804. The plurality of optical enclosures 3802 can be related via a C₂ rotational axis going through point 3820. Each horizontal pair of optical enclosures is related to each other via a C₂ symmetry axis. For example, optical enclosure 3802a is related to optical enclosure 3802c via the C₂ symmetry axis going through point 3821. This discussion re symmetry relationship in FIG. 38 does not consider any couplers and/or ports, e.g., disposed at any end of the optical enclosures, or an interior arrangement in the optical enclosures, which may limit some of the symmetry relations.

As depicted in the example shown in FIG. 38, an arrangement 3850 of a plurality of optical enclosures 3852 each enclosing (e.g., retaining) an optical assembly can align the optical enclosures symmetrically about a first mirror plane 3854 and about a second mirror plane 3856. As depicted, the plurality of optical enclosures 3852 are oriented with respect to respective optical windows such as optical windows 3858 in a similar orientation. For example, an edge 3859a of the optical enclosure 3852a has a first offset 3860a perpendicular to the first mirror plane 3854 and an edge 3859b of the optical enclosure 3852b has a second, offset 3860b perpendicular to the first mirror plane 3854. The plurality of optical enclosures 3852 can be related via a C₂ rotational axis going through point 3860. Each horizontal pair of optical enclosures is related to each other via a C₂ symmetry axis. For example, optical enclosure 3852d is related to optical enclosure 3852c via the C₂ symmetry axis going through point 3861. This discussion re symmetry relationship in FIG. 38 does not consider any couplers and/or ports, e.g., disposed at a rear side of the optical enclosure, or an interior arrangement in the optical enclosure, which may limit some of the symmetry relations.

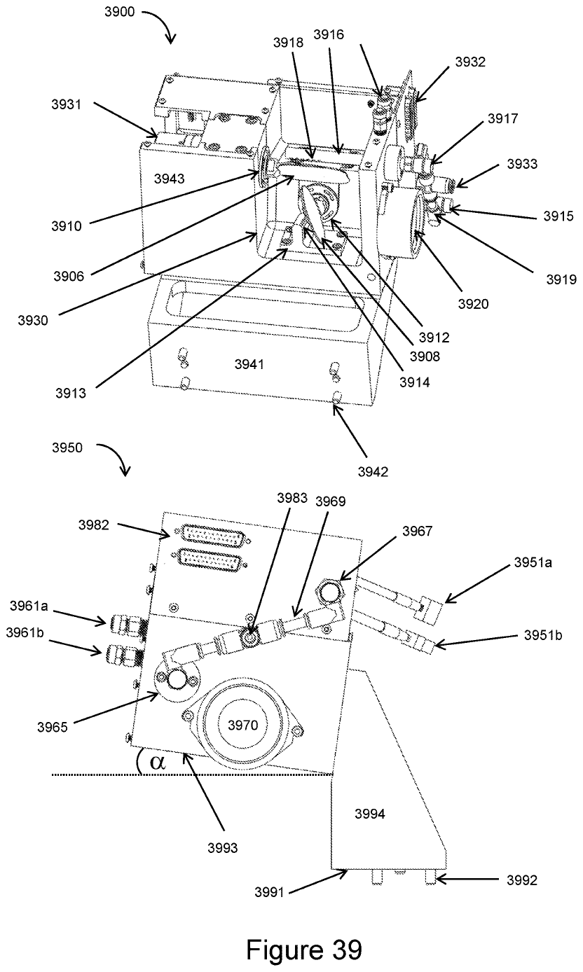

FIG. 39 shows an example 3900 of a perspective view of optical assembly portion including a galvanometric scanner and supportive structure as part of the optical assembly portion. As depicted in FIG. 39, the galvanometric scanner is a two-axis scanner and includes (A) a first mirror 3906, e.g., an X mirror, and (B) a second mirror 3908, e.g., a Y mirror, with X and Y being axes in a Cartesian coordinate system. First mirror 3906 is affixed by mirror mount 3910 to the supportive structure; and second mirror 3908 is affixed by mirror mount 3912 to the supportive structure having floor 3943. First mirror 3906 and second mirrors 3908 are adjustable about the respective axes (e.g., about an X-axis, or about a Y-axis respectively), such that an energy beam incident on the mirrors can be deflected about the respective axes. Mirror 3906 is operatively coupled with a motor 3931, e.g., servo motor control by the control system comprising a controller. Mirror 3908 is operatively coupled with a motor (not shown), e.g., servo motor control by the control system comprising a controller. The motor may adjust position of mirror about an axis, e.g., to alter a propagation direction of the energy beam reflected from the mirror. As depicted in the example 3900, optical gas flow component 3913 includes an inlet configured to receive incoming gas flow from gas channel portion 3915, and expel the gas through apertures including aperture 3914, which apertures are periodically arranged along a surface of gas flow component 3913 in a single file. The gas flow component can be configured to direct gas flow to the surface of an optical element. For example, gas flow component 3913 is configured to direct gas flow to a back surface of mirror 3908. The back surface of the mirror opposes a side of the mirror configured to interact with the energy beam propagating along an optical path and reflect it in a direction. For example, gas flow component 3913 can be configured to direct gas flow to a back surface of a mirror via the group of apertures including apertures 3914. As depicted in the example shown in example 3900, gas flow component 3916 includes an inlet configured to receive a gas flow from gas channel portion 3917, and expel the gas through apertures including apertures 3918, which apertures are periodically arranged along a surface of the gas flow component 3916 in a single file. The gas flow component can be configured to direct gas flow to the surface of an optical element. For example, gas flow component 3916 is configured to direct gas flow to a back surface of mirror 3906. The back surface of the mirror opposes a side of the mirror configured to interact with the energy beam propagating along an optical path and reflects from a surface of mirror 3906 it in a direction. For example, gas flow component 3916 can be configured to direct gas flow to a back surface of a mirror via the group of apertures including apertures 3918. The supportive structure includes inlet 3920 through which the energy beam can propagate. Inlet 3920 can comprise an optical window, or can be devoid of an optical window. The energy beam can arrive from the same optical enclosure in which the optical assembly portion is disposed, or from another optical enclosure. The energy beam can arrive from the same optical housing in which the optical assembly portion is disposed, or from another optical housing. For example, a scanner assembly portion similar to the one included in optical enclosure portion 3900, can be disposed in a manner similar to the one depicted in FIGS. 12, 1234 and/or 1232. The supportive structure in example 3900 is coupled with (e.g., to) a gas splitter comprising gas receiving channel 3933 from which the gas splits through gas channel (e.g., having portion 3919) (A) to channel portion 3917 at a first end and (B) to channel portion 3915 at a second end opposing the first end. Mirrors 3906 and 3908 are affixed to the supportive structure having floor portion 3943. Floor portion 3943 is configured to be directed during operation (a) towards the gravitational center of the ambient environment, (b) towards a ceiling of a processing chamber, and/or (c) towards floor 3941 of a mount. Floor 3943 includes opening 3930 configured to allow during operation transmission of the energy beam through opening 3930. The energy beam (not shown) can propagate through opening 3930 into a processing chamber (not shown). The propagation from the optical assembly to the processing chamber can be through an optical window (not shown), e.g., in an arrangement similar to the one depicted in FIGS. 10 and/or 16. In example 3900, the scanner portion (e.g., mirrors) is coupled with (e.g., to) a mount comprising floor 3941 and aligners such as 3942. Floor 3941 is configured to be directed during operation (A) towards the gravitational center of the ambient environment and/or (B) towards a ceiling of the processing chamber. Example 3900 shows electrical connectors 3932 that can be configured to coupled with a control system, e.g., controlling the scanner, controlling another scanner, and/or controlling the gas flow. In an example, the optical assembly portion shown in example 3900 is disposed in a first optical housing and the first energy beam arrives from a second optical housing in which the second scanner is disposed, the second housing comprising the second scanner configured to direct a second energy beam arriving from the first housing in which the first scanner is disposed (e.g., in an arrangement similar to the one depicted in FIG. 12), and connectors 3932 connect the control system to the second scanner.

FIG. 39 shows in example 3950 of a side view of optical assembly portion 3900 that includes the galvanometric scanner and supportive structure as part of the optical assembly. The supportive structure includes inlet 3970 through which the energy beam can propagate. Inlet 3970 may be devoid of an optical window, or may comprise an optical window, e.g., as disclosed herein. The energy beam (not shown) can arrive to inlet 3970 from the same optical enclosure, or from another optical enclosure. The energy beam can arrive to inlet 3970 from the same optical housing, or from another optical housing. The optical assembly in example 3950 is coupled with (e.g., to) a gas splitter comprising receiving channel 3983 from which gas enters the gas splitter and splits by gas channel (e.g., having portion 3969) (A) to channel portion coupled with (e.g., to) inlet 3977 at a first end and (B) to channel portion coupled with (e.g., to) inlet 3965 at a second end opposing the first end. The supportive structure comprises floor portion 3993 configured to be directed during operation (a) towards the gravitational center of the ambient environment, (b) towards a ceiling of a processing chamber, and/or (c) towards floor 3991 of a mount. In example 3950, the scanner portion is coupled with (e.g., to) the mount having floor 3991, side 3994, and aligners such as 3992. The aligners may be configured to align (e.g., and stability) the mount with respect to ceiling of a processing chamber. Example 3950 shows electrical connectors 3932 that can be configured to couple with (e.g., to) a control system, e.g., for control of the scanner and/or of the gas flow. The optical assembly portion (e.g., floor 3993) is configured to tilt by the angle alpha (α) with respect to (i) floor 3991 of the mount and/or (ii) the horizon. The angle alpha may be the acute angle 1030 shown in the example of FIG. 10. In some examples, the optical assembly portion is configured to tilt with respect to a ceiling of a processing chamber by the angle alpha (α). Example 3950 shows 3951a and 3951b that are cable connections to the motors of the mirrors (e.g., to motor 3931 of mirror 3906). The model comes from the vendor with these already modeled, in practice these are routed into the differential board. The optical assembly portion comprises channels for a coolant, e.g., as disclosed herein. The optical assembly portion showing in example 3950 is operatively coupled with (e.g., to) a temperature conditioning system, e.g., as disclosed herein. Ports 3961a and 3961b are inlet and outlet ports for the coolant conditioning a temperature of (i) gas flowing on coolant channels such as coolant channel 2462 or there adjacent, (ii) a component which it is contacting, and/or (iii) a component having flowable connection to the coolant channel (not shown).

At times, it may be advantageous to allow for easy installation and/or components of the 3D printing system. For example, it may be advantageous if one or more components of the 3D printing system are easily maneuvered (e.g., insertable and/or removed). Maneuver may comprise translate or rotate. Translation can be in a plane or in a 3D space. Maneuver may be reversible, e.g., rotate back and forth, and/or translate back and forth. The reversible maneuver may be taking out and/or placing in. Easy maneuvering (e.g., removal and/or insertion) may include actions of a user facing the 3D system, and maneuvering (e.g., pulling and/or pushing) the one or more components to facilitate their maneuver (e.g., removal and/or insertion, respectively). For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an (e.g., laser generator), an optical system (e.g., an optical enclosure or an optical housing), a detection system, an optical system enclosure, a side cover, or a door. The front of the 3D printing system can include a door to the processing chamber. A top of the 3D printing system can facing the platform through the optical window(s). The top of the 3D printing system may be closer to the optical windows than to the platform. The top of the 3D printing system may face the optical system enclosure, or include at least a portion of the optical system enclosure. The optical system enclosure may be a field replaceable unit. The optical system enclosure may comprise the optical housing. The one or more components can be secured to the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw a pin, or a peg. The component (e.g., energy source) may be disposed on a rack (e.g., an electronic rack). The component may be engaged with a sliding mechanism (e.g., similar to a drawer). For example, the component comprises at least one wheel (e.g., wheels) configured to couple to at least one rail (e.g., two rails) disposed in 3D printing system cavity. For example, the component comprises at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering.

At times, the maneuvering comprises maneuvering the optical system, e.g., disposed in the optical housing, e.g., a field replaceable unit. The maneuvering of the optical housing or the optical system enclosure comprising the housing, may be with minimal disturbance to (I) the optical setup in the optical housing and/or (II) to the beam path traveling in the optical housing. Minimal disturbance may comprise disturbance that requires adjustment without opening the optical housing. Minimal disturbance may comprise disturbance that necessitates remote adjustment of the optical housing, e.g., using at least one controller such as disclosed herein. Minimal disturbance may comprise lack of measurable disturbance. Minimal disturbance may comprise disturbance that does not affect the printed 3D object(s) according to their requested specification(s).

At times, maneuvering the optical system with respect to the 3D printing system causes no, or minimum (e.g., non-material), alternation of the optical system(s) disposed in the optical system enclosure. For example, one or more parts (e.g., all parts) of the optical system or of the optical housing of the optical system (e.g., optical enclosure in FIG. 1, 170) may be stable during extraction of the optical housing from the 3D printing system and/or insertion of the optical housing into the 3D printing system. Such (e.g., reversible) maneuvering methodology may allow easy assembly, and/or maintenance of the 3D printing system (e.g., of the component thereof). The optical system may comprise one or more mirrors (e.g., tilted mirror such as with the aid of screws). The tilted mirror may be susceptible to maneuverings (e.g., susceptible to changes in their maneuverings and/or directionality). A small change in the disposition of the tilted mirror may cause a substantial change in deflection of the energy beam (e.g., laser beam) guided by the mirror, e.g., with respect to the exposed surface of the target surface such as the material bed (e.g., FIG. 1, 104), upon which the energy beam (e.g., 101) impinges. In some embodiments, one or more tilting mirrors (e.g., of the scanner) are substituted by one or more (e.g., a set of) optical prisms such as optical wedges. The optical prism can be rotated around an axis (e.g., z axis), e.g., at an angle φ. A projection angle on the X axis may be θₓ, and a projection angle on the Y axis may be θ_{y}, where X, Y, and Z are Cartesian coordinate axes. The projections θₓ and θ_{y} may abide by the following mathematical relationships:

$${θ}_{x} = α cos φ$$

$${θ}_{y} = α sin φ$$

By having an integer number of prisms (e.g., wedges) k=1, 2, 3, . . . n with all of angles a (where “n” is an integer), the following relationships can result:

$${θ}_{x} = {\sum }_{k = 1}^{n} α cos {φ}_{k}$$

$${θ}_{y} = {\sum }_{k = 1}^{n} α sin {φ}_{k}$$

When n≥2, the projection angles θₓ, and θ_{y} may be controlled independently. Since the value of each of θₓ and θ_{y} is much smaller than angle φ, e.g., θₓ«φ and θ_{y}«φ; the resulting optical mechanism is not as susceptible to maneuvering (e.g., stirring, tilting, and/or shaking), as compared with a tilting mirror mechanism. The optical prisms may be configured to rotate (e.g., are rotatable) to facilitate alteration of the direction of the energy beam passing therethrough, e.g., in two directions and/or in two dimensions. Such alteration may facilitate using the optical system to direct the energy beam towards the scanner that translate the energy beam with respect to the exposed surface of the material bed, e.g., to form the 3D object(s). The optical prism may be referred to herein as a “prism.” In some embodiments, in order to alter the position of the energy beam going through the prisms (e.g., with respect to the scanner) a large change in the positions of the prisms is required. Such requirement for large changes minimizes error in the optical path of the energy beam upon maneuvering of the optical system and/or optical system enclosure, e.g., with respect to an optical system that uses tilting mirror(s) instead of the prism(s).

FIG. 40 shows an example of a prism (e.g., wedge prism) 4000 into which beams 4001a and 4002a (e.g., optical beams such as laser beams) penetrate, the beams are refracted by the prism (e.g., optical wedge) as beams 4001b and 4002b. The angle of refraction is denoted as alpha (x). FIG. 40 shows an example of a Cartesian system including axes X, Y, and Z. The prism can be rotated about the Z axis such as along circular arrow 4010 forming an angle @ with respect to another axis of the Cartesian system (e.g., Y axis, or X axis). The refraction of the rays penetrating the prism that emerge at the opposing side of the prism may depend on the shape of the prism, e.g., on the angles (e.g., 4071 and 4072) the prism is cut, and the refractive index of the material from which the prism is composed. The angles 4071 and 4072 can have the same value or a different value. The angles 4071 and 4072 can be two-dimensional angles or three-dimensional angles. The prism may comprise glass, quartz, or sapphire. The prism may comprise any material that may exhibit a reduced thermal lensing effect, e.g., as disclosed herein. The prism may comprise any high thermal conductivity optical element material, e.g., as disclosed herein.

In some embodiments, the optical system comprising the prism(s) is subject to installation and/or maintenance. As compared to a similar optical system having tilting mirror(s) instead of the prism(s), the maintenance and/or installation of the prisms containing optical system has one or more benefits. The benefits my comprise being quicker, cheaper, simpler, requiring fewer personnel, being more robust, or being more reliable.

In some embodiments, the optical system is operatively coupled to one or more controllers. The one or more controllers may be configured to maneuver the prism(s). For example, the one or more controllers may be configured to alter a position and/or angle of the prism(s) with respect to a reference. For example, the one or more controllers may be configured to alter a position and/or angle of the prisms with respect to each other. The one or more controllers may be part of the control system. The control system may comprise controllers that, e.g., may have a hierarchical structure. The hierarchical structure may comprise at least three levels of hierarchy. The control system may be configured to control one or more components of the 3D printing system. The control system may be configured to control the printing of one or more 3D objects by the 3D printing system, e.g., in a printing cycle. The control system may be configured to control maneuvering the prism(s) before, during (e.g., in real-time), and/or after operation of the 3D printer, e.g., to print one or more 3D objects (e.g., in a printing cycle).

In some embodiments, the energy beam impingement position and detector detecting its reflection from the target surface, are aligned such to allow measurement of a temperature at the target surface, e.g., during printing. The field of view of the detector may be substantially concentric with a location of the irradiating energy on a target surface, e.g., the target surface. The detector may be a thermal detector. The detector may comprise one or more fibers. The detector may be configured to collect thermal emission from the target surface as the energy beam impinges on the target surface. For example, the detector may collect thermal emission from the melt pool generated at the target surface. The control system may translate the energy beam (e.g., at least in part by controlling its scanner) in coordination with location of the detector such that the impingement point of the energy beam on the target surface will remain coinciding with collecting the thermal signal by the detector (e.g., by the fiber(s) of the detector) as the energy beam translate along the target surface. Movement of the energy beam may be synchronized with the collection of the thermal radiation from the target surface by the detector. The image of the energy beam footprint at the target surface may be centered with the image of emerging thermal radiation from the energy beam impingement on the target surface as collected by the detector. There may be one or more energy beams operating during printing, e.g., as disclosed herein.

In some embodiment, alignment is obtained between a footprint of the energy beam on a target surface, and an image collected by the optical detector, e.g., thermal detector. The alignment may be achieved by using a movable optical element. The movable optical element may comprise a mirror, or a prism. The movement may be a rotational movement. The movement may be about an axis. The movement may devoid a translatory movement along an axis. The alignment may be reached using one or more stirring mirrors. The alignment may be reached using one or more (e.g., stationary) mirrors. The mirrors may be different than the mirrors of the scanner. The mirror may be stirred automatically using an actuator and/or manually using adjustable screw(s). For example, the adjustable screw(s) may tilt the plane of the mirror. Automatic adjustment may be facilitated using one or more controllers, e.g., as part of a control system such as the one disclosed herein. At times, small changes in the adjustment of the mirror may cause a large deflection in the energy beam and/or alignment of the detector with the thermal image to be collected. The mirror may double the deflection of the beam. For example, a change of one microradian in the angle of the plane of the mirror may cause a change of about two microradians in the outgoing beam from the mirror. The focal length multiplied by the deflection may be substantial. For example, the focal length may be at least about 500 mm, 800 mm, or 1200 mm. Therefore, a small deflection of the mirror may express itself as a large deviation from the requested alignment. Using prism(s) may present a mechanism that is more robust as compared to rotatable mirror(s), e.g., less sensitive to small movement of the optical element as compared to rotatable mirror(s). The beam may translate through the prism. The beam may comprise the thermal energy beam (e.g., IR beam) collected by the detector, or the energy beam (e.g., laser beam) directed towards the target surface. The prism may be configured to tilt the path of the beam from its initial propagation direction. The prism may be configured at a low angle that is sufficiently practical to correct for small positional misalignment errors during printing. The small positional misalignment may be a misalignment in a position of at most about 500 micrometers (μm), 250 μm, 100 μm, 80 μm, 50 μm, or 25 μm. When the prism rotates about its axis, the beam passing through the prism will rotate on a circle with the angular radius of the circle being α*(n−1), where n is the index of refraction, and alpha (x) is the angle of prism in radians, e.g., FIG. 40, angle 4036a. When the angle of the prism is zero, the prism can be rotated, and the beam path will remain as if no rotation has occurred. When the angle of the prism is small (e.g., about 1 degree), then for a glass prism, the prism may have a scanning angle of at about half a degree. Thus, large changes in angular position of the prism about its axis may be required to bring about a change in deflecting the beam passing through the prism. The prism may comprise glass, sapphire, quartz or silica such as fused silica. The prism may or may not be achromatic. The prism may be utilized to stir the beam. The prism may be devoid of causing color fringing (e.g., chromatic aberration) at least in the requested wavelength of the beam. The prism may or may not comprise a coating. The coating may comprise an anti-reflective coating. The coating may comprise Magnesium Fluoride (MgF2) coating. The prism may be configured to stir any energy beam disclosed herein. For example, the prism may be configured to stir an energy beam in the IR region. The IR region may comprise an energy beam having a wavelength of at least 1400 nanometers (nm), 1500 nm, 1600 nm, 1700 nm, or 1800 nm. The prism may be configured to stir the energy beam having a wavelength between any of the aforementioned wavelengths, e.g., from about 1400 nm to about 1800 nm, or from about 1500 to about 1700 nm.

At times, a misaligned between the impinging energy beam and the optical detector occurs. At times, it may be required to maintain alignment of the detected image from a target surface during translation of the energy beam impinging on the target surface. For example, it may be required to maintain alignment of the detected thermal image from a target surface during translation of the laser beam impinging on the target surface. Such requirement may arise due to drift of the beam path of the impinging energy beam, e.g., laser beam). It may be requested to correct such misalignment without opening an optical system enclosure, e.g., Field Replaceable Unit of the optical system, abbreviated herein as “FRU.” The rotatable optical component (e.g., mirror(s) or prism(s)) may be operatively coupled to an actuator such as a motor, e.g., a servomotor. The rotatable optical component may comprise glass, sapphire, crystal quartz, zinc selenide (ZnSe), magnesium fluoride (MgF2), calcium fluoride (CaF2), fused silica, borosilicate, silicon fluoride, beryllium, silicon carbide, or Pyrex. The actuator may be disposed in the optical system enclosure. The actuator may be operatively coupled to at least one controller, e.g., as disclosed herein. The coupling may comprise wired or wireless communication. For example, the actuator may be controlled remotely, e.g., using the at least one controller. The rotatable optical component may be manually controlled, e.g., using a screw extending from outside of the optical system enclosure to the optical element disposed in the interior of the optical component enclosure. The screw may be coupled to the housing of the optical system enclosure by a seal such as a rotational seal. The optical system enclosure may be hermetically sealed, e.g., may be gas tight. In some embodiments, the optical system enclosure may be leaking, e.g., purposefully leaking such as in FIG. 15.

In some embodiments, a plurality of rotatable optical components are utilized to align the beam. The plurality of rotatable components may comprise a pair of optical components aligned with their axis perpendicular, or substantially perpendicular, to each other. At times, a plurality of prism pairs are utilized to deflect the beam, e.g., two pairs of rotatable prisms. The refractive indexes of each prism in the pair of prisms may be the same, or substantially the same. At times, two pair of prisms are utilized to deflect and/or align the beam on a plane. A first rotatable prism about a first axis of rotation may cause a beam to move along a circumference of a first circle having a first center as the first prism rotates, e.g., FIG. 40, 4041a having radius r1. In order for the beam to be deflected beyond the circle circumference on a plane, a second rotatable prism is utilized. The second rotatable about a second axis of rotation may cause a beam to move along a circumference of a second circle having a second center as the second prism rotates, e.g., FIG. 40, 4042a having radius r2. The pair of rotatable prisms may be disposed such that their centers form a right angle with respect to center of a requested area to which the prism can deflect the passing beam to, e.g., FIG. 40, 4043a. At times, a Risley prism assembly is utilized to deflect the beam. The Risley prism assembly may comprise two prisms such as wedge prisms, or two trapezoid prims. In some embodiments, the wedge prism is a prism having a shallow angle between its input and output surfaces. The shallow angle can be at most about 3 degrees. Refraction at the surfaces of the prism may cause the prism to deflect light by a fixed angle. Two prisms of a pair of prisms may have equal (or substantially equal) refractive indices. The prism may be utilized to steer the beam passing through the prism, while the prism rotates about an axis. Risley prism pair may comprise two prisms such as two wedge prisms. The prism pair may be rotatable such that one prism rotates with respect to the other. Rotation of the prisms in the prism pair may change the direction of the beam as it propagates through the prism pair. In some embodiments, when the angle between the prisms in the prism pair in the same direction, the angle of the refracted beam becomes greater. In some embodiments, when the wedges are rotated to angle in opposite directions, they cancel each other out, and the beam is allowed to pass straight through the prism pair. Moving a wedge either closer or farther away from the energy beam (e.g., laser) can be used to steer the beam. The first prism may refract the beam at a first angle along a circle circumference pattern having a radius. The second prism adds a second rotational axis. The second prism may be larger than the first prism, e.g., to accommodate the emerging beam from the first prism. The prism may comprise an angled exposed surface or a non-angled surface. For example, the vertical cross section of the prism may be a right triangle having a non-angled side and an angled side with respect to its base. For example, a vertical cross section of the Risley prism pair pay be two right triangles, with their non-angled surfaces disposed parallel to each other and perpendicular to the axis of rotations. An example of a Risley prism pair is provided in FIG. 40, 4031a. The spacing between the parallel sides of the prism pair should remain constant or substantially constant during each prism's rotation. Each of the prism in the pair of prisms may rotate independently of each other. The pair of prisms may cause movement of the beam along a two dimensional circle, including the circumference and interior of the circle. In some embodiments, the pair of prisms are operatively coupled to one actuator configured to move each of the two prisms in opposing directions. In some embodiments, each of the prisms in a pair of prisms may be configured to an actuator, respectively. The actuators of the prism pair may be synchronized with each other, e.g., coordinated with each other. The focal length can be at least the FLS of the processing chamber, e.g., as disclosed herein. For example, the focal length can be at least about 1 meter, 800 mm, or 500 mm.

In some embodiments, at least some of the optical components (e.g., optical elements) are enclosed in an enclosure such as an optical system enclosure. For example, optical components comprising a prism (e.g., of a Risley prism set), a lens, a beam splitter, an optical filter, or a mirror. At times, at least one first optical component is disposed in the enclosure and at least one second optical component is disposed outside of the optical enclosure. The at least one first optical component may be of the same type as the at least one second optical component. For example the at least one first optical component may be a first lens and the at least one second optical component may be a second lens. The at least one first optical component may be of a different type from the at least one second optical component. For example the at least one first optical component may be a mirror and the at least one second optical component may be a beam splitter. Any of the optical components may be maneuverable, e.g., rotatable and/or translatable. The maneuvering may comprise 2D or 3D maneuvering. At times the optical components are part of an optical setup. At least part of the optical setup may be disposed in an enclosure such as an optical system enclosure, or an optical system housing that encloses the optical system enclosure. At times, the optical setup is configured to direct an energy beam from an energy source to the target surface, e.g., exposed surface of a material bed. At times, the energy beam source may be disposed outside of the enclosure housing the optical element(s). In an example, the energy source is not disposed in the optical enclosure (e.g., energy source 121 vs. optical enclosure 170 of FIG. 1). The energy source may be directed to the enclosure, e.g., using an optical fiber. At times, electromagnetic radiation may be emitted from the target surface and directed by the optical setup to a detection system comprising a detector. The detector may be disposed in the enclosure that houses the optical setup. The detector may be disposed outside of the enclosure that houses the optical setup. The electromagnetic radiation may be directed to the detector, e.g., using an optical fiber. The detectors may or may not be disposed in the optical enclosure. The target surface may be disposed outside of the optical enclosure. In an example, the target surface is disposed in a processing chamber that is operatively coupled to the optical enclosure, e.g., FIG. 1, surface 119 in processing chamber having interior space 126.

FIG. 40 shows an example of side vertical cross sections of two prisms 4011a and 4012a, each having a trapezoidal cross section having a right angle forming a horizontal bottom and a vertical side, with a vertical side of one prism being parallel to a vertical side of the other prism. The first prism can rotate in a direction 4013a or in an opposite direction thereto, and the second prism can rotate in a direction 4014a or in an opposite direction thereto. The rotations 4013a and 4014a begin along axis 4018a. The rotation can be in any of the directions 4050a about an axis traversing position 4051a in window 4030a. The rotation of each of the prism can be dependent or independent of the other. For example, the rotation of prism 4011a can be independent of the rotation of prism 4012a, and vice versa. Electromagnetic radiation enters the prism pair in a direction 4017a. The energy beam can exit the prism pair as deflected (not shown). A front view of the prism pair can resemble window 4030a, or have any other shape such as geometric shape. Each of prism of the prism pair can have a side angled with respect to its horizontal base. The angle (e.g., 4015a and 4016a) can be a shallow angle. For example, each prism can be an optical wedge. The shallow angles may be at most about 10 degrees (°), 8°, 5°, 3°, or 1°. For example, each prism can be an optical wedge.

FIG. 40 shows an example of side vertical cross sections of two prisms 4031a and 4032a, each having a triangle cross section having a right angle forming a horizontal bottom and a vertical side, with a vertical side of one prism being parallel to a vertical side of the other prism. The first prism can rotate in a direction 4033a or in an opposite direction thereto, and the second prism can rotate in a direction 4034a or in an opposite direction thereto. The rotations 4033a and 4034a begin along axis 4038a. The rotation of each of the prism can be dependent or independent of the other. For example, the rotation of prism 4031a can be independent of the rotation of prism 4032a, and vice versa. Electromagnetic radiation enters the prism pair in a direction 4037a. The energy beam can exit the prism pair as deflected (not shown). A front view of the prism pair can resemble window 4030a, or have any other shape such as geometric shape. Each of prism of the prism pair can have a side angled with respect to its horizontal base. The angle (e.g., 4035a and 4036a) can be a shallow angle as disclosed herein. For example, each prism can be an optical wedge.

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Components of the galvanometer scanner were temperature conditioned (e.g., cooled) during operation using components depicted in FIG. 39 including (A) X mirror gas manifold 3913, (B) the Y mirror cooling manifold 3916, and (C) coolant circulating through ports 3961a and 3961b. The 3D printer included similar components to the ones depicted in FIG. 12. Each of the laser beams originated from a fiber laser and traversed its respective optical window into the processing chamber to impinge on an exposed surface of the powder bed to print layerwise a 3D object. Each of the laser beams had a maximum power of about one (1) Kilo Watt, and a wavelength of about 1060 nanometers. A user was able to view the laser beams during printing using three circular viewing window assemblies similar to the windows shown in processing chamber 1210 of FIG. 12. The viewing assembly comprises a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

Example 2: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 600 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with eight optical windows made of sapphire in a configuration similar to the one depicted in FIG. 5, e.g., 580. Each laser beam was guided by an optical setup in an optical system enclosure, the optical system enclosure disposed above the processing chamber, the optical system enclosure comprising a galvanometer scanner. Components of the galvanometer scanner were temperature conditions (e.g., cooled) and shielded during operation using components depicted in FIGS. 19-24 including (A) X mirror mount baffle depicted in guards 1934c, 2128, 2216, and 2302; (B) Y mirror mount baffle depicted in guards 1934a, 2256, 2260, 2304, 2420; (C) X mirror back baffle depicted in guards 1934b, 2126, 2218, 2262, and 2306; (D) X mirror gas flow component (e.g., gas manifold) depicted in 2418, 2422, and 2450; (E) Y mirror gas flow component (e.g., gas manifold) depicted in 2424, and 2430; and coolant circulating thorough channels 2462. The optical system enclosure was similar to the one depicted in FIGS. 13 and 14. Each of the laser beams originated from a fiber laser and traversed its respective optical window into the processing chamber to impinge on an exposed surface of the powder bed to print layerwise a 3D object. Each of the laser beams had a maximum power of about one (1) Kilo Watt, and a wavelength of about 1060 nanometers. A user was able to view the laser beams during printing using rectangular viewing window assembly similar to the window assembly 1371 of FIG. 13. The viewing assembly comprises a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A device for energy beam translation, the device comprising:
an actuator;
a mirror operatively coupled with the actuator configured to move the mirror about an axis, the mirror being configured to deflect the energy beam impinging on the mirror; and
a housing configured to (a) accommodate the mirror, (b) facilitate transmission of the energy beam propagating along an optical path disposed in the housing, and (c) operatively couple with an optical window configured to facilitate the energy beam to propagate therethrough and out of the housing, wherein:
a. during operation, the device is configured to bring about translation of the energy beam along a target surface with a positional error at the target surface, the positional error being of a value of at most about 0.01 percent, the value of the positional error being relative to a portion of the path from the axis of the mirror to the target surface;
b. the device comprising a guard configured to shield the mirror from at least a portion of stray radiation in the housing;
c. the mirror being coupled with the actuator with an adhesive having a liquidous phase transition at a temperature of at least about 120 degrees Celsius;
d. the device is configured to maintain its standard operation at a temperature of at least about 80 degrees Celsius, the standard operation being at an ambient temperature external to the device;
e. the device is configured to maintain the standard operation while being subject to stray radiation that increases the temperature of the standard operation by a temperature increase value of from about zero degrees Celsius to at least about 25 degrees Celsius, the temperature increase being (i) of the actuator and/or (ii) of the mirror;
f. a fastener of the actuator has a torque value of at least about 1.5 Newton*meters;
g. during operation, the mirror is configured to have a frequency response drift, the frequency response drift having a value of at most about two hertz per degree Celsius;
h. during operation, the mirror is configured to have a total drift tolerance frequency having a value of at most about 100 Hertz;
i. the device comprises an optical element having a reflectivity value of at least about 90 percent or higher, the optical element comprising the mirror, a mount of the mirror, the actuator, or the guard, the reflectivity being of the energy beam; or
j. any combination of (A) to (I).

2-3. (canceled)

4. The device of claim 1, wherein the guard is configured to guard the mirror from stray radiation incoming into the housing through the optical window.

5-6. (canceled)

7. The device of claim 1, further comprising one or more other optical elements other than the mirror and the actuator.

8. The device of claim 7, wherein the guard is configured to shield the mirror from stray radiation reflected from the one or more other optical element.

9-12. (canceled)

13. The device of claim 7, wherein the device comprises an axicon or an optical wedge.

14. The device of claim 13, wherein (I) the axicon is configured to alter the energy beam from the first profile to the second profile, (II) the axicon is reversibly translatable, and/or (III) the optical wedge is configured to direct a reflected beam from the target surface to be detected by a detector; and optionally wherein translatable is in real time during the printing.

15. (canceled)

16. The device of claim 1, wherein the housing is configured (A) for reversibly installed and uninstalled without substantial alteration to the beam path of the energy beam at the target surface, and/or (B) to be reversibly installed and uninstalled for the purpose comprising maintenance, upgrade, or replacement; and optionally wherein the housing is a field replaceable unit.

17. The device of claim 1, wherein the target surface comprises an exposed surface of a material bed.

18-20. (canceled)

21. The device of claim 1, wherein the energy beam is configured to irradiate the target surface to transform a starting material into a transformed material to print a three-dimensional object; and optionally wherein transformation of the starting material comprises melting or sintering.

22. The device of claim 1, wherein the mirror being coupled with the actuator with an adhesive having a liquidous phase transition at a temperature of at least about 120 degrees Celsius.

23-28. (canceled)

29. The device of claim 1, wherein the device comprises an optical element having a reflectivity value of at least about 90 percent (%), the optical element comprising the mirror, a mount of the mirror, the actuator, or the guard, the reflectivity being of the energy beam.

30-34. (canceled)

35. The device of claim 1, wherein the housing comprise a galvanometer scanner that comprises the mirror.

36. (canceled)

37. The device of claim 1, wherein the housing is configured to facilitate flow of at least one coolant type therethrough, the at least one coolant type configured to cool the mirror and/or the actuator during operation of the device to translate the energy beam.

38-39. (canceled)

40. The device of claim 1, wherein the stray radiation comprises (i) radiation entering the housing through the optical window and/or (ii) reflected from one or more optical elements disposed in the housing.

41. The device of claim 1, wherein the optical path is disposed in one or more channels within the housing.

42-43. (canceled)

44. The device of claim 1, wherein the mount comprises a central portion from which supporting beams extend to different edges of the mirror, the supportive beams being configured to (A) support similar weight and/or (B) withstand a similar force as compared to each other.

45-56. (canceled)

57. The device of claim 1, wherein the housing is configured to engage with (i) an energy source for the energy beam, (ii) a coolant source, and/or (iii) a gas source.

58-60. (canceled)
